(19) United States
(12) Patent Application Publication
(10) Pub. No.: US 2005/0154742 A1
(43) Pub. Date: Jul. 14, 2005

(54) Business software application generation system and method

(76) Inventors: Aviv Roth, Brooklyn, NY (US); David Roth, New York, NY (US)

Correspondence Address: DLA PIPER RUDNICK GRAY CARY US, LLP, 2000 UNIVERSITY AVENUE, E. PALO ALTO, CA, 94303-2248, US

(21) Appl. No.: 10/996,792

(22) Filed: Nov. 24, 2004

Related U.S. Application Data
(60) Provisional application No. 60/525,379, filed on Nov. 26, 2003.

(51) Int. Cl. G06F 7/00

(52) U.S. Cl. 707/100

(57) ABSTRACT

A business software application generation system and method are described.

### PRIORITY CLAIM/RELATED CASE

This application claims priority under 35 U.S.C. 119(e) to U.S. Provisional Patent Application Ser. No. 60/525,379, filed on Nov. 26, 2003 and entitled “Business Software Application Generation System and Method” which is incorporated herein by reference.

### FIELD OF THE INVENTION

The inventions relates generally to a system and method for the generation of a business software application and in particular to a computer-implemented system and method for generating a business software application.

### BACKGROUND OF THE INVENTION

Business software application systems generally help large companies and/or large enterprises manage data and information of various types. There are many different types of business software application systems. One type of business software application is an enterprise resource planning (ERP) system that is a comprehensive enterprise system for managing demand side processes, supply side processes, financials and operation data. The demand side processes may include forecasting, planning and customer orders, the supply side processes include production, purchasing, inventory, vendor connectivity and input, the financials may include accounts payable, accounts receivable and the general ledger. The operation required by particular business cause a plethora of addition applications such as commissions, royalty, warehousing, customer service, distribution logistics, US custom handling, profitability and a myriad other business applications.

Some of the applications mentioned above may spawn many sub applications, depending on the business operation and product mix. Production, for example, may include pre-production product design and approval: complex bills-of-materials which are product recipes of raw materials, operations, or other resources required to assemble finished products. The handling of such materials, sometimes referred to as MRP (Manufacturing Requirement Planning), could be varied and complex, bringing into consideration variables such as costs, currency conversions, products locations, manufacturing capacity, transportation, import quotas, time to market, preferred vendors. The list goes on and on, depending on the particular vertical market and the specific business requirements.

Additional applications such as Human Resources (HR) may have minimal interface to the main ERP system in some organization, or a monumental importance in organizations that must control such components for operations, billing or revenue model. Such applications are typically included and perceived as a part of the larger ERP systems. Note that a large ERP software provider such as PeopleSoft started its business providing a Payroll and HR system, later branching into ERP functionality. PeopleSoft's inclusion of the HR system in their ERP offering compelled competitors to do the same, establishing the norm that HR is part of an ERP system.

Another type of business software application is a supply chain management (SCM) system that refers to the control and management of incoming products, services and resources which the business ultimately needs to match and distribute against its internal or customer demands. With possible unique exceptions, SCM has no life of its own; it needs to be part of an ERP system. The management and control of the supply and resources needs to be integrated, matched or correlated to some ultimate target, and distributed against it. The supply cannot live in a vacuum without some ultimate destination.

Stand alone SCM received a big boost from the internet. Internet software SCM solutions that attempted to provide a pathway for the supply chain into customers' ERP systems have been created. However, these software products only present the supply side to the customers' ERP. The demand side of the customers still lives in the ERP system, and its processes, programming, logic, and business accommodation are controlled by the host ERP system. It is obvious that SCM is an integral part of the ERP system, and indeed it is formulated and marketed as such by the large ERP vendors such as SAP, PeopleSoft and Oracle.

Another type of business software application is a customer relationship management (CRM) system. Customer relationship management refers to the management of customers, relating to the fulfillment of their demand, such as order shipping status, order modifications, or inventory and supply chain availability. A CRM module typically needs to draw on the ERP system for the correlation and interaction of supply side information (from various sources) against customer demand. Customer Service may also need other parts of the ERP system such as the customer credit evaluation, past payment history, current receivables obligations, and others.

The only time that CRM can stand alone without the ERP system is during the prospecting and customer marketing/acquisition cycles. At those stages, the prospect has no orders in the system and can be managed by a separate system. As soon as the prospect becomes a customer and places an order or commitment, he needs to be handled through the ERP system. Currently, the control over customer marketing and customer prospecting are a niche market capitalized on by some system publishers. A notable example is SalesForce.com, which has managed to garner more than 50,000 users for their service which they and the market refer to as CRM software. The conclusion is that ERP, SCM and CRM are and need to be part of the Enterprise system, normally lumped under the term ERP. The chronological history of ERP systems and enterprise resource planning including various companies such as JDE, PeopleSoft and SAP. SAP's website contains a biased history of ERP systems at http://www.saptech.8m.com/erp_history.htm.

Business Software Application Business Issue

Most typical business software applications, such as an ERP systems, are hard coded in that the business logic, user interface and other features of the business software application system are determined by the computer code that implements the system and is somewhat hard to change. A codeless business software application system (that generates the business software application on the fly) can overcome some limitations imposed by typical hard-coded business software applications and solve some vexing business issues.

One prevalent business issue is that different vertical markets have different ERP requirements. Many manufacturers and distributors have similar and generic activities such as producing or procuring goods, managing customer orders, shipping merchandise, creating invoices, collecting payments and so on. But different vertical markets have serious differences between their specific business process models, their management, and reporting. Even the same market vertical may contain segments of differing businesses, different philosophies, and differing requirements. A manufacturer may have full manufacturing and raw material processing requirements, or partial requirements, or may even assist in procuring some raw materials for some overseas vendors with different logistics, costs and commission logic. An importer may purchase finished goods and therefore may have different concerns and require different logistics. A drug distributor may need to have its ERP track the lot number and origin of each bottle shipped to a retailer for possible regulatory recall.

An electronic distributor may need a particularly large SKU (Stock Keeping Unit) product number, or what is known as a license plate (serial number) for each product or part of a product. Relationship and connectivity among parts may be unique to his business and driven not only by authorized physical parts connection but by cost considerations of the optimum product and its assemblage.

A garment business may have its SKU composed of style, color and size segments. Another garment business may pre-pack SKUs each consisting of multiple colors and sizes, or a particular size pre-packaged as one SKU item consisting of multiple styles and colors.

Coordinated sportswear will require the ability to store and ship tops and bottoms as separate styles, yet view, process, and ship them as a single coordinate item at other times. Another apparel distributor may have lot-shading requirements where he cannot mix different shade lots in the same shipment to a customer, requiring additional SKU identification and logistics.

A men's suit producer may not even deal with style and color. They may use a pattern to produce different model creating different operational requirements, including an additional sizing matrix (short, regular and tall). Other apparel businesses may have different requirements emanating from the use of dimensions (sleeve length, bra cup size). Private label companies may sell the same products as is, or with variations to multiple customers. Creating kits of garment and other products is another industry segment with its own requirement. Apparel organizations which have sized merchandise can usually manage in less than 14 sizes, while footwear companies (considered part of the softgoods vertical) require more than 20 sizes. This is a particular challenge since sizes are typically displayed horizontally on inquiries and reports. The Legal Practice vertical has different functional orientation when used in law offices than when used by in-house counsel of a large corporation. As can be seen from the above, one ERP system does not fit each different vertical market so that a typical ERP system developer must develop a separate ERP application for each different vertical market.

Due to the above business issue, typical ERP systems have evolved into two approaches including developing numerous specific vertical ERP products or a generic ERP product.

Specific Vertical ERP Products

The complexity of all ERP requirements for all businesses is so enormous, that small ERP vendors have tended to concentrate on a small set of similar market segments, or a single vertical in which they develop expertise and continuous functional improvements. As additional clients are recruited to use a particular software vertical, their specific and unique requirements may cause a custom version to be programmed for them as a unique branch from the vendor's current base version. If that system is customized extensively, it usually prevents the customer from receiving future generic upgrades, since its database schema, processes and logic may be so different, future version upgrades would overwrite the client's custom code. Some organizations manage, at considerable costs, to incorporate future generic system changes by slowly and laboriously programming them into their customized ERP system.

Another approach taken by software providers is to incorporate into their base package as many customer requirements as possible deemed generically useful for that vertical. At times, some of these customer requirements are “put on a switch” so they can be eliminated or run somewhat differently for different clients. That is, switches are turned on and off to provide and hide functionality as required for a specific customer. Generic ERP solutions, described below, take this option to a greater extreme.

Thousands of small and medium software providers address these verticals. It is not unusual for a vertical to have dozens or even hundreds of software providers, each competing on functionality and other business considerations.

Generic ERP

Some ERP providers, such as SAP, PeopleSoft, and Oracle, grew by crossing sectors and segments. They have engaged in a variety of techniques to overcome the problem of never-ending diverse functionality. Some of the techniques involved componentization of the software where specific ERP functions are still programmed in the traditional way but are controlled by software switches, settings, or metadata.

Such software attempts to execute pre-determined functions selectively, but cannot execute applications or functions that were not conceived of in the program design. ERP elements need to have been conceived of as a possibility or be in the conceived range of such possibility that is coded in the software. Also, the sheer number of switches that need to be set and processed at runtime adds complexity and performance overhead to the solution. SAP, the leading worldwide ERP system provider with thousands of installed systems, has over 8,000 switches and settings for its R/3 ERP system. The cost of implementing such huge systems is substantial, with a ratio of implementation to software cost of 3:1 on the low end and as much as 10:1 on the high end. An entire SAP implementation industry has mushroomed around the world, where major consulting companies and smaller entities specialize in implementing SAP, PeopleSoft, Oracle and other such ERP systems. Given the complexity of implementing and administering SAP switches, this is a very lucrative industry.

Some vertical markets have business models that are so complex, that ERP vendors can't effectively enter or accommodate such verticals with a generic cross-industry ERP. The apparel/softgoods industry is one such vertical where SAP spent hundreds of millions of dollars in a consortium with major clients such as VF, Reebok, Nike, and others, to create a stand-alone version of its R/3 system named AFS (Apparel Footwear System), geared specifically to that vertical. As of the filing of this patent even the specialized AFS has garnered less than 100 customers. The uniqueness of each apparel business prevent a quick adaptation out-of-the-box for this package.

ERP Systems are Costly to Develop and Maintain

A typical ERP software provider spends 10-17% of its gross sales for R&D to enhance its vertical functional capabilities. Additionally, a major source of income to such vendors is the customization of additional functionality for the clients of its software. Depending on the software provider business model, customization may range between 15-50% of gross sales. This activity is usually reimbursed and paid by clients. The total software development costs for a software provider range approximately from 25-65% of its gross sales.

Even with current CASE tools (Computer Aided Software Engineering), componentization (object oriented design and programming), and UML (Universal Modeling Language), the process to develop software has not changed conceptually in the last 20 years. While a small organization may have a programmer/analyst who is familiar with the business process interact directly with end users and then program their requirements, most substantial ERP vendors and systems require the following steps to customize their base system for a specific client:
1. Overall system objectives and business definition
2. Functional definition by a business analyst
3. Technical definition—translated from step 2
4. Database and schema modification if additional data elements are required
5. Programming
6. Technical testing to ensure first level program operation
7. Functional testing—usually by an analyst or user
8. Integration of code with base system
9. Application testing—usually on a test system
10. Integration of code into live environment
11. Testing in the live (production) environment

Any failure of any testing stage will usually return the product to a prior stage, depending on the nature of the problem. Multiple iterations of software development steps are common, and are the norm. The complex relationship of various ERP software components are too large to be encompassed by a single developer. A change to a module may have unforeseen deleterious consequences on other connected modules. Indeed the complexity of such systems is so great that a typical sales demonstration for SAP, PeopleSoft, Oracle, Intentia, or any tier-1 (over 1 B in sales) ERP vendor is conducted by multiple presenters, each familiar with a portion of the software.

As a result, modification to a system, either for a specific client's unique needs, or changing realities of the business environment, are time-consuming and expensive, often more so than implementation itself. The difficulty and expense of modification weds a business to its ERP system's model, often at the expense of proven practices or keeping up with competitors.

Programming Tools Currently on the Market are Intended to Make Programming Easier

While programming tools do not have anything to do with the Invention, they illustrate the evolved thinking of the market regarding software and software application development. Development tools have concentrated on the objective of making programming easier, faster, cleaner, less mistakes prone, and controlled. At times they replace cumbersome functions known as housekeeping with meta-function. No programming tool claims or expects to eliminate programming—it is, after all, a programming tool.

Magic Software™ has eliminated some programming related to creation and maintenance of database structure and relationships.

DataFlex™ from Access Data Corporation has replaced writing code for editing functions of data elements by selecting their pre-written objects.

Microsoft, the world's foremost tool developer, has introduced business class objects in its NET development tools to supplant and replace some development in conjunction with their .NET languages that are used to program applications. Microsoft, after spending about three billion dollars acquiring various ERP software products such as Navision, Great Planes Accounting and Solomon Accounting, is currently estimated to budget about $400 Million in a multi-year effort to combine these products into a uniform platform under its .NET development umbrella.

These development tools are unaware of how an ERP system operates, and are ignorant of its processes. They have no relationship to applications such as order entry, accounts receivables, etc. These tools have their mission to expedite software development and programming, not eliminate it. Most significantly, they do not even address the problem of modifications of large-scale systems, with complex dependencies, that have already been deployed.

Conventional System Modeling

BPMI.org (the Business Process Management Initiative) is a non-profit corporation that aims to empower companies of all sizes, across all industries, to develop and operate business processes that span multiple applications and business partners. To that effect they have developed for their members BPML a Business Process Modelling Language. This has evolved into a complex programming language. This prior art, does not eliminate programming; it replaces it with another programming language that happens to be at a higher layer. It does not address the issue of modification.

Note that many of the members of the organization are ERP software vendors such as Bea Systems, Computer Science Corporation, Fujitsu-Siemens, IBM, PeopleSoft, and SAP. None has abandoned its traditional programming development in favor of a completely codeless development methodology, requiring no programming. None have addressed the issue of flexible change and modification, especially of in situ systems.

Generating a complete ERP system through codeless means has not occurred by any of the existing ERP software providers. Nor has there been a comparably flexible, easily modifiable ERP system. Empirical market analysis suggests that if a prior art codeless methodology would have existed, or a comparably flexible methodology, then any of the tier-1 ERP providers such as SAP, PeopleSoft and Oracle (who among the three of them, command over 50% of the ERP market), would have allocated the relatively minor resources required to replicate existing or new products. Even tier-2 software suppliers such as JDA—a Retail vertical software provider—has spent over $60 million during 2003 and half of 2004 to re-write its vertical system in Microsoft NET.

The invention could produce a desired functional replication of such a retail vertical without any programming in less than 10,000 person/hours when deployed by business consultant, not programmers, to populate the Invention's dictionaries. The resulting product would be incomparably easy to modify and maintain, at the whims of the install base.

In a typical business software application system, the business logic and functionality of the system is hard coded into the software and is very difficult to change or modify. Furthermore, the modification of existing business software applications require a programmer. Thus, it is desirable to provide a business software application generation system and method and it is to this end that the present invention is directed.

### SUMMARY OF THE INVENTION

The business software application generation system in accordance with the invention permits a business software application to be generated rapidly and efficiently without any programming experience and knowledge so that, for example, a business industry expert can generate a business software application for a particular business industry. In accordance with the invention, the user interface, business logic and functionality of the generated business software application are stored in a plurality of tables in a database wherein the business software application is generated by an engine tool that retrieves the data about the business software application from the database and generates the business software application. The business software application generated by the system in accordance with the invention may include, but is not limited to, enterprise resource planning (ERP) software, customer relationship management (CRM) software, supply chain management (SCM) software and any other software that moves information and controls resources and processes. Note that the software is optimized for ERP (although it could be used for any database-backed, form-fronted system). Also: SCM and CRM are commonly sub-components of a typical ERP system. That is, commercial SCM and CRM are typical applications of ERP.

In the conventional business software application systems, any failure of any testing stage (as set forth above in the background ERP systems are costly to develop section) will usually return the product to a prior stage, depending on the nature of the problem. Multiple iterations of software development steps are common, and are the norm. The complex relationship of various ERP software components are too large to be encompassed by a single developer. A change to a module may have unforeseen deleterious consequences on other connected modules. Indeed the complexity of such systems is so great that a typical sales demonstration for SAP, PeopleSoft, Oracle, Intentia, or any tier-1 (over 1 B in sales) ERP vendor is conducted by multiple presenters, each familiar with a portion of the software. As a result, modification to a system, either for a specific client's unique needs, or changing realities of the business environment, are time-consuming and expensive, often more so than implementation itself. The difficulty and expense of modification weds a business to its ERP system's model, often at the expense of proven practices or keeping up with competitors.

The business software application generation system described below is optimized for change, by eliminating all programming. In particular, the inventive system deploys, for the generation of a business software application system (once the system objectives and business definitions are completed), the steps of 1) functional definition by a business analyst; 2) application testing—usually on a test system; and 3) testing in the live (production) environment. In accordance with the invention, the data and functionality definitions constructed by the business analyst is interpreted by a business software application generation engine, known as the eReplicator engine in a preferred embodiment of the invention. If the definition generating any part of the system is not satisfactory or it requires additional functions, it is modified immediately. The eReplicator engine is never touched and therefore is stable. All aspects of the ERP application are defined in metadata dictionaries. As a result, not only is implementation achieved in a fraction of the time, but modifications are trivial rather than disruptive. Iterative ERP adjustment in real-time is possible for the first time.

To develop a new business software application, the system may receive input from a user, such as an business industry expert/consultant, who defines the functions, processes, input, output, data relationships, and presentation of any data object or combination of objects by modifying data using a user interface wherein the modified data is stored in a database. Thus, there is no end-user application code. The software code associated with the business software application generation system processes the dictionary data in the database to address the business software application functions, methods, and presentation of data. In accordance with the invention, the business software application generation system permits generation of a functionally rich business software application, with equivalent or improved functions of conventional systems such as PeopleSoft, J. D. Edwards, Intentia, or other similar systems herein the construction time is less than 2,000 hours which is a significant improvement over typical business software applications. In a business software application system generated using the inventive system, the front end user interface of the business software application is interpreted from the tables of the system while the business logic and data tables are in fact generated in addition to the data dictionary representation. The business logic and data tables can be changed at will by the consultant even after implementation/installation, as if they were interpreted. More importantly, modification of a completed ERP system can be done in a matter of hours, days, or weeks (for a large customization job), rather than months. For the first time, an organization is not married to its system, and the system can change with the organization.

The skill level required to generate a business software application in accordance with the invention is that of a high-level business consultant who is an expert in the specific industry-vertical for which the system is constructed for the first time (assuming that the consultant has some rudimentary understanding of database design.) Subsequent modifications to the business software application system, the addition of a new module or application requires the consultant or analyst to be expert only on the specific industry vertical, but does not require a computer programming or database expert. In accordance with the invention, in order to modify the software business application or add a business software application, a user may modify data in the database so that a new version of the business software application with the modifications is generated by the business software application engine.

In an implementation of the business software application generation system, the system is data driven and contains a unique set of programs that derive their definitions, functions and rules from program dictionaries which are database entries that contain information that is used to generate the business software application. The system enables a quick and codeless creation and/or modification of business software application systems such as ERP (Enterprise Resource Planning) systems, which encompasses applications including SCM (Supply Chain Management) and CRM (Customer Relationship Management), without writing or modifying any programming code. Thus, the system can create a new and comprehensive ERP system with no programming.

In accordance with the invention, the program dictionaries are populated only once per industry-vertical business to provide the guidelines for the business software application in that particular industry-vertical business area. Then, a non-programmer can “modify” or “build” additional modules by adding new dictionary entries or editing existing ones, as well as remove unnecessary modules by removing dictionary entries. Then, the engine interprets the edited/new dictionaries to present a fully functional business software application system to the user.

The business software application generated using the system in accordance with the invention has the look of a traditional business software applications, containing industry-vertical defined terms and additional, specific user requirements. The system may include a plurality of templates wherein a different template or set of templates may exist for each different vertical market. Each template is predefined in the program dictionaries and are easily modified for a particular user's nomenclature. Thus, end users see the names of the specific applications and functions that they already know, such as Order Management, Pricing Module, Warehouse Management, BOM, MRP, Capacity Planning, Corporate Calendar, etc., even though the compiled code is generic and have nothing to do with such specifics. These templates, data objects, and input and output specifics are derived from the generation system's tables and attributes which define the traditional user applications and environment that fit end users' particular knowledge-sphere and needs.

The business software application generation system in accordance with the invention provides many benefits. For example, the system reduces the ongoing continuous development staff for a particular business software application. The system also permits expansion of a business software application to different vertical niches without specific programming. The system also permits the generation of non-ERP business software application systems such as collaboration software. More generally, any basic form-based, database-backed system can be created, but the invention has powerful ERP optimizations. The business software application systems generated by the system in accordance with the invention may co-exist with legacy systems by directly interfacing with them as seamlessly as with the native database. The system further provides functional duplication (literal or logical) of complex systems where their publishers have built a large maintenance business. The system also permits user to commit to future software changes on a fixed price or carte blanche basis. The system also permits the business software application systems to appeal to the untapped market of smaller businesses. The system also permits the business software application to generate large “resale” profits as the software is resold without the need for custom reprogramming, even for a new vertical market.

The system also provides highly profitable maintenance because of the minimal cost to maintain the code since there are no changes to existing attributes, methods or objects. In accordance with the invention, only newly uncovered attributes and methods require construction—and that process (done by consultants, not programmers) diminishes itself each day. The system also simplifies business software application system installations by flagging and deploying only desired input and output items, cutting implementation costs and creating a highly competitive product. The system in accordance with the invention may also function as a front-end tool to another system, using it as a migration tool from legacy systems or first as a front-end input engine and a back-end reporting and presentation. The system provides profitable incentive for third parties within a vertical to market and install the software in that their training is minimal since they only have to understand their vertical. The system sets up the methodology since, once an initial system has been built for a vertical, there is no need to understand tables, rows, records, field relationships, indexes, or joins.

### BRIEF DESCRIPTION OF THE DRAWINGS

FIG. 1 is a diagram illustrating a conventional hard-coded business software application;

FIG. 2A illustrates an example of a business software application generation system and method in accordance with the invention;

FIG. 2B illustrates an example of a hardware implementation of a business software application generation system in accordance with the invention;

FIG. 2C is a diagram illustrating more details of the engine in accordance with the invention;

FIG. 3 illustrates an example of building industry vertical business software application templates for the business software application generation system in accordance with the invention;

FIG. 4 illustrates an example of a customer-specific business software application generated by the business software application generation system in accordance with the invention;

FIG. 5 is a model of a generic enterprise resource planning (ERP) system;

FIG. 6 is an example of a customer-specific business logic for an ERP system;

FIG. 7 illustrates a generic application level/model;

FIG. 8 illustrates an example of an ERP system with multiple process types;

FIG. 9 illustrates an example of an application level definition;

FIG. 10 illustrates an example of a level instantiation;

FIG. 11 illustrates more details of the level instantiation shown in FIG. 10;

FIG. 12 illustrates an example of resource types in accordance with the invention;

FIG. 13 illustrates an example of a resource table;

FIG. 14 illustrates an example of simplified sale order application that may be implemented using the business software application system in accordance with the invention;

FIG. 15A illustrates a transaction model in accordance with the invention;

FIG. 15B illustrates an example of a generic ERP system in accordance with the invention in which an update method updates tables from stage to stage, application to application, resources and other portions of an application;

FIGS. 16A-N illustrate examples of application transaction tables in accordance with the invention;

FIG. 17 illustrates an example of an update method sub-process in accordance with the invention;

FIG. 18 illustrates examples of the update method in accordance with the invention;

FIG. 19A illustrates a resource update process in accordance with the invention;

FIG. 19B illustrates an example of a dependent stage update process in accordance with the invention;

FIG. 19C illustrates an example of the transaction table for the dependent state update method shown in FIG. 19B;

FIG. 20 illustrates an example of an application update in accordance with the invention;

FIG. 21 illustrates a method for building an update method using an automated process in accordance with the invention;

FIG. 22A is a diagram illustrating an example of the user interface for the update method designer;

FIG. 22B is an example of the update method options user interface;

FIG. 22C is an example of a parameters editor user interface for an update method;

FIG. 22D is an example of a more details parameters editor user interface for an update method;

FIG. 22E is an example of a server function options user interface in accordance with the invention;

FIG. 23A is a table illustrating an example of the basic statements of an update method in accordance with the invention;

FIGS. 23B-I are diagrams illustrating further details of the statements shown in FIG. 23A;

FIGS. 24A-C are diagrams illustrating the data tables in accordance with the invention used to store an update method in accordance with the invention;

FIGS. 25A-F illustrate more details of the update method designer in accordance with the invention;

FIGS. 26A-C illustrates a validation designer in accordance with the invention;

FIG. 27 is a diagram illustrating the system database tables of an example of the business software application generation system;

FIG. 28 illustrates more details of the universal database connectivity that is provided by the system in accordance with the invention;

FIG. 29 is a diagram illustrating an example of a definition of a column table for system tables of the system in accordance with the invention;

FIG. 30 is a diagram illustrating an example of a definition of a table containing information about the tables for system tables of the system in accordance with the invention;

FIGS. 31A and 31B illustrating an example of a definition of a table columns table containing information about the columns of the tables for system tables of the system in accordance with the invention;

FIG. 32 illustrating an example of a definition of a connection type table containing information about the type of non-native database connected to the system in accordance with the invention;

FIG. 33 illustrating an example of a definition of a connection table containing information about the external database connections of the system in accordance with the invention;

FIG. 34 illustrates a method for representation a table in accordance with the invention;

FIG. 35 illustrates an example of a method for opening a table in accordance with the invention;

FIG. 36 is a diagram illustrating more details of the DBConn object shown in FIG. 35;

FIG. 37 illustrates a method for saving table data/modifying table data in accordance with the invention;

FIG. 38 illustrates a method for modifying table schema data in accordance with the invention;

FIG. 39 illustrates an example of a user reference form in accordance with the invention;

FIG. 40 illustrates an example of a user reference form results tab in accordance with the invention;

FIG. 41 illustrates an example of a column designer user interface in accordance with the invention;

FIG. 42 illustrates an example of a database designer user interface in accordance with the invention;

FIG. 43 illustrates an example of a table designer user interface in accordance with the invention;

FIG. 44 illustrates an example of a table column designer user interface in accordance with the invention;

FIG. 45 illustrates an example of a table column designer zoom user interface in accordance with the invention;

FIG. 46 illustrates an example of the ddLanguage table in accordance with the invention;

FIG. 47A illustrates an example of a user interface in the system to change the language of the business software application interface in accordance with the invention;

FIG. 47B illustrates the user interface of the business software application once the Chinese language has been selected;

FIGS. 48A and 48B illustrates an example of the business software application feature (a customer master) user interface for a web-based system and a Windows-based system, respectively;

FIGS. 49-58 illustrate more details of the application levels and application level designer in accordance with the invention;

FIG. 59 illustrates the ddColumns table of the database structure of FIG. 27;

FIG. 60 illustrates the ddTable table of the database structure of FIG. 27;

FIGS. 61-1 and 61-2 illustrate the ddTabCols table of the database structure of FIG. 27;

FIG. 62 illustrates the ddForms table of the database structure of FIG. 27;

FIG. 63 illustrates the ddFormItems table of the database structure of FIG. 27;

FIG. 64 illustrates the ddMultiForm table of the database structure of FIG. 27;

FIG. 65 illustrates the ddMlFmltm table of the database structure of FIG. 27;

FIG. 66 illustrates the ddProcAttr table of the database structure of FIG. 27;

FIG. 67 illustrates the ddProcDtl table of the database structure of FIG. 27; and

FIG. 68 illustrates the ddTabRels table of the database structure of FIG. 27.

### DETAILED DESCRIPTION OF A PREFERRED EMBODIMENT

The invention is particularly applicable to a computer implemented system for generating an enterprise resource planning software system and it is in this context that the invention will be described. It will be appreciated, however, that the business software application generation system and method in accordance with the invention has greater utility as the system may be used to generate various different types of business software applications, including but not limited to customer relationship management (CRM) software systems, supply chain management (CSM) software systems, payroll systems and collaboration software. In fact, the business software application generation system in accordance with the invention may be used to generate any software system that models business processes and stores and manipulates business data. For example, any software system that is capable of being modeled using an application and level model in accordance with the invention as set forth below may be generated using the business software application generation system.

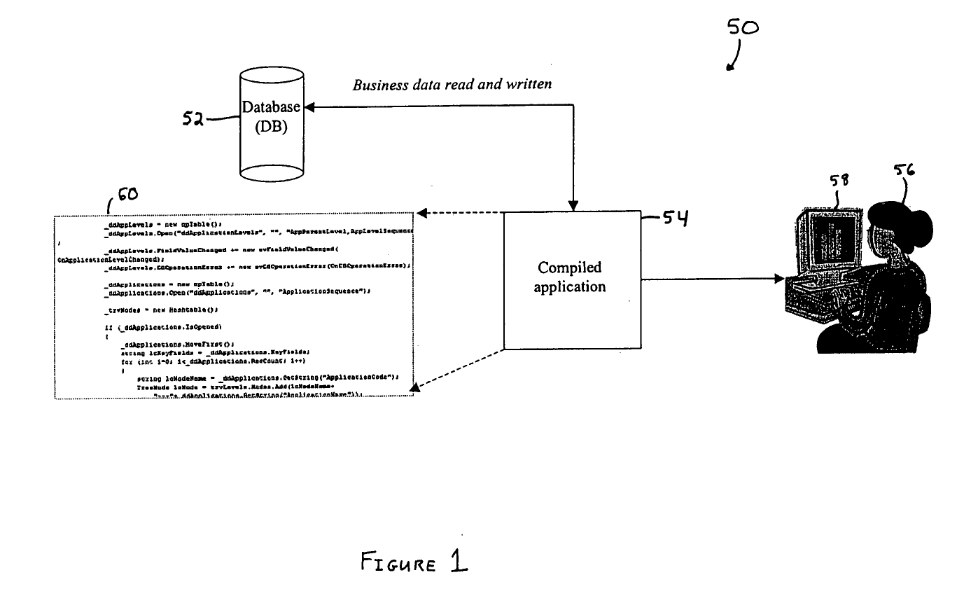

To better understand the business software application generation system in accordance with the invention, an example of a typical business software application system will be briefly described. FIG. 1 is a diagram illustrating a conventional hard-coded business software application system 50. The system 50 has a database (db) 52 and a compiled business software application 54 that are interconnected together wherein business data is read from and written into the database 52. The compiled business software application 54 consists of one or more software executable software modules that reside of a computer system, such as a server, and are executed by the processor of the computer systems to implement the business software application functionality. The compiled application 54 may generate a user interface that is provided to a user 56 that may access the business software application using a typical client computer system 58 that is connected to the computer system executing the compiled application 54 by a typical computer network.

As shown in FIG. 1, the compiled application 54 may comprise a plurality of lines of computer code 60 wherein the hard-coded computer code specifies the business software application definition, the user interface, the business logic within the business software application and the database structure of the database associated with the business software application. For this typical business software application system, the system definition, business logic and database structure are hard-coded. As a result, it is not possible to change/modify/update the business software application system without rewriting and recompiling the computer code which is a very slow, tedious, labor intensive and expensive process. In accordance with the invention, it is desirable to provide a business software application generation system which does not require the re-coding and recompiling process in order to update/change/modify a business software application. Furthermore, it is desirable to provide a business software application generation system that permits a new business software application to be generated without the computer programming expertise and coding typically required. A business software application generation system in accordance with the invention achieves these goals and overcomes the limitations of the typical business software application shown in FIG. 1. This business software application generation system in accordance with the invention will now be described.

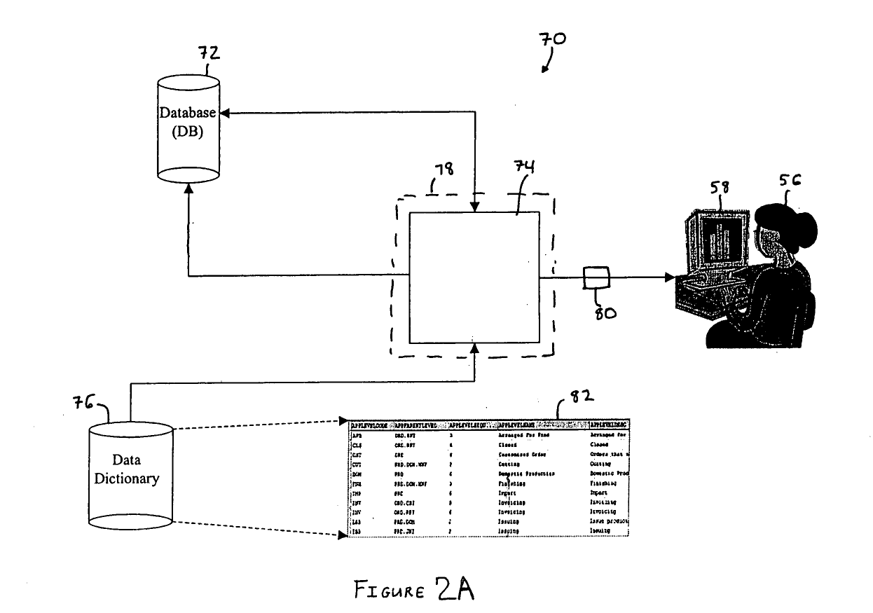

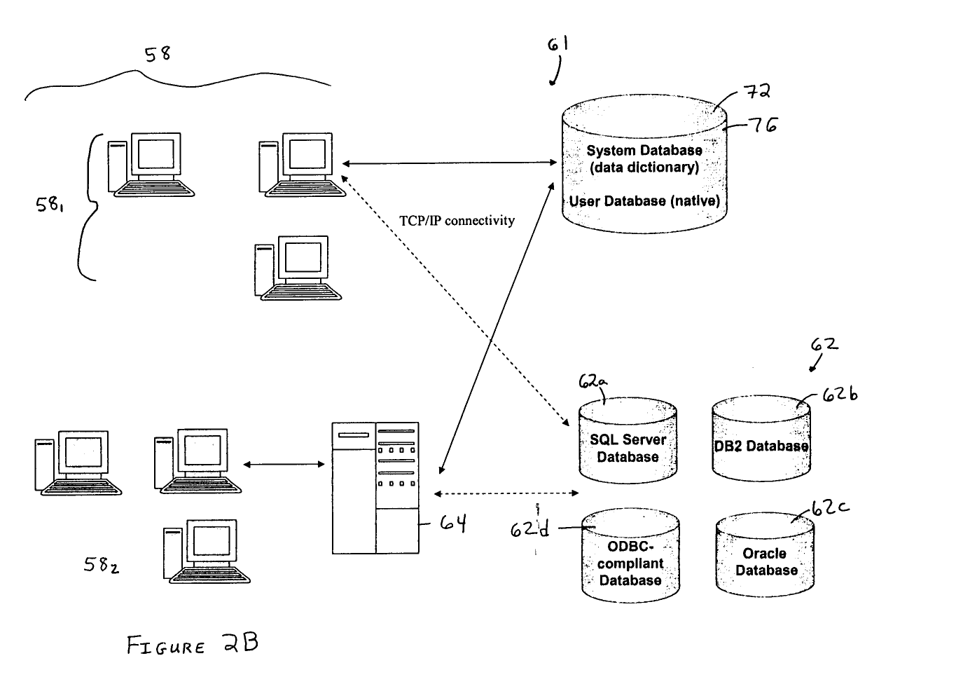

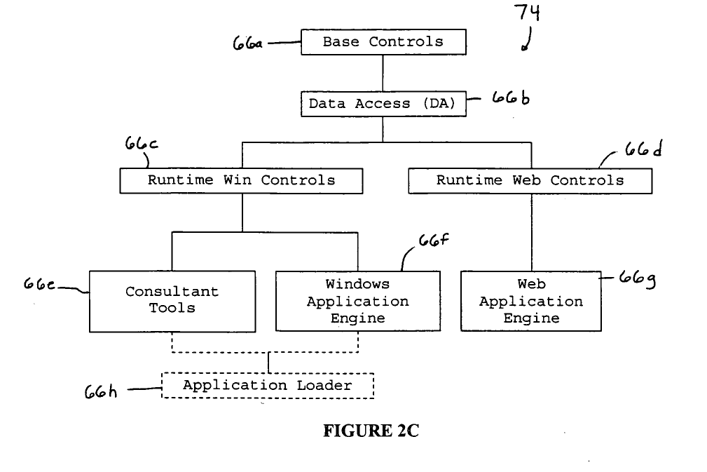

FIG. 2A illustrates an example of a business software application generation system and method 70 in accordance with the invention. The system comprises a database (db) 72, an engine 74 and a data dictionary 76 that are interconnected to each other over a typical computer network (now shown). The database 72 and data dictionary 76 may be separate databases (on different database servers or two different databases stored on the same server) or the database 72 and data dictionary 76 may be stored in a single database server and/or single database. The engine 74, in a preferred embodiment, may be one or more software modules (compiled computer code with a plurality of instructions) stored on a computer system 78, such as a local client (Windows implementation) or web application server (Web implementation), and executed by a processor (not shown) of the computer system. As shown in FIG. 2A, the engine 74 is a compiled piece of software that may reside on a local user computer, pulls data from the database 72 and data dictionary 76 to generate the business software application 80. The engine may also be a Windows form engine that operates on a Windows operating system, a Unix/Linux based engine or based/operating with various other different operating systems. These implementations of the engine are fat client implementations. Furthermore, the engine 74 may be located on a web server and generate web pages to each user with the user interface of the business software application (known as a thin client implementation) wherein the user computer only needs a typical browser application to generate the business software application.

The computer system 78 may include the well known components of a typical computer system (not shown) including one or more processors, a persistent storage device, such a hard disk drive. optical drive, tape drive, removable media device, etc., memory, such as DRAM or SRAM, input/output devices and a connection to the computer network. In other embodiments, the engine 74 may be stored on a piece of media, such as a flash memory device, CD, DVD, etc. so that it may be loaded onto a computer system and executed or executed from the piece of media. In other embodiments, the engine 74 may be stored on/hard-coded into a hardware device. In accordance with the invention, the engine 74 (or interpreter as it interprets the data in the data dictionary in order to generate a business software application 80) reads data from the data dictionary 76 to present the business software application 80 user interface and functionality to the user 56 that accesses the business software application using the client computer 58. In accordance with the invention, one or more client computers 58 and users may be connected to and interacting with the generated business software application 80. The business software application system 80 is defined by adding/modifying entries 82 to the data dictionary 76, and customizations involve editing those entries. The entries in the data dictionary define the user interface, database structure, forms layout, menu structure and customized business logic for the business software application system. In a preferred embodiment, the data dictionary 76 may comprise one or more inter-related/relational database tables. The data in the data dictionary, however, may be stored in other manners that are within the scope of the invention. In accordance with the invention, the engine 74 reads the entries 82 in the data dictionary 76 to present a fully functional, fully customized business software application system 80 to the end user 56. The business software application system generated by the system 70 will operate and function in the same manner (and provide the same user experience) as a typical hard-coded business software.

As shown in FIG. 2A, business data associated with the generated business software application 80 is read from and stored in the database 82. In addition, the database structure and business logic for the business software application 80 is built by the engine 74 based on the data in the data dictionary 76 (stored in the database 72 in this example). In FIG. 2A, both the data dictionary 76 and the database 72 are shown to differentiate between the database tables that define the system (the data dictionary) and the database tables (stored in the database 72) that are built from the data dictionary and consumed by the end-user system. For convenience, the data dictionary tables are referred to as system tables and the end-user tables are referred to as user tables. Thus, the system tables provide guidance to the engine 74 on how to build and present the business software application system (for example: Tables, Columns, Forms, Controls, Labels, Resources, Modules, Processes) and the content of the system tables define the business software application system. The user tables are defined in the system tables and are generated to be consumed by the end-user system (for example: Customers, Orders, Materials, Warehouses, and Salesmen).

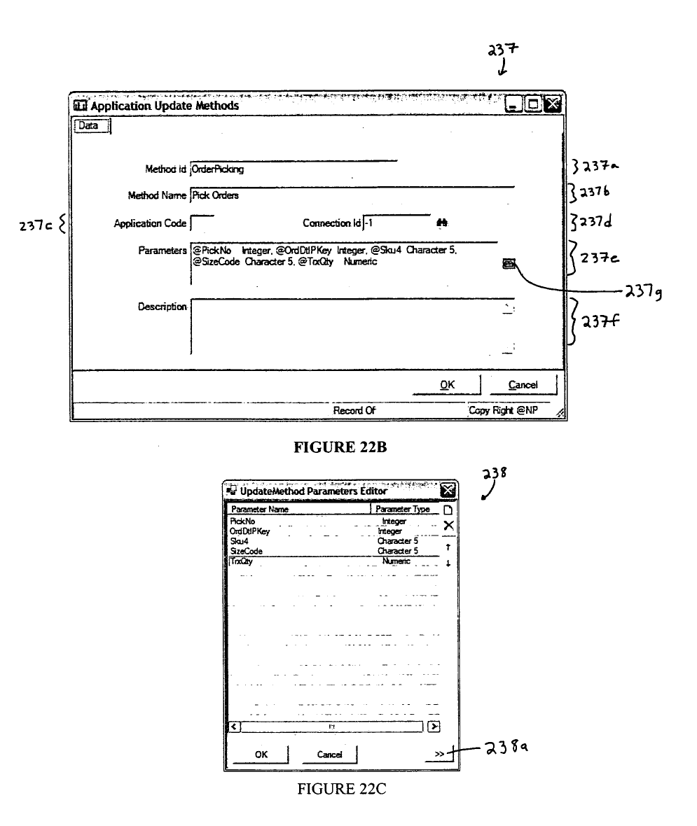

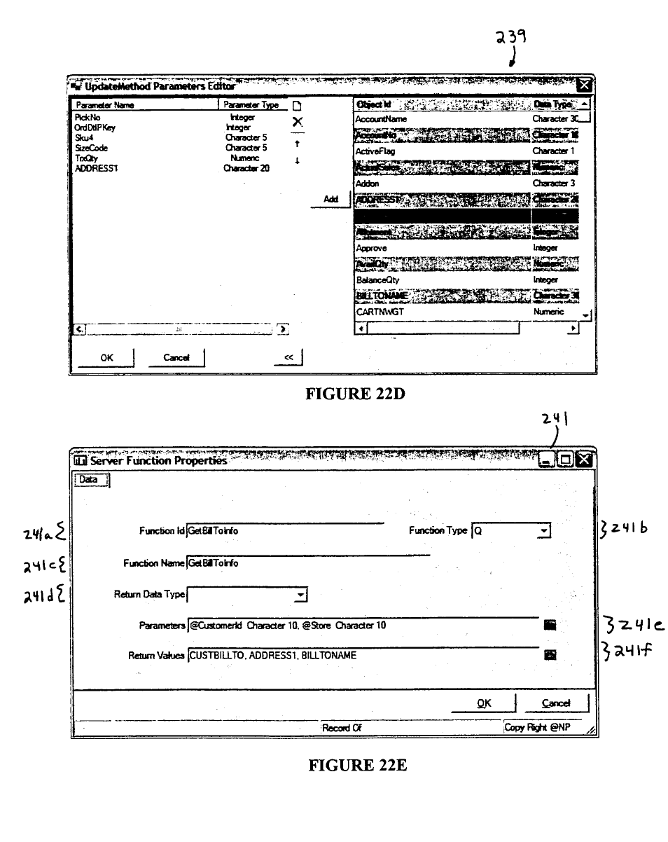

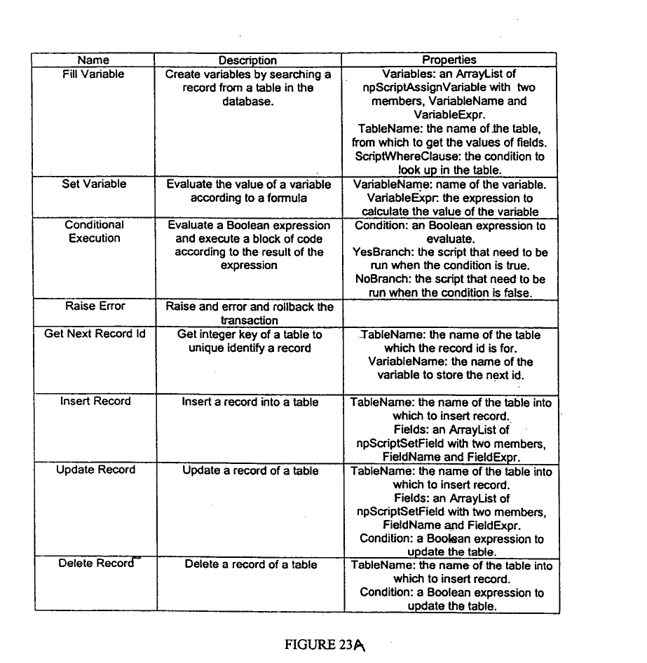

As set forth above, the system includes business logic that is built by the engine 74 based on the data in the data dictionary 76. Thus, all business logic created by the system is stored in the system tables in the invention's native format and even incomplete work may be saved. When the business logic is completed, then the consultant explicitly chooses to generate converted code to be saved to the format of the backend database. In accordance with the invention, there are three kinds of business logic in the invention's model including update methods, validations and server functions. The update methods are methods that are usually used to explicitly update data within the user database and the update methods are converted and stored in the user database as stored procedures, and are called externally on demand. The validations are used to make sure that any data saved to a table conforms to explicit rules. The validations are stored in the user database as triggers and may also be used for event-based logic. The validations may also write data to the user database if a condition fails or is met. The server functions are used to make calculations and return values. Unlike update methods and validations, server functions may not actually write data to the user database and are converted and stored in the user database as server-side functions. Other than the exceptions noted above, the different business logic types are very similar to each other. In particular, they share a similar user interface for the consultant, syntax for the native scripts, and are even stored in similar system database tables. Below, the user interface, syntax and database tables for an update method is described (See FIG. 22 et seq.), but the description also apply to the server functions and validations.

The business software application system in accordance with the invention may have one or more different individuals that interact with the system. Those people may include a programmer, a consultant and a user. The programmer is an employee who works on building the system tables and the engine. The programmer obviously needs to know how to program, but should not require industry vertical expertise. The consultant is a system analyst or business analyst who populates the system tables using our tools, building an actual business software application, such as an ERP system, without any writing of computer programming code. The consultant needs to have expertise in the industry for which the end-user system is built (chemical, automotive, etc), but does not require programming expertise. The consultant is responsible for defining the user table structure, input forms, business processes, business logic, etc. The user is an end-user of the system created by the consultant, such as an accountant, warehouse employee, executive, order entry clerk, production expeditor, etc. Now, an example of building an industry vertical business software application template using the system and then an example of a customer-specific business software application from the template are described.

FIG. 2B illustrates an example of a hardware implementation 61 of a business software application generation system installation in accordance with the invention. The hardware implementation 61 has one or more client computers 58, such as one or more fat clients 58, and one or more web clients 582, wherein each fat client is a computer device that has software executing on it including a Windows operating system, a .Net 1.1 software application, an eReplicator Windows client engine 74 and wherein each web client may include a typical web browser software application being executed by the underlying computing device. In more detail, the web client end user merely requires a computing device with a Javascript compliant web browser, and connectivity to the Web Application Server. For both of these types of clients, the computing device may be a typical personal computer, workstation, PDA, cellular phone or other computing device with sufficient memory and computing resources to execute the software to access the system. In the case of the web clients 582, the computing device may include significantly less computing resources since the web client must only be able to execute a browser application. For the web clients 582, the installation further comprises a web application server 64 that includes at least a Windows Server installation (2000, XP or 2003), an Internet Information Service (IIS) component, and ASP.NET component and an eReplicator web client. As shown, the clients 58 (though the web application server 64 in the case of the web clients 582) have a network connection, such as TCP/IP connectivity, to the databases of the system including the system database 72 (which in this exemplary installation includes the data dictionary 76) and zero or more external databases 62. In accordance with the invention, the system database may be located on one or more database server(s) with Windows Server (2000, XP, 2003) and Microsoft SQL Server. This server is required for the System Database (data dictionary). The native user database may reside on the same server, or on an external server with SQL Server installed.

The external databases 62 may include one or more of an SQL server database 62a, a DB2 database 62b, an Oracle database 62c and an ODBC-compliant database 62d. In accordance with the invention, the external database may include any currently or future supported database. The external database may reside on any operating system supported by the database manufacturer. In this installation, note that the Web Application Server and the multiple Windows Clients communicate concurrently with the same system and user databases. Also note that the Web Clients communicate concurrently with the same Web Application Server. Thus, the net result is that multiple web users and windows users consume the same system and user databases concurrently. In accordance with the invention, the business logic and data associated with a particular instantiation of a business software application may be stored on any server.

FIG. 2C is a diagram illustrating more details of the engine 74 in accordance with the invention. As described above, in a preferred embodiment, the engine is implemented as one or more software modules/components implemented in a plurality of instructions of object oriented programming code that operate together to provide the functionality of the business software application generation system. Thus, in a preferred embodiment, the engine 74 may include a base control component 66a, a data access component 66b, a runtime win control component 66c, a runtime web control 66d, a set of consultant tools 66e, a windows application engine 66f, a web application engine 66g and an application loader 66h. The base control component is the building block for the system and may include virtual classes for UI controls (inherited by Runtime Win Controls and Runtime Web Controls), utility classes for convenience functions (usually data type conversion functions); file access classes and system configuration classes. The classes in the base controls may be inherited and consumed by classes across the system and in the other components shown in FIG. 2C. The data access component 66b has one or more classes that are used for database interaction. These classes allow the front end to be blind to the back-end database. The runtime control classes (See 66c and 66d) consume generic data access classes. The generic data access classes then compute which database-specific classes to call for database access. Thus, the data access component 66b includes, but is not limited to, important classes discussed in this application, such as npTable, npDDTable, and DBConn.

The runtime win control and runtime web control components 66c, 66d includes the user interface (UI) controls in Windows Forms and Web Forms: menus, checkboxes, textboxes, dropdown lists, forms, etc. They are richer than standard UI elements, because their behavior is directly linked to data access elements (for example, form UI elements link to instances of npColumn). The consultant tools component 66e is a set of tools that a consultant uses to build an ERP or other business software application system. The tools include, but are not limited to, Column Designer, Table Designer, Form Designer, Query Designer, Update Method Designer, Validation Designer, Menu Designer, UI Screen Designer, Application Level Designer, Report Designer, etc. These tools populate the system tables with the relevant metadata required to run a fully functioning ERP or other business software application system, and create the user tables and server-side business logic required to run the ERP or other business software application system. The windows application and web application engines 66f, 66g present the various applications of the completed ERP or other business software application system to the end user, based on the definition in the system tables. It generates the menus, forms, queries, applications, screens, reports, etc. which are presented and used by the end-users. In accordance with the invention, for ease of development, there is a container component shown as the Application Loader 66h that presents both Consultant Tools and the finished Windows Applications to the user. This allows consultants to easily develop and test systems with the invention in the same window. The security model allows consultant tools to be hidden from end users.

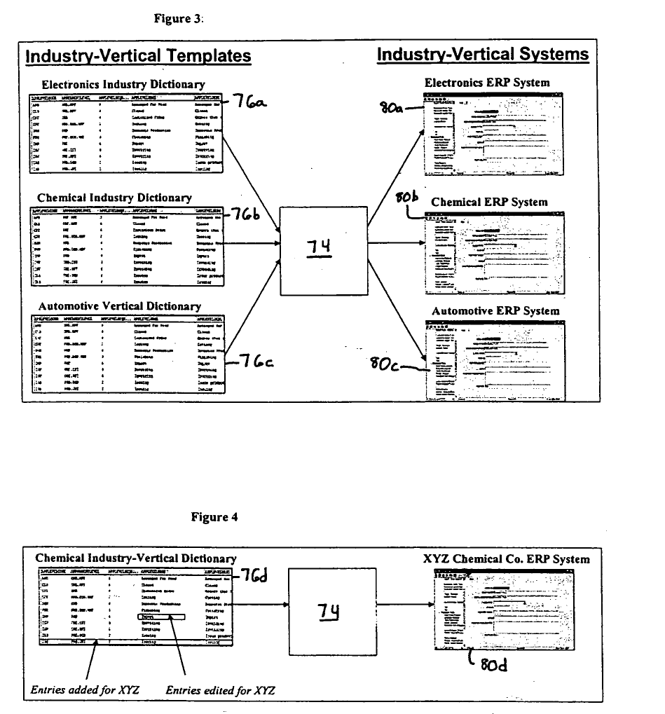

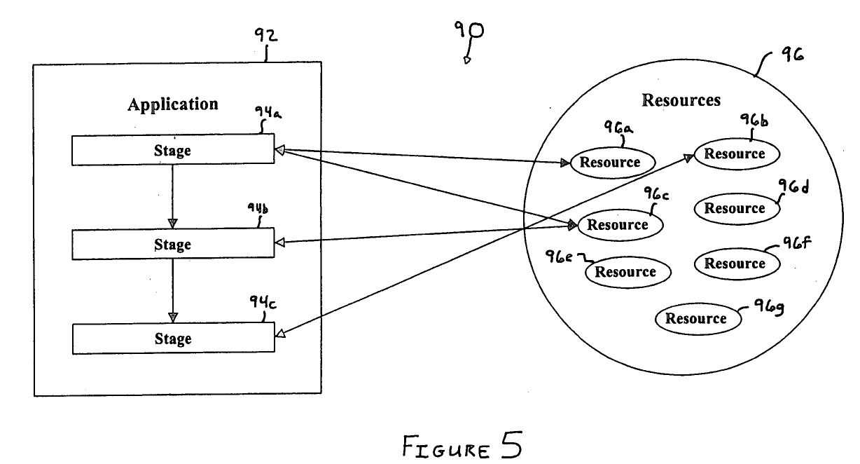

FIG. 3 illustrates an example of building industry vertical business software application templates for the business software application generation system in accordance with the invention. In particular, the engine 74 of the business software application generation system uses the data dictionaries 76a-c for different industries to generate one or more industry-vertical business software application systems 80a-c. Thus, for example, there may be an electronic industry data dictionary, a chemical industry data dictionary and an automotive industry data dictionary (created by the programmer or consultant) which are used to rapidly generate an electronics ERP system 80a, a chemical ERP system 80b and an automotive ERP system 80c. In accordance with the invention, the strategy is to first invest time configuring a system for a specific industry-vertical, such as Chemicals, Electronics, or Automotive as shown in FIG. 3. Then, these industry general systems 80a-c can be customized easily for specific customers' organizations. Thus, as shown in FIG. 4, a customer-specific business software application 80d generated by the business software application generation system in accordance with the invention wherein entries in the data dictionary for the chemical industry are modified to generate a modified data dictionary 76d that is then used by the engine 74 to generate a customized business software application system 80d. The customized system 80d has been customized for a particular company XYZ Chemical Co. Thus, in accordance with the invention, the customized business software application system 80d for a particular customer may be easily generated without any programming knowledge since a consultant only needs to modify the entries in the data dictionary in order to modify the business software application.

Thus, the first stage (industry-vertical) shown in FIG. 3 will take the most significant amount of time and requires more senior consultants who have some technical experience and understand database tables and relationships. The second stage (customer-specific) shown in FIG. 4 consumes considerably less time and requires industry or client application knowledge, but none or minimal technical expertise from a consultant. While the business software application system allows the consultant to do scripting, no scripting (i.e. coding) is required. All business processes can be modeled with the engine tools without requiring coding or script writing from the consultant.

Now, more details of the business software application generation system will be described. In order to describe the details of the invention, a specific example of an implementation of the system, namely an ERP generation system that generates an ERP business software application, will be used. In the example shown, a very simple example of an ERP system is described for clarity although the invention may be used to generate very complex ERP systems. Furthermore, the invention is not limited to the ERP example shown and described as the invention may be used to generate/modify/update a variety of different business software applications as described above.

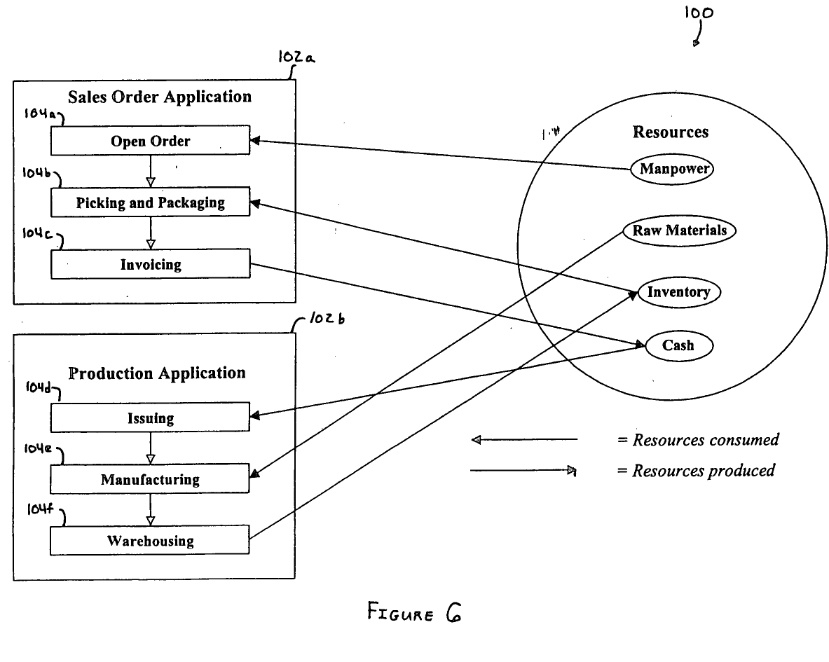

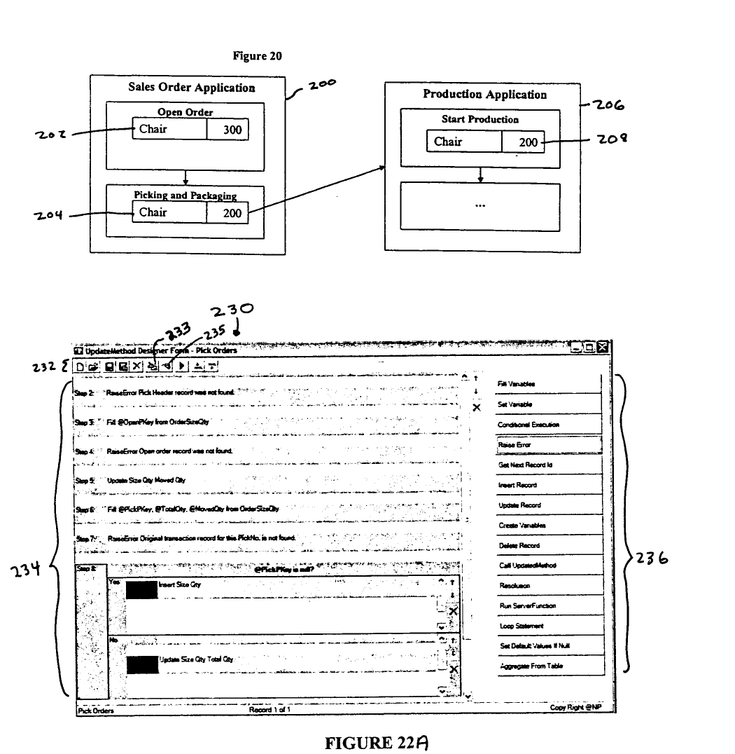

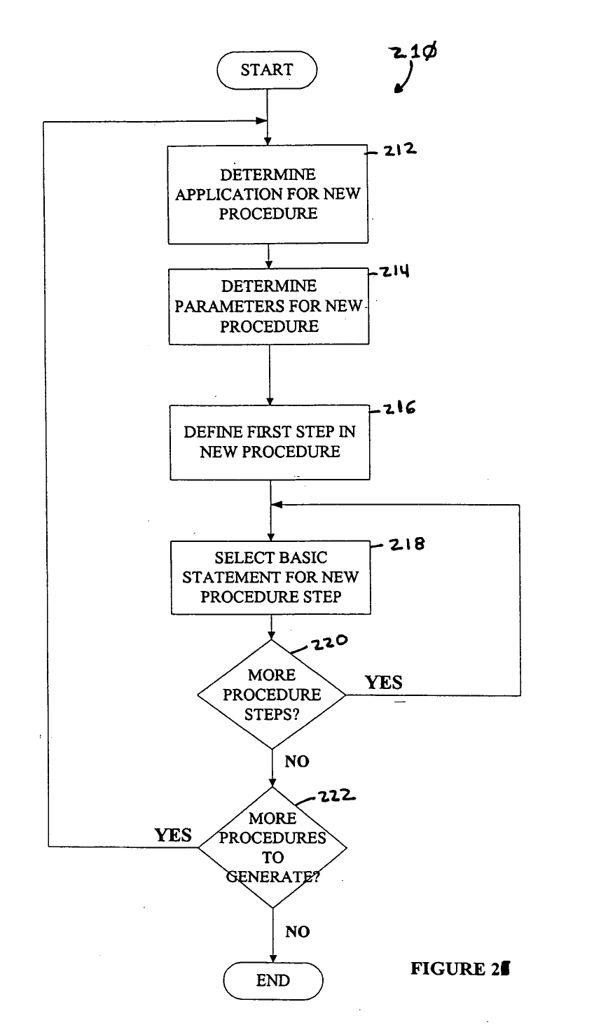

FIG. 5 is a model of a generic enterprise resource planning (ERP) system 90 that may be used in accordance with the invention to generate a data dictionary for a generic ERP system that may be later utilized to generate customized ERP systems. In particular, the model of a generic ERP system is that it has one or more applications 92 (one is shown in FIG. 5) wherein each application 92 has one or more stages 94, such as stages 94a-94c shown in FIG. 5, wherein each stage may consume and/or produce resources 96, such as resources 96a-g shown in FIG. 5. Thus, all ERP systems consist of applications 92 that model the essential business processes (for example: Sales Order, Production Management, Bill of Materials) for the business process being managed using the ERP system. Each application 92 models at least one business process as a series of stages 94 wherein each stage represents a specific point in the timeline of the business process (for example: Open, Pick, Invoice). Then, each stage consumes, produces, modifies, forwards or acts on resources 96 (such as Raw Materials, Finished Goods, Cash, or Manpower). An example of a model for a SCM system is shown below in FIG. 20.

FIG. 6 is an example of a customer-specific business logic for an ERP system 100 wherein the model shown in FIG. 5 is modified for a particular ERP system by modifying the data dictionary. In particular, the customer-specific ERP system has a sales order application 102a and a production application 102b wherein the sales order application has an open order stage 104a, a picking and packaging state 104b, an invoicing stage 104c and the production application has an issuing stage 104d, a manufacturing stage 104e and a warehousing stage 104f. For this customized system, the open order stage 104a consumes manpower resources, the picking and packaging stage consumes inventory resources and so forth as shown in FIG. 5. To develop this ERP system, the generic ERP model (a template data dictionary) is used and then each application and each application stage is defined. Then, the resources associated with the ERP system are defined and finally the resources being consumed/produced at each stage is defined. Thus, a consultant builds the application within the system by defining the specifics shown in FIG. 6 using the tools of the business software application generation system in accordance with the invention. These definitions live in the system tables, and are quickly modified. The code in the engine reconstructs and runs the applications at runtime based on the definitions in the system tables and its understanding of the generic model.

The universal/generic ERP constructs as shown in FIG. 5 may include resources, applications, and levels wherein the levels may include types (different business processes or paths in a business process) or stages (different steps within a path of a business process). In accordance with the invention, each business process may be modeled using this application, level and resource model so that it may then be generated using the business software application generation system. These generic constructs may be stored in the engine which may be, for example, optimized for generating ERP applications. Then, the specific business constructs are stored in the data dictionaries. The specific business resources may include, for example, cash, materials (fabric, buttons, plastic, widgets), manpower and electricity. Examples of the applications may include sales orders, production orders, bill of materials, inventory adjustment and warehouse space adjustment. Examples of process types may include (for examples of sales orders) customized order and a repeat order. Examples of the process steps (for a sales order/repeat order for example) may include arranged for production, closed, invoicing, management approval, picking and packaging, open order, warehouse receiving and shipping. Now, more details of each of these constructs will be provided to better understand the framework in which the business software application generation system is utilized.

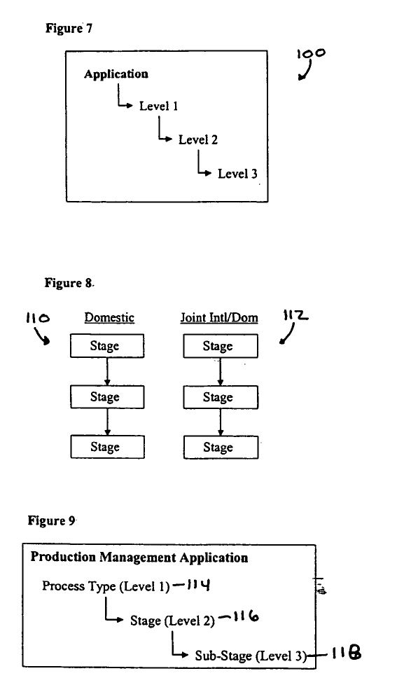

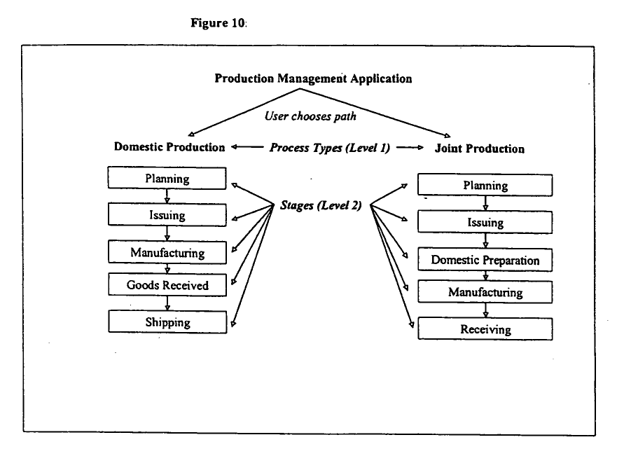

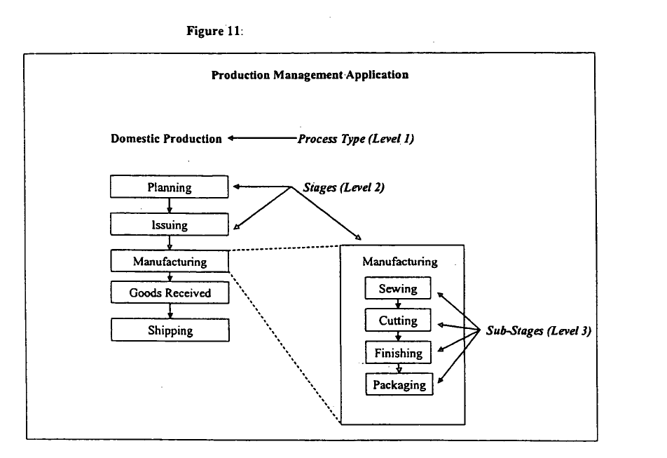

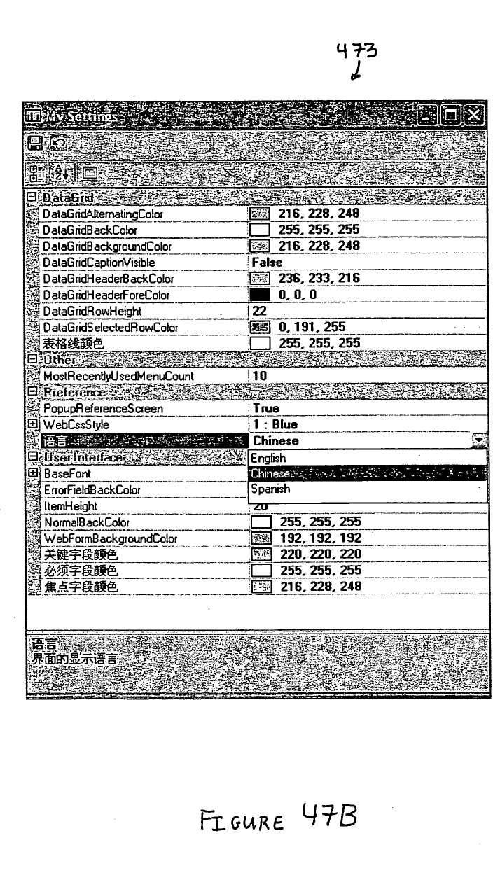

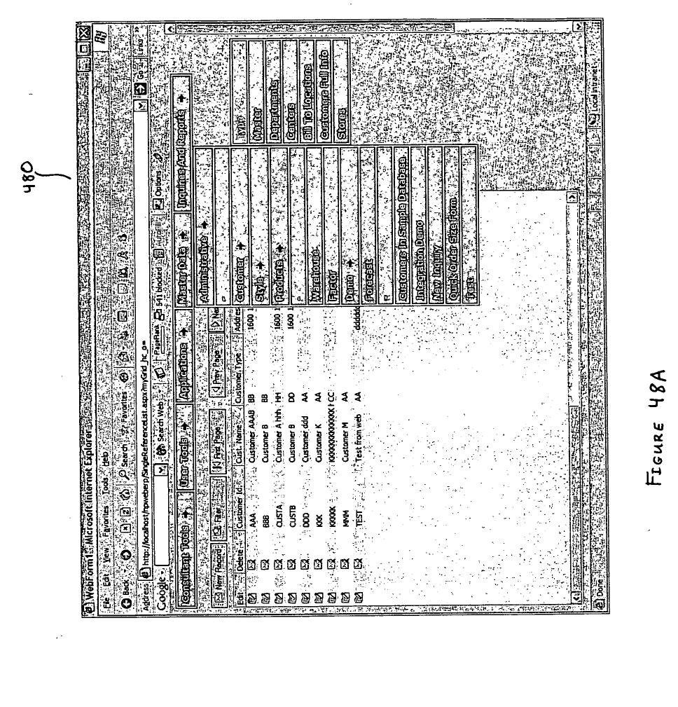

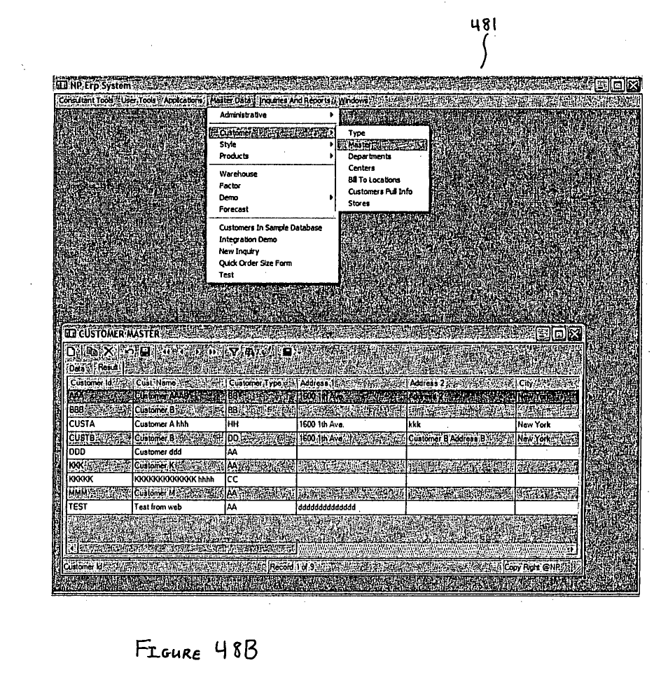

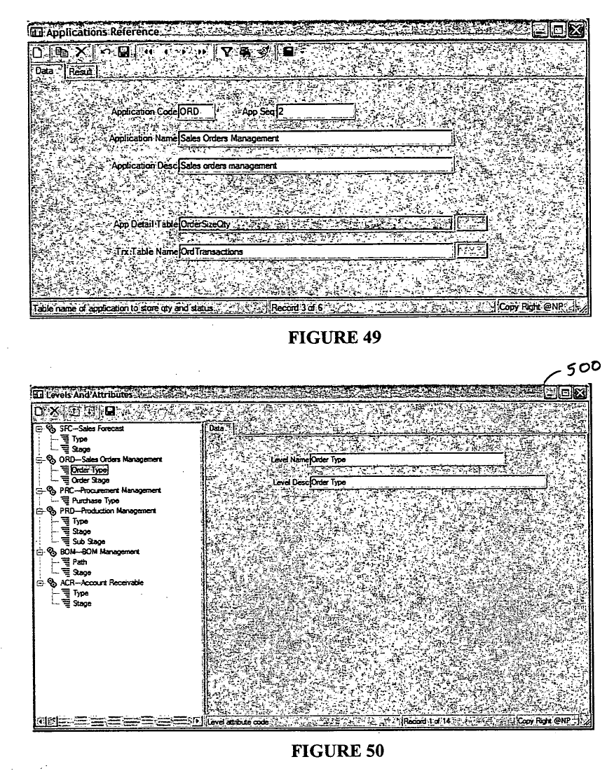

FIG. 7 illustrates a generic application level/model 110 wherein an application may include one or more nested levels and sub-levels. Further details of the generation of an application and the application levels is described below with reference to FIGS. 49-58. Thus, the business software application generation system models applications with substructures known as levels. These are generic enough to allow the consultant even more flexibility when building the application, by explicitly declaring the hierarchy within the application itself. For example, within a Production Management Application, there might be more than one process timeline, depending on the situation. The consultant might wish to define different timelines for domestic production 110 and joint domestic/international production 112 as shown in FIG. 8. For each application as shown in FIG. 9, there may be one or more levels such as a process type 114 (Level 1), a stage 116 (Level 2) and a sub-stage 118 (Level 3). With this hierarchy declared by the consultant, specific Process Types and Stages can be defined with different levels as shown in FIG. 10 wherein two different process types (Domestic Production and Joint Production) are defined as well as one or more stages (Level 2) for each process type. Note that the consultant can drill down the levels as deep as she wants (in this example, 3). This allows very flexible, complex modeling of ERP business processes. FIG. 11 shows a further drill down of the sub-stages (Level 3) for the manufacturing stage of the domestic production process type. Thus, in accordance with the invention, the application level model permits business processes with a plurality of different steps/stages to be modeled in the business software application system, but also permits a business process with a single stage to be accurately modeled. Now, further details of the resources in a business software application will be described.

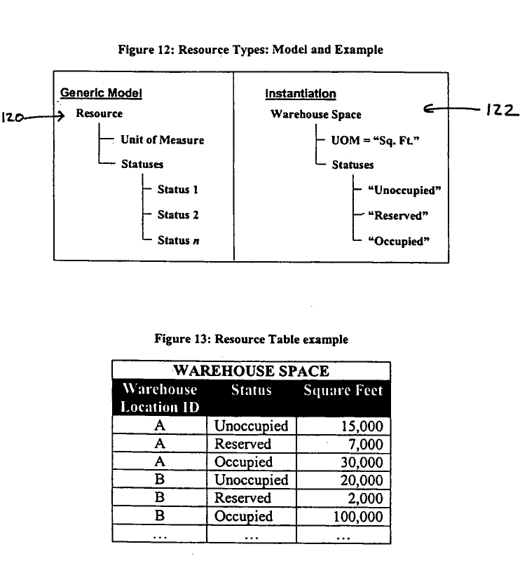

FIG. 12 illustrates an example of resource types in accordance with the invention. In particular, an example of a generic resource model 120 and an example of an instantiation of an ERP specific resource 122 are shown. As described above, resources model real world entities that can be measured or counted. For example: “square footage in Warehouse B”, “cash available to the accounting department” and “number of buttons in stock” are resources. They are consumed and produced by applications. The resources are classified into types, which are defined by the consultant. Resource types can include materials, cash, warehouse space, production capability, or anything else that the consultant may identify for her industry or business. Resource types, such as the generic model 120, are declared in the system tables. Thus, the resource type is used to generate the particular resource types for a specific business software application system. Thus, in the example shown in FIG. 12, the generic model 120 may include a unit of measure parameter, and one or more status parameters, such as Status 1, Status 2, . . . , Status n. In accordance with the invention, all resources of the same type have the same unit of measure (dollars, square feet, units, yards, liters), defined by the consultant. In addition, each resource type has statuses that convey the state of the resource. For example, a resource type of “Warehouse Space” 122 might have valid statuses of “Unoccupied”, “Reserved”, and “Occupied” as shown in FIG. 12 as well as a unit of measure of “Sq. Ft.”.

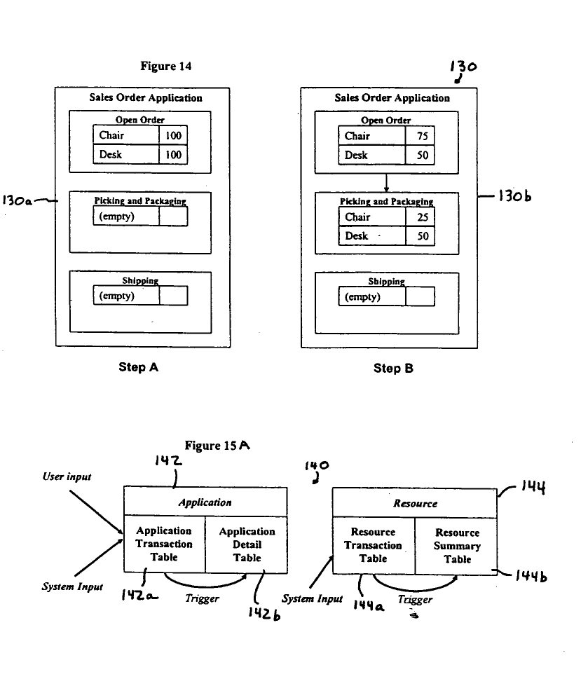

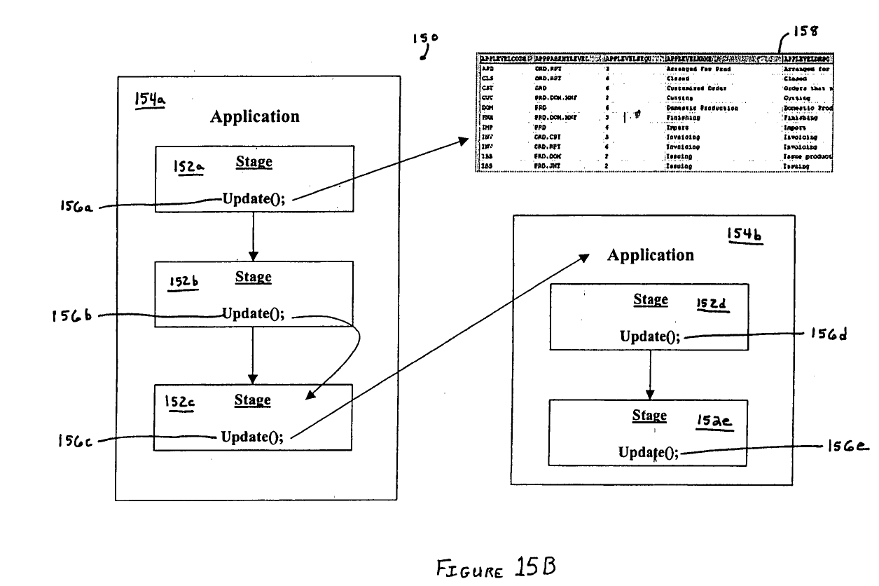

Thus, once the types are declared in the ddResources table, resource tables are created in the user database to track the quantities of the organizations resources for the particular user. In accordance with the invention, a consultant may define the schema of the resource tables in the system tables, allowing the consultant the flexibility to model business needs unanticipated by the original programmer of the engine 74. Once the resource schema is defined in the system tables, the particular resources may be instantiated in the user tables. However, there are certain generalities that may be included into the business software application generation system that consultants will probably reuse. Those generalities may include one summary table for each resource type, with one record for each resource (they may or may not join to detail tables). Furthermore, quantities may be tracked by resource status. So, for example, each warehouse's unoccupied space will have a dedicated quantity, as will its reserved space and occupied space as shown in FIG. 13. In accordance with the invention, the business software application generation system may include a set of the most common resource tables so that a consultant might not even need to design the resource table schema, but only have to modify them. Now, an example of a simplified application for a ERP application will be described in more detail.

FIG. 14 illustrates an example of simplified sale order application 130 that may be implemented using the business software application system in accordance with the invention. As stated, an application consists of a linear progression of steps that model a business process. When a user uses an application, he picks from valid resources (e.g. “chairs” in the example shown in FIG. 14) and moves a finite quantity through the steps of the application. In FIG. 14, a first step A 130a and second step B 130b are shown. In the example, an office furniture company receives an order for 100 chairs and 100 desks. The user then opens the “Sales Order” application, and places the order. This places 100 chairs and 100 desks in the “Open” stage of the application (Step A in FIG. 14). The next step is to Pick and Package the products. However, the update method (set by the consultant) that moves the 100 chairs and desks to “Picking and Packaging” determines that there are only currently 25 chairs and 50 desks in the warehouse. The update method can then put 25 chairs and 50 desks in the “Picking and Packaging” stage (Step B in FIG. 14). This update method will then automatically deduct that amount from the “Open Stage” as is described below in the update methods section.

FIG. 15A illustrates a transaction model 140 in accordance with the invention that includes at least an application 142 and a resource 144. The updates shown in FIG. 14 are local to the application and are separate from updates to resource tables. In particular, the applications and resources keep track of their own tables as shown in FIG. 15A wherein the application 142 may accept user and system input to an application transaction table 142a that will trigger a change to an application detail table 142b and the resource 144 may receive system input into a resource transaction table 144a that will trigger a change to a resource summary table 144b. The system recognizes that every update in the application 142 does not necessarily affect the resources 144. In the example above in FIG. 14, moving chairs and desks into the “Open” and “Picking and Packaging” stages might not update the quantities in the resource table, since the items are still on the company's premises. However, moving the items into the “Shipping” stage would update the resource tables subtracting 100 chairs and 100 desks as the items are now being shipped out of the company. Also note that the example in FIG. 14 is simplified. For example, quantities are usually added to and deducted from Resources with a specific Status (e.g. “Available Chairs”) rather than from the generic resource itself (“Chairs”) in this example which is dependent on the particular update method assigned by the consultant and the tables being updated by the update method.

As shown in FIG. 15A, the application 142, stored in an application table in a preferred embodiment, and the resource 144, stored in a resource table in a preferred embodiment, both use the transaction model 140. In accordance with the invention, the data tables 142b, 144b are never directly updated by user or system events. In particular, when a user uses an application in the system, or when the system's methods interact with an application, the actions are recorded in the application's transaction table 142a. In addition, this write (insert) into the transaction table fires a trigger which updates the data in the application detail table 142b based on a manually generated update method by the consultant. Similarly, the system's methods interact with resource data tables exclusively through a resource's transaction table 144a. When a consultant builds either an application or a resource with the business software application generation tools, he/she creates and declares both the data table and the transaction table to be used for that application or resource.

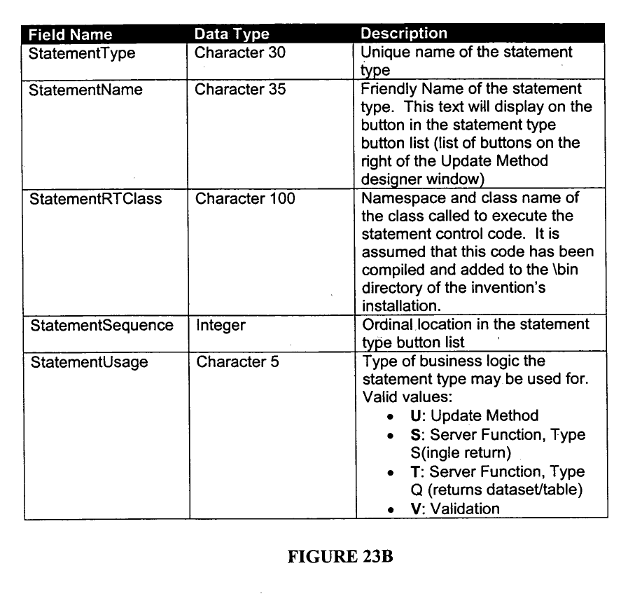

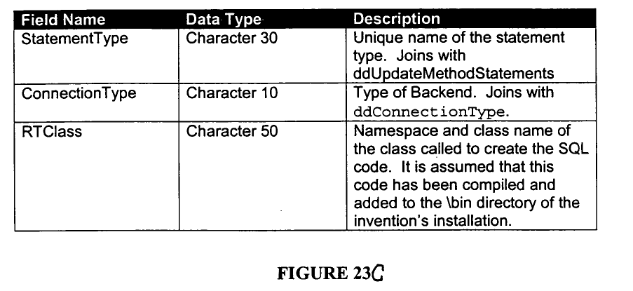

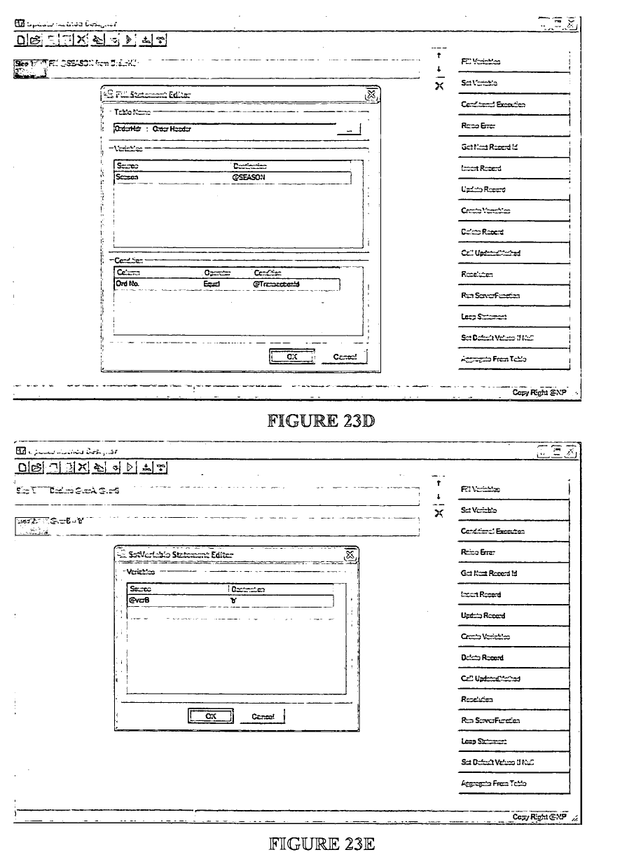

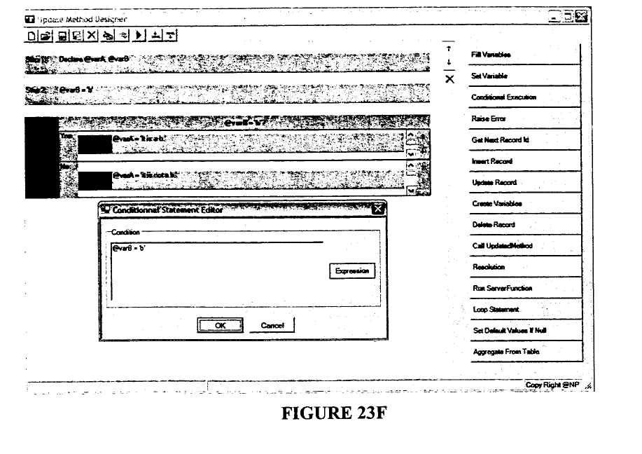

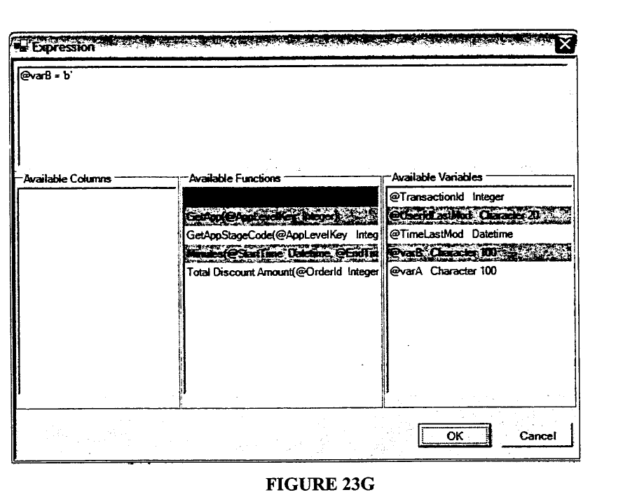

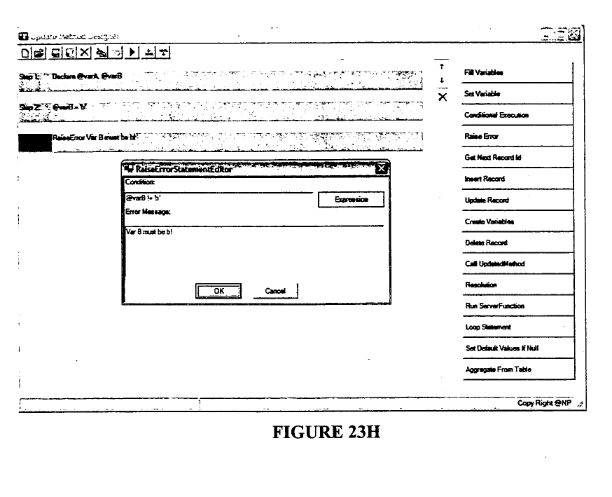

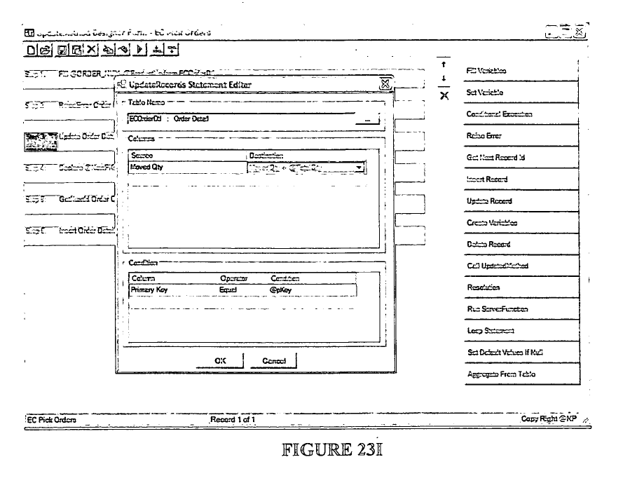

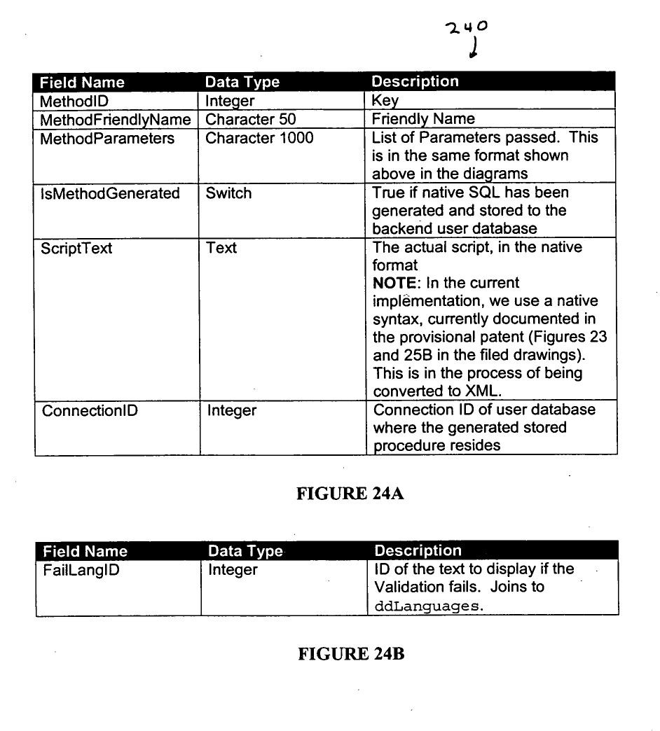

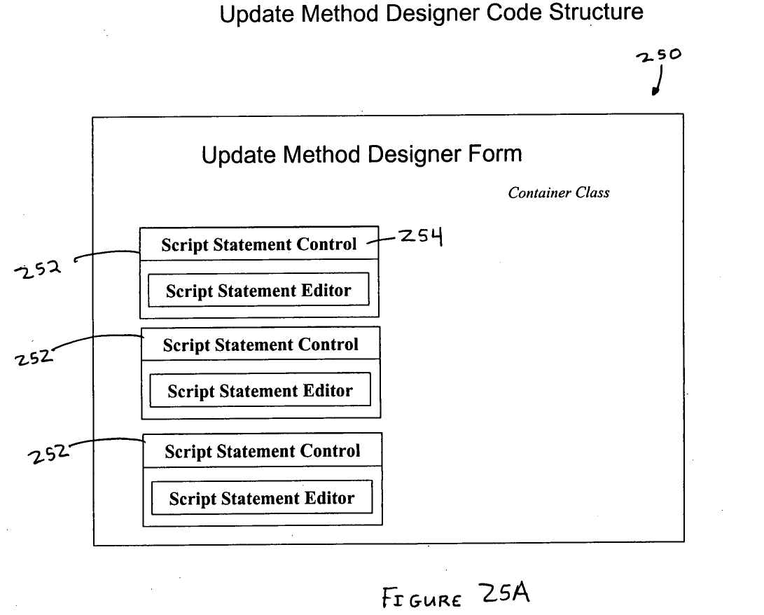

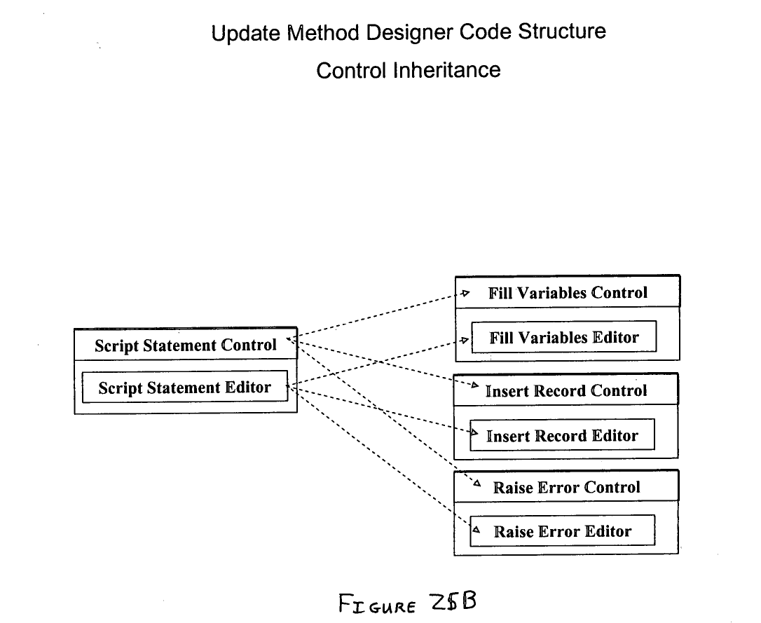

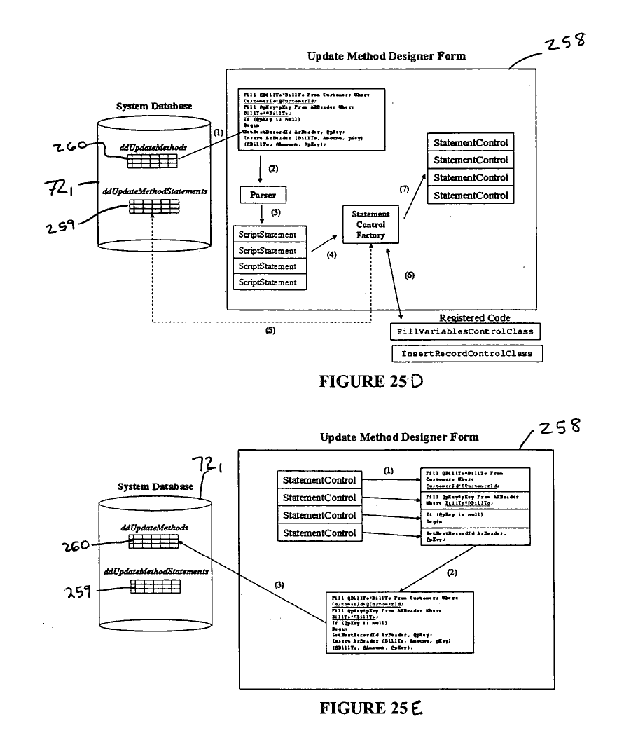

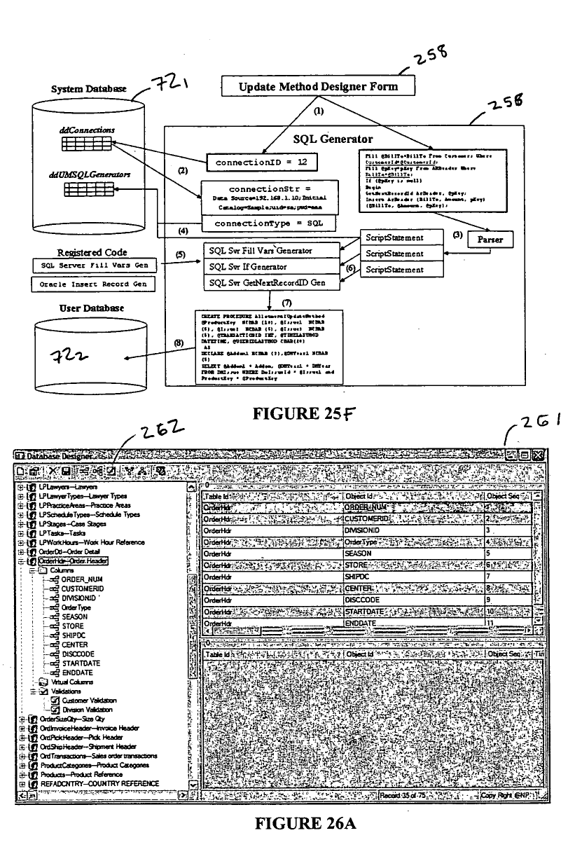

In accordance with the invention, resource triggers are generated automatically by the system after the consultant creates (or edits) the resource. The trigger is written as an SQL statement and is stored directly to the database as an update trigger on the resource transaction table. The consultant does not need to create or manage resource triggers. Application triggers, on the other hand, are explicitly configured by the consultant, within an update method. The update method is important for modeling business logic, and is described in more detail below with reference to FIGS. 21-25B. It is modeled graphically, using our tools (i.e. FIGS. 22, 25A). When saved, it is saved and stored in the system's native language (FIGS. 23, 25B). When an update method is actually assigned to a table or application it is translated by the engine to the user database's native scripting language, and saved to the user database as a stored procedure. A trigger is then set on the application's transaction table that calls the stored procedure.

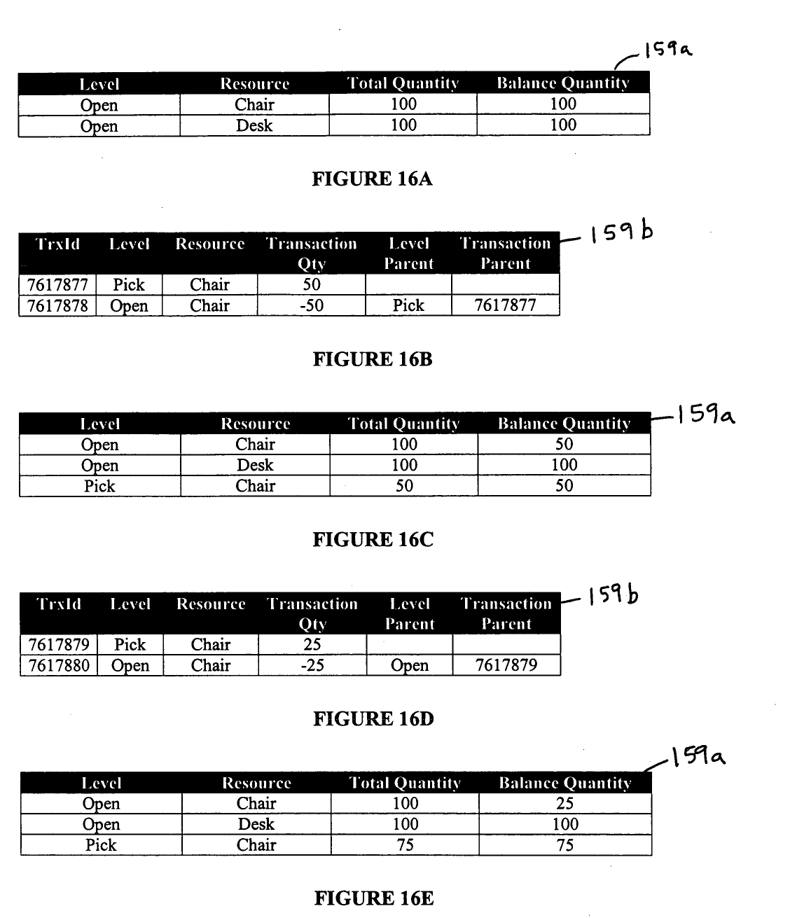

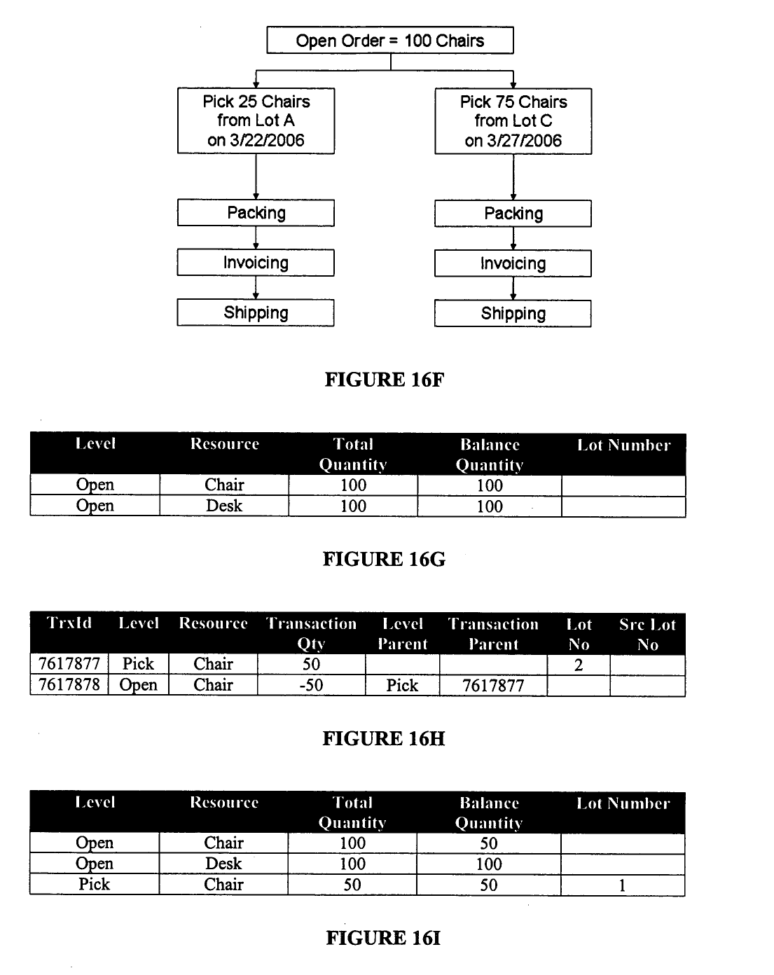

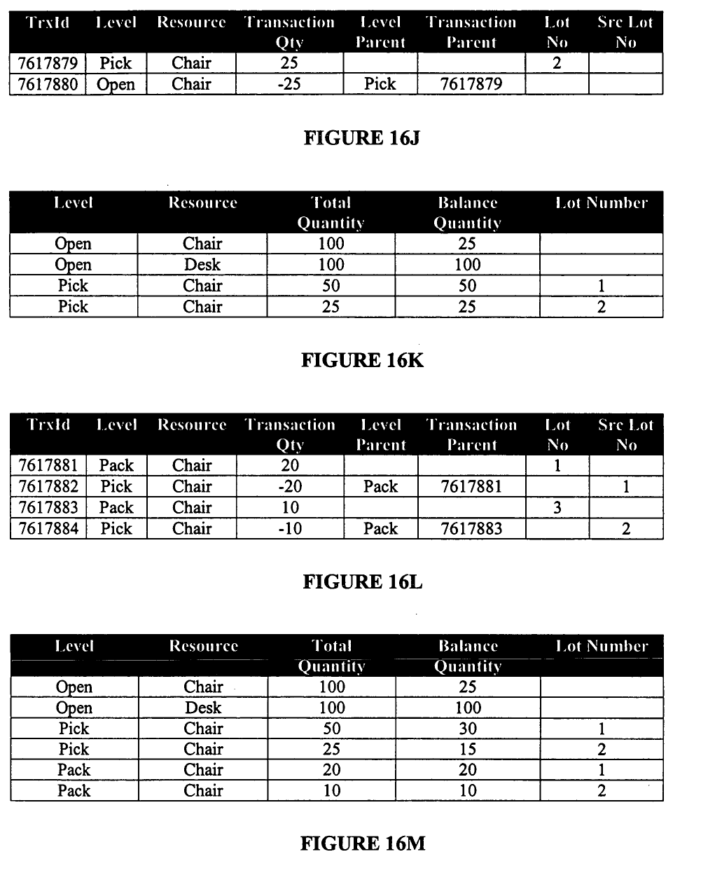

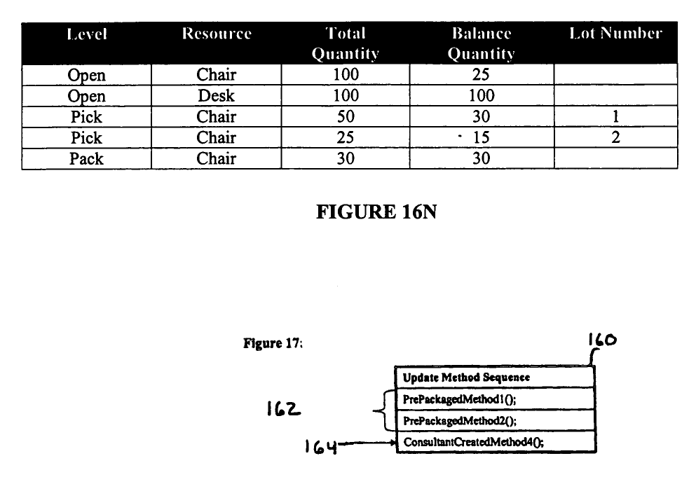

FIGS. 16A-M illustrate examples of application transaction tables in accordance with the invention that is based on the example shown in FIG. 14. This example illustrates what happens in an application detail table and an application transaction table when items are moved from level to level. For simplicity in the following Order Entry example, the Level is defined as a “Stage”. In this example, an order has been opened for 100 chairs and 100 desks and FIG. 16A illustrates an application level table 159a that shows that 100 chairs and 100 desks have been put into the order fulfillment queue. The total quantity represents the number of items that have been moved to the Open stage, and the balance quantity represents the number of items that need to be moved out of the Open stage into the next stage in the application. Later, 50 chairs are located in the warehouse and are moved to the pick stage as shown in FIG. 16B in a transaction table 159b. Note that the first transaction entry (transaction ID 7617877) is a result of the user manually moving 50 chairs from the Open stage to the Pick stage. This trigger's the Pick stage's update methods, which enter the second transaction (transaction ID 7617878). The second transaction notes the calling stage (Pick) and the transaction that caused it (7617877).

As a result of the transactions, the application level table 159a is changed as shown in FIG. 16C. Notice that Open Chair's has its Balance Quantity decremented by 50 as a result of transaction 7617878, and a Pick Chair record has been added to the table. Also note that the Total Quantity has not been adjusted, as it maintains a running total of Chairs that have been moved through the Open stage in this order. Now suppose that 25 more chairs have been located in the warehouse, and are moved from Open to Pick. When the user moves 25 more chairs from Open to Pick, the following 2 transactions are recorded as shown in FIG. 16D which results in the altered application table shown in FIG. 16E. Notice that Open Chair's Balance Quantity has been decreased again, with no adjustment to the Total Quantity. However, notice that both of Pick Chair's quantity fields have been incremented. This illustrates how Total Quantities can increase as items are passed through stages, even though they never decrease within an order (since they keep a tally of the total items that have passed through the stage for this order). If 25 chairs are subsequently moved from Pick Chair to another stage, its Total Quantity will remain 75, even as its Balance Quantity is reset to 50.

In the examples shown above, detail table items have one unique record for each resource-stage pair. However, sometimes business rules require each transaction to have its own unique record in the detail table. A real world example: Suppose there is an order for 100 chairs. Only 25 become available from one warehouse, but 30 are available from another warehouse. The system will need to track the Picks from warehouse A and warehouse B almost as separate orders. Another possibility is that the same warehouse has only 25 chairs in stock on June 1^{st}, and would like to ship out those chairs to the customer immediately. The balance is available on June 15^{th}, and those 75 are shipped out then. The business may require tracking of those two shipments separately, as early as the Pick stage, essentially branching out into two order paths as shown in FIG. 16F. This is known as “keeping the lot number”—remembering which lot the merchandise was chosen from. This business rule requires different behavior in the detail table.

Consider the previous example, but with the Pick stage now keeping its lot numbers. Assuming the same starting state when the order is opened is shown in FIG. 16G. Then 50 chairs are moved to the Pick stage (See FIG. 16H) which results in the following changes to the Detail table as shown in FIG. 16I. Notice that both the detail table and transaction table are tracking the lot number (assigned by the system). So if 25 more chairs are moved to the Pick stage (See FIG. 16J). This results in a completely new record being opened for the Pick stage as shown in FIG. 16K. All moves from Pick to subsequent stages now need to be tracked separately. So, assuming the Pack stage also keeps its lot number, if 20 chairs are moved from Pick Lot 1 to Packing, and 10 are moved from Pick Lot 2 to Packing, the transactions look like as shown in FIG. 16L resulting in a Detail Table that looks as shown in FIG. 16M. If the Pack stage does not keep its lot number, the items moved from both Pick lots are merged into the same Pack stage as shown in FIG. 16N.

FIG. 15B illustrates an example of a generic ERP system 150 in accordance with the invention that includes update methods. In particular, each stage 152a-e of the applications 154a, 154b has an update method 156a-e wherein each update method adjusts/changes/updates/modifies the various data tables/transaction tables 158 associated with the applications. In accordance with the invention, the update method can update any table so that an update method in accordance with the invention may be used for various portions of a business software application as shown in FIG. 15B. Now, the update method in accordance with the invention will be described in more detail.

The update method in accordance with the invention is an important part of the business software application generation system as it models the essential business logic of each application generated using the system. Update methods are also stored in our data dictionary, which allows them to be updated as rapidly and safely as all data constructs. When saved, the update method are converted to SQL triggers and stored directly to the database for maximum server-side performance, consistency, and concurrency control. An update methods are configured by the consultant using an Update Method Designer tool which is described below in more detail. Briefly, the tool allows the business logic of the update method to be modeled rapidly and without generating any new programming code. However, the tool does support a scripting language for advanced consultants who would prefer to fine tune their update methods in a more traditional manner.

Update methods are usually set per application, meaning that the same update method is triggered no matter what stage in the application is updated. However, the per application method can be overridden by per stage update methods, which only fire when a specific stage is updated. Thus, the system in accordance with the invention provides update methods at various granularity levels.

The update method itself can consist of multiple sub-processes, and can even call other update methods or server side functions as shown in FIG. 17. The business software application generation system in accordance with the invention may include the most powerful and common sub-processes that would be required by a consultant, but the consultant may also write his own sub-methods and server side functions using the Update Method Designer tool that is part of the business software application generation system. Thus, as shown in FIG. 17, an update method 160 may include one or more previously generated processes 162 and a customized process 164.

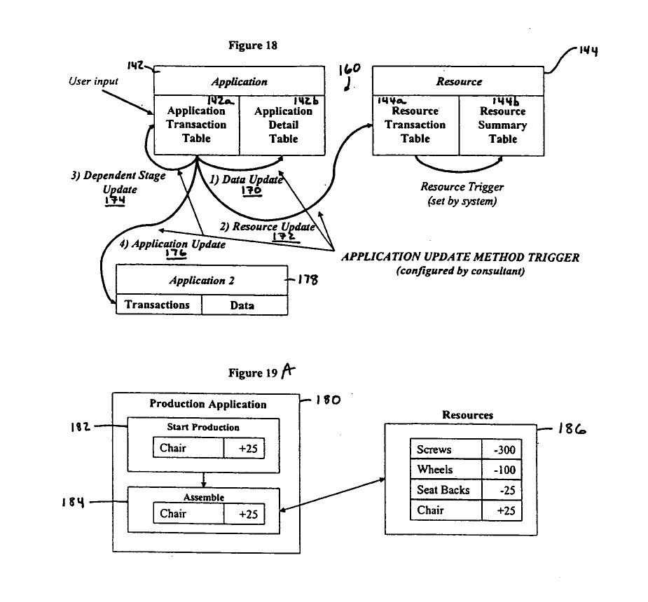

FIG. 18 illustrates an example of the update method 160 in accordance with the invention and the types of updates supported by this particular update method. In accordance with the invention, there may be a plurality of trigger types and the particular update method that is attached to a particular table is determined by the consultant that generates the business software application. The update method may include and support a data update process 170, a resource update process 172, a dependent stage update process 174 and an application update process 176. In the data update process, the data table 142b of the application 142 is updated to reflect the current state of the application following a transaction. The resource update process is a process in which the resource 144 is directly updated to reflect consumption or production of a resource by the application 142. The dependent stage update process updates any other dependent stages within the application, if any. The application update process updates any other dependent applications, such as application 2 178 in the example shown in FIG. 18, are updated. In accordance with the invention, each update method can have any one of these update types, a combination of types, or all of them. Now, more details of each different update method type in accordance with the invention will be described in more detail.

The data update process 170 shown in FIG. 18 maintains the transaction model described above. Unlike resources updates and triggers, applications require the user to configure the data update trigger here in the update method. This gives the consultant flexibility and control over the business rules within the trigger.

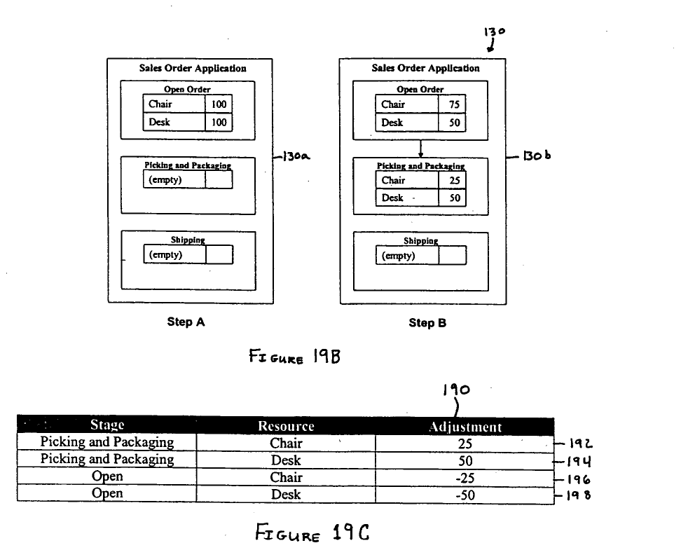

The resource update process 172 may update a resource based on the application. As described above, applications keep track of “resources” independently of the actual resource tables. However, depending on business rules, the quantities in the actual resource tables have to be updated to reflect consumption and production. A simplifier example of a resource update process is shown in FIG. 19A wherein a production application 180 (with a state production stage 182 and an assemble stage 184) affects a resource 186. In this example, chairs might be assembled from various parts (screws, backs, wheels, arms, seats, etc). In the “Start Production” phase 182, an order is put in to produce 25 chairs, but no resource tables are actually updated. When 25 chairs are in the “Assemble” stage 184, then the parts consumed (screws, wheels, seat backs) have their quantities reduced in the resource table 186, and the chairs produced have their quantities increased as shown. This example is simplified in that only the transaction tables are shown and not the data tables. The invention is capable of handling updates for more complex applications, but a simple application was described and shown here for illustration purposes.

The dependent stage update method will be further described with reference to FIG. 19B that illustrates the sale order application 130 at the first step 130a and the second step 130b as previously shown in FIG. 14. In Step B, adding 25 chairs and 50 desks to “Picking and Packaging” subtracts 25 chairs and 50 desks from “Open Order”. This means that the “Picking and Packaging” stage is dependent on “Open Order”. If a resource is added to the later stage, it must be subtracted from the earlier stage. This logic is defined by the consultant in the update method, which is saved as a trigger to the database. When the transaction table is updated, the trigger is fired, updating the transaction table again, with the dependent update. A transaction table 190 for this example is shown in FIG. 19C. The first 2 transactions 192, 194 are entered as a result of user input. Each entry causes an update method trigger to fire. The triggers then enter the next two transactions 196, 198.

Businesses processes are complex, and sometimes the processes in completely different applications are interdependent. The application update method handles this inter-dependency. FIG. 20 illustrates an example of an application update method in which a sale order application 200 (with an open order stage 202 and a picking and packaging state 204) interact with an production application 206. For example, suppose a furniture manufacturer's “Sales Order” application 200 needs to fill an order for 500 chairs. However, it finds that there are only 200 chairs in inventory. It would then have to open the “Production” application 206 and place an order to produce 300 more chairs in a start production stage 208 as shown. Thus, the sales order application 200 affects and alters an interdependent production application 206 and the application update method handles this interaction between different applications. Now, an example of an application update method designer tool in accordance with the invention will be described.

FIG. 21 illustrates an method 210 for automatically generating an update method in accordance with the invention. As described above, a business software application generated by the system may contain applications (modules) such as: Sales Order, Production Management, Accounts Receivable, etc as shown above. These applications are routinely modified with special cases to accommodate specific requirements for specific customers. However, when the core business software application system is modified, customer-specific modifications frequently break. As described above, each application may have multiple stages. The business software application generation system permits end-users or consultants to dynamically configure and run their business software applications and modify the stages in the application to fit their particular situation. For any application, every action in an application has a rule, normally called “business logic” in the domain of ERP applications. Each different customer may have different rules for even the same action in the same application. For example, a company may determine that it will ship an order only after it receives a 50% deposit. In this case, the system may need to generate a special invoice when the order is picked, instead of generating an invoice when an order is shipped. In accordance with the invention, the group of actions, including updating of remaining quantity and generating an invoice in the example above, is an “Update Method”. Generally, an Update Method is a series of update, insert or delete statements that can be translated into SQL statements that make up a database transaction.

In accordance with the invention, for efficiency of processing application transactions and performance of the system, application transactions are handled on the server, using table triggers, database stored procedures, or both. The business logic of the application transaction will also be encapsulated in these triggers and stored procedures. For a typical business software application, a majority of all transactions involve deducting the transaction quantity from the source stage and adding the transaction quantity to the destination stage for the ERP application example. In accordance with the invention, the business software application generation system may include one or more trigger templates (written in with the invention's Update Method designer) to handle these kind of transactions. However, the business software application generated by the system must still cover the remaining minority of the transactions that do not fall into the standard transaction type. An example of this special transaction will be to create an Accounts Receivable record when we move a Sales Order to Invoice stage. In order to solve this problem, the application update method permits a person, that is configuring the business software application to be generated by the system, to enter specific formatted input with the required parameters to generate a stored procedure on the server for the particular application. The purpose of the stored procedure will be to accept some parameters from some other application and create, update or delete records in the tables of that application. An application may contain one, many, or no stored procedures.

Returning to FIG. 21, the method begins when the update method designer tool, such as a well known software-based wizard, is started. In step 212, when the tool starts up, it will ask the consultant for the application code, for which he is going to create the stored procedure so that the procedure may be stored with the appropriate application. In step 214, the tool will ask the consultant for the parameters that are required to call the stored procedure to determine the data tables being accessed by the new procedure. In step 216, the consultant may define the new step in the new procedure. In more detail, the tool may display a user interface screen (such as that shown in FIG. 22 and described in more detail below) that allows consultant to define the steps of the stored procedures. Each of the step actually is a statement. In step 218, the consultant may select a pre-defined statements (included with the tool) that may be taken for each of the steps. These pre-defined statements may include, but are not limited to:
Fill Variable (from other table by certain criteria)
Create Variable (by a certain formula)
Conditional Execution (of a block of code)
Raise Error
Update Table (by a certain criteria)
Insert Record (into a table)
Delete Records (from a table)
Get Next Record Id (for a table)

Each of these example predefined statements is described in more detail below with reference to FIG. 23. Each of these pre-defined statements requires some parameters. For example, the Fill Variable action will require the name of the variable, the name of the table to get data from, the name of the field of the table to search data from and the criteria to search data from the table. Once the consultant selects a predefined statement or create one of his own using the user interface, in step 220, it is determined if the consultant has to define other procedure steps. If there are other procedure steps, the method loops back to step 218. If the steps for the current procedure are completed, then it is determined, in step 222, if the consultant is going to generate additional new procedures at this time and loops back to step 212 to generate a new procedure. After the consultant finishes his design and is ready to save the data, he goes to the final screen of the tool. In this screen, the consultant will have an option of whether to create the stored procedure after the system saved his data. If the option is checked, the system will generate a stored procedure based on the diagram designed in the previous step and save the data. Otherwise, the system will only save the data and the consultant needs to go back to this wizard again to create the final stored procedure.

FIGS. 22-25A are diagrams illustrating the method for generating a business logic and in particular an update method and an example of an update method in accordance with the invention. FIG. 22 illustrates an example of a user interface 230 to generate an update method in accordance with the invention. As shown, the user interface for the designer may include a button area 232 with one or more buttons that permit the user/consultant to control the generation of the update method. The user interface further comprises a working area/script window 234 that permits the consultant to generate the one or more statements that make up the update method. The working area may include a statement listing 236 which lists the basic predefined statements (shown in more detail in FIG. 23A) that are provided with the tool. In a preferred embodiment, these statements are coded into NET ddl files that are registered in the system tables so that new statements can be added seamlessly.

To add new logic, a consultant 1) clicks on a statement type (on the right of the screen); and 2) clicks in the script window on the left. A generic statement is then displayed graphically where clicked. Note that the user can click between existing statements to insert a statement into the middle of a script in progress. In a third step, the consultant double clicks on the new statement. A properties window (described in greater detail below), unique to the statement type will appear. The consultant may select any statements within the script by single clicking on it. The selection is indicated when the “Step n” box turns color (red, by default). The consultant may edit any existing statement within a script by double clicking on it. The consultant may delete any statement by selecting it and clicking a deletion button (shown as a stylized X on the user interface) in the upper right hand corner of the script window (note, this is NOT the same as the “X” in the toolbar, which deletes the entire update method from the database). Similarly, the up and down arrows above the deletion button moves the selected statement up and down within the script. Before an update method can be saved to the system database, its global information must be defined. This is done by clicking on the “options” button 233.

FIG. 22B is an example of the update method options user interface 237 which is presented to the user when the options button 233 is pressed by the user. This user interface permits the consultant to define the global parameters of the particular update method. In accordance with the invention, the parameters may include a method ID field 237a, a method name field 237b, an application code field 237c, a connection ID field 237d, a parameters field 237e and a description field 237f. In accordance with the invention, the mandatory fields may include the MethodID field, the Method name and Parameters fields. The MethodID field contains the primary key for the method, as stored in ddUpdateMethods, ddValidations, or ddServerFunctions. The Method Name contains friendly name for the update method.

The Parameters field contains the parameters to be passed to the Update Method when called. Note that the user does not need to know the proper syntax for Parameter declaration, or even the data types available. In particular by clicking of a parameter detail button 237g, a parameters editor user interface 238 (shown in FIG. 22C) is displayed to the consultant. The parameters editor permits the consultant to fill in the parameters for the update method. Furthermore, clicking on an arrow button 238a (shown in FIG. 22C) brings up a more detailed parameter editor 239 (shown in FIG. 22D) that displays all of the columns in the ddColumns table so that the consultant can see the columns and choose the appropriate columns.

FIG. 22E is an example of a server function options user interface 241 in accordance with the invention. As described above, server functions differ from update methods in that they support return values which must be specified in the server function option dialog shown in FIG. 22E. The dialog 241 may include a function ID field 241a, function type field 241b, a function name field 241c, a return data type field 241d, a parameters field 241e and a return values field 241f. The function type may by Q(uery) in which a dataset is returned or S(ingle) in which a value is returned. The return data type is only required if function type is S. All data types supported by the invention (and listed in ddDataTypes) are valid. If the function type is Q, the list of columns to be returned and if the function type is S, a system variable called @ReturnValue is made available to the consultant in the script window to set.

FIG. 23A is a table illustrating an example of the basic statements of an update method. As shown in FIG. 23A, each basic statement has a name and properties associated with the basic statement. Furthermore, each basic statement performs a particular desirable operation common to a business software application, such as an ERP application. In accordance with the invention, more basic statements may be added into the system according to the following requirements for creating a Basic Statement. Each of the basic Statements is a user control inherited from bsScriptStatementControl, which we will create before we start this project. bsScriptStatementControl needs a method context, typically the variables (created by preceding Statements) that are available for this action to instantiate itself. Also, some of the Statements may modify the context by creating new variables, which will be available for subsequent Statements. bsScriptStatementControl has a protected variable, _PropertyScreen, that links it to a form that must be inherited from bsScriptStatementEditor (which we will create before we start this project). All the child classes of bsScriptStatementControl must set the variable to its corresponding screen so that when the consultant double-clicks a Basic Statement in the working area, the corresponding property form will pop-up. In short, each of the Basic Statements consists of two classes: one class inherited from bsScriptStatementControl and the other class inherited from bsScriptStatementEditor. After a new Basic Statement is created, it needs to be registered into the system before it can be used. The register screen is just a simple reference screen created using the business software application generation system.

In more detail, a statement is a step within a script. For example, “Fill Variable @myvar=5”. “Loop from 1-5 and Read Next” “Insert Record Into table Customers” are examples of a statement. A statement type represents one atomic unit of syntax (e.g., “Fill Variables” and “Insert Record”) within a script. Further examples are shown in FIG. 23A. To allow maximum flexibility, each statement type, when developed, handles its own code, both for its behavior within the Update Method Designer, and the subsequent generation of actual logic. This allows maximum atomicity and flexibility, and makes it easier to add future statement types in the future, if there are any we haven't thought of.

When implemented, each statement type consists of the following objects, each written in NET: a statement control class, a statement editor class and an SQL generator class. The statement control class may: 1) handle the behavior of the control in the update method designer's script window; 2) must inherit from the invention's ScriptStatementControl class. This parent class handles generic processing of all mouse click events, selection, and display; and 3) contains an instance of a statement editor class (next). The statement editor class may: 1) handle the behavior of the statement's property pages (which pop up when the consultant clicks on the statement in the script window); 2) handle the conversion of the statement and it's properties to the invention's native syntax; and 3) must inherit from the invention's bsScriptStatementEditor class (currently a placeholder class). The SQL generator class may: 1) handle the conversion of the statement to actual SQL that will be saved in the user database as a stored procedure (or trigger or server function). Note that a different SQL Generator Class must be written for each database type. That is, a statement needs a different SQL generator class written for Oracle (PL/SQL), SQL Server (T-SQL), and DB2; and 2) must inherit from the invention's npUMStatementSQL class.

Also note that while there are similar behaviors an functionalities shared between logic types (Update Methods/Validations/Server Functions) each type usually maintains its own set of statement types. So “Fill Variable” usually isn't written and registered for all 3 logic types; it must be written for each logic type. This allows the Validation Designer to optimize for trigger creation, Update Method Designer to optimize for stored Procedure creation, etc. In practice, Validation statements are written uniquely, but Update Methods and Server Functions can often share statements.

For a compiled Statement to be used in the invention, the Statement Control Class must be registered in ddUpdateMethodStatements. The SQL Generator Class must be registered in ddUMSqlGenerators. Note that these tables are used to register statements for Update Methods, Server Functions, and Validations. FIG. 23B illustrates the ddUpdateMethodStatements table and FIG. 23C illustrates the ddUMSqlGenerators table.

Returning to the update method, when an update method, validation or server function is saved, it is converted to the invention's native syntax and saved to ddUpdateMethods, ddValidations, or ddServerFunctions tables in the system database, respectively. Note that this does not actually convert and save the update method into working logic in the user database. The conversion of the update method into working logic when the consultant clicks on a “generate” button 235 shown in FIG. 22A. This allows the consultant to save uncompleted work without worrying about syntax errors from the user database upon save. Another valuable benefit is that conversion from one backend database to another is instantaneous. If an update method has been used with a SQL Server backend, but the system is migrated to Oracle, all the consultant has to do is change the ConnectionID and click “Generate”.

FIGS. 23D-I illustrates some screen shots with example of implemented control statements. They are accompanied by brief descriptions of the each statement's editor page (which pops up when the statement is clicked on) and control display (how the statement looks in the editor). FIG. 23D illustrates an editor page for the fill variable statement wherein the table name field contains the table to query to fill the variable from. This is a zoom which lists all user tables available to the consultant (resolves to “FROM” clause in SQL statement). The variables field contains a list of the variables (one shown here) to fill with the values from the record fields wherein the “source” is the table column which contains the value to be returned to the variable (resolves to “SELECT” clause in a SQL statement) and the “destination” is the local variable(s) in the script to fill. Both these items are drop down lists which list valid values. The conditions field contains the search criteria for the record (resolves to “WHERE” clause in SQL statement) wherein the “column” is the table column to search on, the “operator” is a full list of Boolean operators and the “condition” is the value to compare. This is a combo box with a dropdown with all variables in the scope of this step of the script (including all global variables, system variables, and variables declared in previous steps within this update method). However, the consultant may also type a literal or expression into the combo box.

FIG. 23E is an example of the editor for the set variable statement wherein a source field contains a variable to set with a combo box that lists all variables available to this statement and the destination field contains a value. FIGS. 23F and G illustrate an example of a conditional execution statement that shows both the statement control and the statement editor. The consultant may type a Boolean expression directly into the conditional statement editor. However, clicking on “expression” brings up an expression builder that enforces proper syntax: When the consultant is finished setting the condition, he then inserts statement controls into the “yes” and “no” sections the same way they are inserted on the main form (shown in the first diagram for the “conditional statement” control).

FIG. 23H illustrates an editor for a raise error statement and the statement editor. The condition filed contains a condition required to raise the error. (Note that “Expression” raises the expression builder) and an error message field contains the text of the error string to be returned. FIG. 23I illustrates an editor for an update records statement wherein a table name field contains a zoom of all available user tables in the system and a column field contains a list of columns in the table to update (only one shown here). This resolves to the “SET” clause in a SQL statement: The source field contains the field in the table to update and the destination field contains a value to insert which is a combo box that lists all available variables (local, parameters, global, etc), but allows literals and expressions to be typed in (as in this example). The condition field contains a list of search conditions to locate records to update. This resolves to the “WHERE” clause in a SQL statement. The column field contains a list of the column to search on, the operator field contains the Boolean operator for comparison and the condition field contains a combo box with list of variables in scope (local, global, parameters). Consultant can type in condition or literal as well.

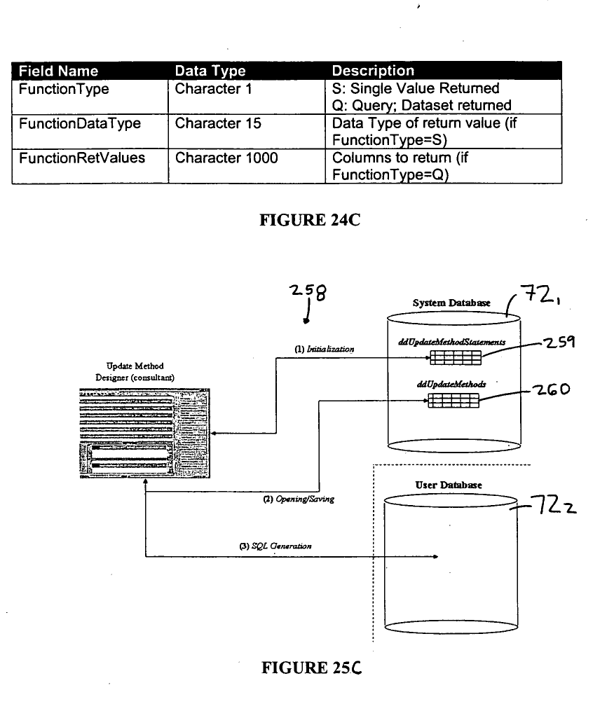

FIGS. 24A-C are diagrams illustrating the data tables 240 in accordance with the invention used to store an update method in accordance with the invention. In particular, the update methods are saved to ddUpdateMethods table (shown in FIG. 24A) in the System Database. The ddValidations table is functionally equivalent (with slightly different field names). One crucial additional field is for the validations table is shown in FIG. 24B. All labels and text displayed anywhere in the UI is placed in ddLanguages. Each statement is retrieved based on the LanguageID and the current language of the user's UI settings. This allows data-driven UI labeling, and instant real-time language conversion (provided that ddLanguages is fully populated). The ddServerFunction table is also functionality equivalent to ddUpdateMethods (with slightly different field names). The additional fields for the server function are shown in FIG. 24C.

FIGS. 25A-F illustrate more details of the update method designer 258 in accordance with the invention. As shown in FIG. 25A, the update method designer form 250 is a container for one or more update method statements 252. As shown in FIG. 25B, since each statement (such as the Fill Variables, Insert Record and Raise Error statements shown in FIG. 25B) inherits from a parent ScriptStatementControl class 254, it can expect a uniform interface from each statement. FIG. 25C illustrates the update method designer 258 and its connection to the system database 72₁ and user database 72₂. In particular, when the update method designer form is initialized in step (1), it queries the ddUpdateMethodStatements table 259 for a list of statement types. As a result, it knows which statement type buttons to list on the right of the form. Also, the registered classes are loaded into memory, so the form knows which statement control class to instantiate when a consultant inserts a statement into the form. If the consultant opens a saved update method (by clicking “Open” in step (2)), the script's record is located in a ddUpdateMethods table 260. The form has its own utility to parse the script's code into a tree node structure. In a future implementation, the code's current syntax will be replaced with XML, so that parsing can be decentralized: all the form will have to do is query ddUpdateMethodStatement based on the node name. There will be no need for a central repository of grammar. Then the nodes are traversed to create the list of controls (with their properties) that need to be instantiated in the work area of the Update Method Designer form (more below). When saving an update method, the form loops through the statement control list, and each control returns the native code snippet that makes up its statement in the complete script. Similarly, when the consultant decides to “generate” SQL in step (3), the form can call the code listed in ddUMSQLGenerator to specifically generate SQL from the statement. The form then creates (or alters) the stored procedure to the user database.

FIG. 25D illustrates a method for opening an update method in accordance with the invention. When an update method is opened, it is read from ddUpdateMethods table 260 in step (1). The script is then sent to the designer's parser in step (2), which parses the script into an Arraylist of ScriptStatement structures in step (3). Each statement can then be sent to the Statement Control Factory in step (4) to be converted to Form controls. The Statement Control Factory looks up the proper object to instantiate in ddUpdateMethodStatements table 259 in step (5), so that it can find the NET code to call in step (6) and use to instantiate each control on the form in step (7). The form now contains an array of Statement Controls, as described above.

FIG. 25E illustrates a method for saving an update method in accordance with the invention. When saving, the form gets the text of each statement in native script syntax from each statement control in step (1). The statements are concatenated as a whole script in step (2) and saved back to ddUpdateMethods table 260 in step (3).

FIG. 25F illustrates a method for generating an SQL message in accordance with the invention. When the consultant clicks the “Generate” button, the entire script in native language is sent to the SQL Generator utility 256, along with the connectionID in step (1). Based on the connection ID, the connection string (which includes the connection type) is retrieved from ddConnections in the system database 72₁ in step (2). Meanwhile, the script is parsed into an arraylist of Script Statement structures in step (3). The proper SQL generator code is retrieved for each statement by querying ddUMSqlGenerators by statement type (“Fill Variables”, “Insert Record”, etc.) and connection type (SQL, Oracle, DB2, etc.) in step (4). This allows the proper SQL generator object to be called for each statement in step (5), which each statement is subsequently passed to in step (6). The results are concatenated into a CREATE or ALTER statement, and sent to the user database 72₂ in step (8). If the generation is successful, the Update Method Designer sets the “Generated” field for the Update Method to TRUE in ddUpdateMethods (not shown). Now, a validation designer in accordance with the invention will be described in more detail.

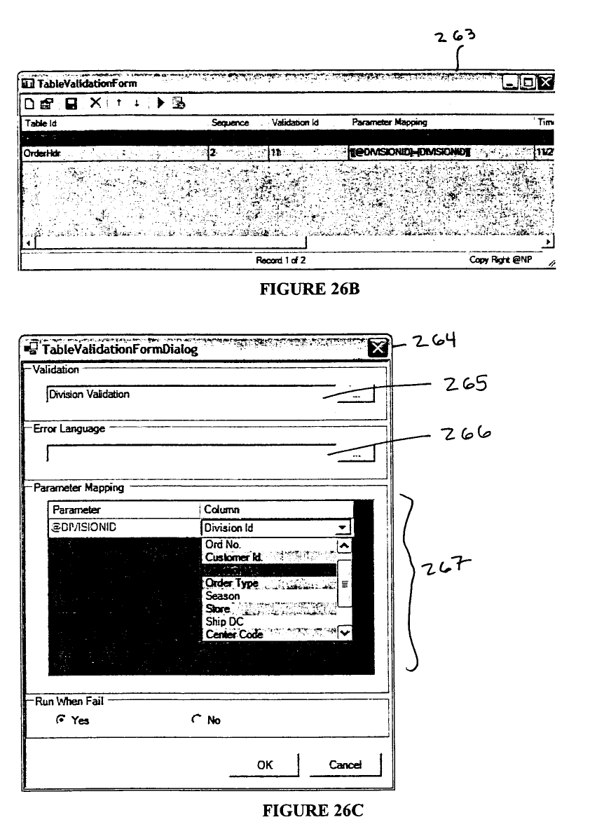

FIGS. 26A-C illustrates a validation designer in accordance with the invention. Validations are event based, and are converted to triggers on specific tables. As a result, they must be assigned to a specific table before they are effective (note that a defined validation can be assigned to multiple tables). The consultant must use a database designer 261 to assign a validation to a table. The assignment is listed in ddTableValidations table stored in the system database. Also note that the validation designer does not have a “Generate” button as SQL is only generated when the validation is assigned to a table. The UI for adding a validation to a table is similar adding columns to a table as shown in FIG. 26A.

To add a predefined validation, the consultant selects the desired table (in this case, OrderHdr), and clicks a “Validations” button 262. This brings up the list of validations (if any) listed in ddTableValidations for the user table (OrderHdr) 263 as shown in FIG. 26B. Note that if no validations have been assigned, this list is blank. Clicking on either “new” or “edit” brings up a form 264 as shown in FIG. 26C. A “Validation” field 265 specifies the Validation process to assign to this table. The zoom lists all Validations defined in the system and stored in ddValidations. An “Error Language” field 266 is the error to display to the user if the Validation fails. The zoom lists all entries in ddLanguages (note that the id of the text is stored in the ddTableValidations entry, not actual language.) A “Parameter Mapping” 267 lists the input field(s) for the validation. A column of the current table must be selected and assigned to each Parameter listed here. When the user clicks OK, the new validation item is added to the Table Validation Form list (see above), and are available for review. When the user clicks “Save”, the Validation record is saved to ddTableValidations. When the user clicks “Generate”, actual SQL is generated and saved to the database as a trigger on the user table, in an almost identical manner as described above for Update Methods.

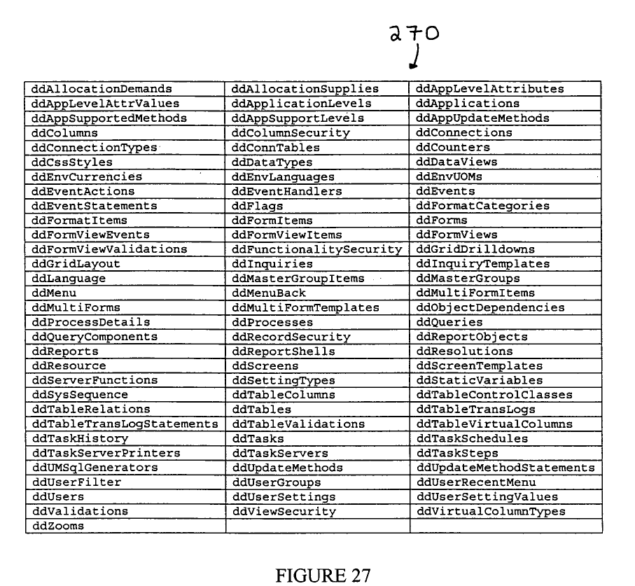

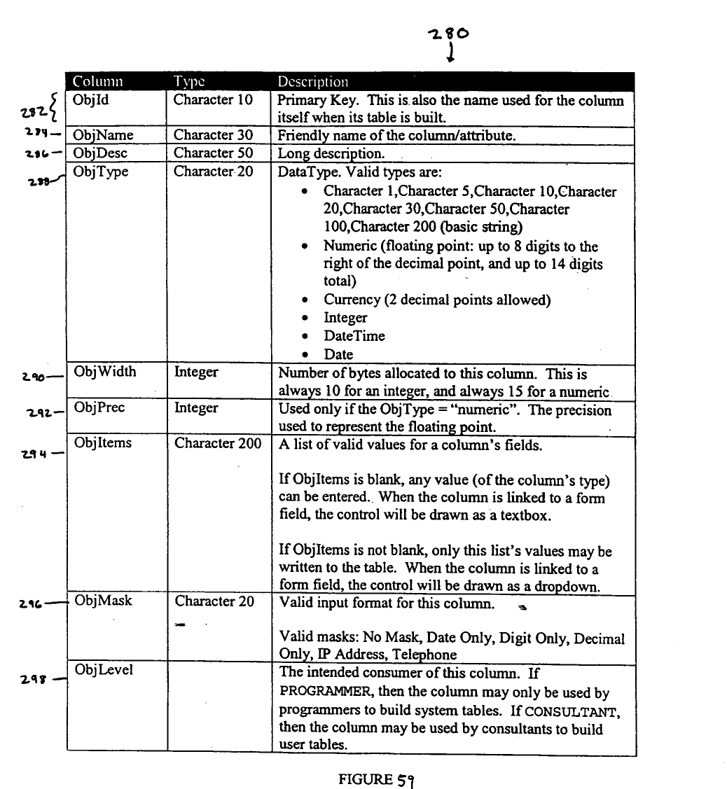

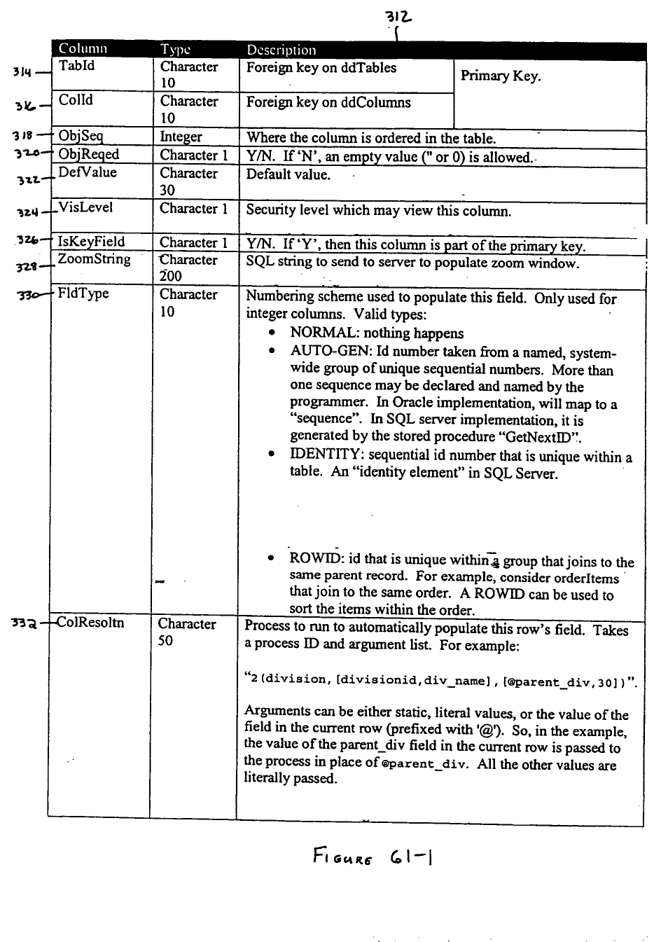

FIG. 27 is a listing 270 of the tables of the system database for an example of the business software application generation system in accordance with the invention. In a preferred embodiment, the database may include various categories of data tables and various individual data tables that are briefly described here. Some examples of the data tables described here are then described in more detail below with reference to FIGS. 59-68. The data tables may include database structure dictionaries, user interface tables, user setting data dictionaries, client-side process dictionaries, application dictionaries, resource dictionaries, user data grouping dictionaries, output dictionaries, data warehouse dictionaries, EDI dictionaries, business messages and subscriber dictionaries, interface mapping dictionaries, security and licensing dictionaries and task scheduler dictionaries. The database structure dictionaries may include a ddColumns dictionary (implemented as a database table in a preferred embodiment), a ddTables dictionary, a ddTableColumns dictionary, and a ddTableRelationships dictionary. The ddColumns dictionary defines the columns of the database tables (in the preferred embodiment in which database tables are being utilized) in the entire system including data and program columns. This dictionary contains base primitive characteristics attributes of the columns such as data type, length, decimals, etc. The ddTables dictionary stores data, such as the name of each table and whether the table is a system table or a user table, about all of the tables in the system including program and data. The ddTableColumns dictionary stores data about the columns in each respective table. For example, the specific primary keys, default values for the columns, the process to resolve the value of the columns, and the process used in zoom of this column may be defined. The ddTableRelationships dictionary defines the relationships among tables, and relationship attributes such as foreign key. This table is used also in query designer since it defines both joins and constraints.

The user interface dictionaries may include a ddForms dictionary, a ddFormItems dictionary, a ddMultiForms dictionary, a ddMultiFormItems dictionary, a ddMenus dictionary and a ddLanguage dictionary. The ddForms dictionary defines the input forms in the system. For example, the dictionary may include data about the forms, its ID, and the zero or more tables connected to this form. The dictionary may also define the security level of the form and other characteristics of the form such as the screen area. The ddFormItems dictionary defines the input fields of a form, including all labels (captions of input fields), text and combo boxes. Furthermore, each input field is directly linked and directed into a specific column in its application table. The ddMultiForms dictionary is a form container used to accommodate multi-level input such as header/detail, or header/detail/sub-detail etc. For example, this dictionary may be used for hierarchical input and can pick multi sub-forms from the next dictionary. The ddMultiFormItems dictionary may list the sub-forms within a multiform and the sub-forms is declared in ddForms described above. The ddMenues dictionary may define the menu system including the menu tree. The dictionary provides instruction that is executed when a menu item is selected. A menu may be pointed to a form, an object, or any DLL or program that is developed through .Net. The ddLanguage dictionary may define all text displayed by the system in every natural language supported by the system.

The user setting data dictionaries may include a ddUserSettings dictionary, a ddUserSettingsValue dictionary, a ddUserRecentMenu dictionary, a ddUserFilters dictionary, and a ddGridLayout dictionary. The ddUserSettings dictionary defines user preferences settings such as colors for text boxes, fonts, language, etc. The ddUserSettingsValue dictionary stores the individual settings for each user of the system. The ddUserRecentMenu dictionary stores the most recently used menu item/s for each user. The ddUserFilters dictionary stores the last filter used by each user for each form and the ddGridLayout dictionary stores the layout information for each of the grids set by each user for every form. The client-side process dictionaries may include a ddProcess dictionary and a ddProcessDetails dictionary. The ddProcess dictionary defines client-end processes such as zoom window format, validations, input field resolution, etc. The ddProcessDetails dictionary defines, when a process defined in the previous dictionary has sub-processes, these sub-process and listed in their execution sequence.

The application dictionaries may include a ddApplications dictionary, a ddAppSupportLevels dictionary, a ddApplicationLevels dictionary, a ddAppLevelAttributes dictionary, a ddAppLevelAttributesValues dictionary, a ddAppSupportedMethods dictionary, a ddAppUpdateMethods dictionary, and a ddUpdateMethods dictionary. The ddApplications dictionary defines/stores the applications (modules) that are supported for a particular instantiation of a business software application. The data in this dictionary may include the application nomenclature and its sequence in the supply/demand information chain. The dictionary may link the zero or more tables used in the application—primarily the Application Transaction Table and the Application Detail Table. The ddAppSupportLevels dictionary may store user defined application levels since it declares the name of the level and its parent. For example, in the Sales Order, we may define two levels—a Sales Order Type and a Sales Order Stage. In other words here we say that the first level is an order type and the second is a stage. The next dictionary will actually define them. The ddApplicationLevels dictionary is a BPM (Business Process Model) that defines the application. For example—in sales order we may have sales order type, followed by order stage, followed perhaps by picking stage or invoicing stage. The ddAppLevelAttributes dictionary defines and stores data associated with the attributes required or supported for each of the application levels. The ddAppLevelAttributesValues dictionary defines the actual values of each of the levels of the prior dictionary and stores data associated therewith. The ddAppSupportedMethods dictionary defines the update methods types while the ddAppUpdateMethods dictionary links the actual update method for each of the applications or application level or application stage. The actual definition of each update method is stored in the ddUpdateMethods dictionary. Thus, the ddUpdateMethods dictionary is a system-wide repository of all Update Methods defined by consulting and includes the name and actual script of the update methods. Some of the update methods stored in this dictionary may be generated using the update method tool described above.

The resource dictionaries may include a ddResource dictionary and a ddResourceStage dictionary. The ddResource dictionary defines the resources that the user wants the system to manage, such as cash, materials, production capacity, human resources, space, etc and stores data about those resources. The ddResourceStage dictionary controls resources status, such as demand, reserved, and consumed and stores data about the statuses. The user data grouping dictionaries a ddMasterGroups dictionary and a ddMasterGroupItems dictionary. The ddMasterGroups dictionary stores the data that permits a link to be established between individual reference tables. An example is style/color/inseam/dim/size. The dictionary declares the group names and authorizes it while the ddMasterGroupItems dictionary groups them together. Thus, the ddMasterGroupItems dictionary combines the simple masters into the specifically declared groups in ddMasterGroups.

The output dictionaries may include a ddQueries dictionary, a ddInquiries dictionary, a ddReports dictionary and a ddDDO dictionary. The ddQueries dictionary stores data for consultant defined queries to get the result set while the ddInquiries dictionary defines the inquiry screens. The ddReports dictionary stores data that defines the report forms.

As shown in FIG. 27, the tables of the system database are a key component of the business software application generation system. Therefore, a model for accessing these tables will now be described in more detail. The table accessing model is important for various reasons. First, every single object and type created by the system and used in the system (whether coded or created by the consultant codelessly) is represented in the system tables. Second, for most features (especially higher level features) creating a business object or business logic is a matter of creating, editing, or deleting a row or a field in a system table. Finally, the system database does not only model the objects in the user database; it also models objects in the system database. As a result, the table access model is used by the completed customer application for user data access. The table access model allows the simplicity and flexibility of the invention itself, since it is also used to access system tables so that all that the consultant is doing is accessing his own set of tables and columns in order to generate or change a business software application. This table access model allows “universal database connectivity” as described in more detail below. The model itself keeps table consumption segregated from the backend database, so that the client does not need to be aware of what type of database backend is being used, where it is located, or even if it has recently changed.

As described above, the system uses a system database and user database wherein the user database is the actual database of the end user's data and includes table built for the user by the consultant, such as “Customer” or “Order” etc. These can be different from customer to customer and industry to industry. The system database functions as a data dictionary and models all system types, objects (including both the system and user databases), and all data created by the consultant that results in a final constructed system. All system tables are prefixed with “dd” (as shown in FIG. 27) to prevent confusion. As shown in FIG. 27, the system tables cover a wide breadth of objects from constructs as basic as “data type” (ddDataTypes) to complex objects such as applications, levels, stages, update methods, and allocations. In accordance with the invention, building just about any feature merely requires populating these tables. The two important exceptions are the objects that need to be created and to be saved in the user database. These include columns, tables, update methods (stored procedures), validations (triggers), and server side functions. Although their system tables are also edited when they are built or modified, physical changes need to happen to the user database as well.

FIG. 28 illustrates more details of the universal database connectivity 280 that is provided by the system in accordance with the invention. As described above, the structure of the invention's data access model allows “universal database connectivity”. That is, database objects are accessed similarly, almost through a “virtual database”, as defined in the system database. This is true of all database objects, whether they reside in the native user database, external user databases (regardless of database manufacturer), or even the system database itself.

As shown in FIG. 28, a user application 282 accesses a “virtual database” 284 which in turn is generated by a system database 72₁. The system database is in turn connected to one or more legacy databases (286₂ and 286₃ in the example in FIG. 28) as well as it own database 286, and the system database (due to the table access method) is able to access data from any of the databases. In accordance with the invention, the actual database structures and contents are shielded from the user as the user is interacting with the virtual database 284 so that all of the data in all of the databases appears uniform to the user even when the data is being pulled from different databases. Similarly, a consultant tool 288 (used to generate a new business software application or modify an existing business software application) connects to the virtual database 284 which is in turn generated by the system database 72₁. The system database acts as its own data dictionary and is connected to a user database 72₂ into which the data for the business software application being created by the consultant is being written. Now, some examples of various system tables as well as the table access method in accordance with the invention will be described.

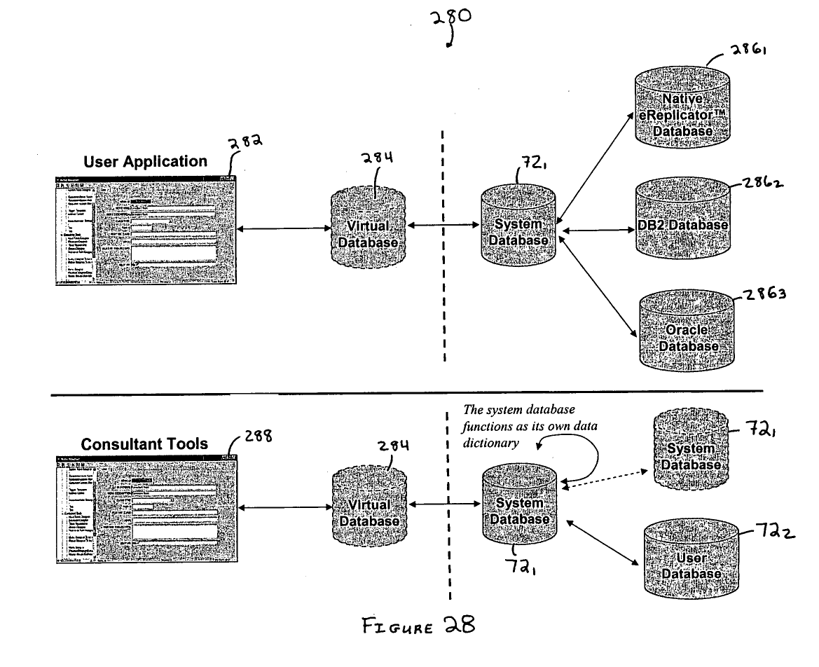

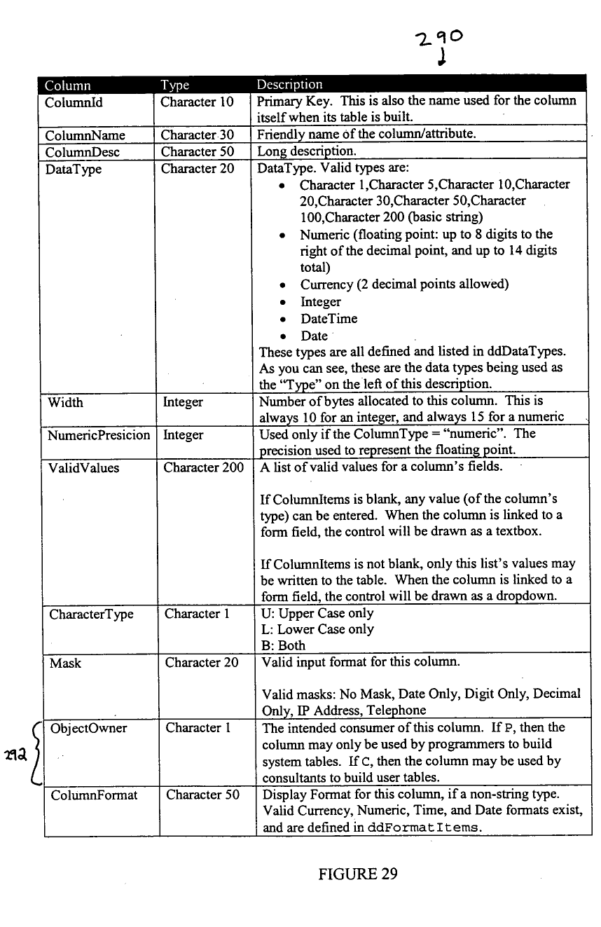

FIG. 29 is a diagram illustrating an example of a definition of a column table 290 for system tables of the system in accordance with the invention. In accordance with the invention, each table of the system includes a TimeCreated, TimeLastMod, and UserIdLastMod columns that are not shown in FIGS. 29-33 and any other examples of the tables of the system. These columns assists in the proper auditing of additions and modification of every record in the system and is set automatically by the system. The column table 290 (shown as ddColumns in FIG. 27) lists all of the columns in all of the databases that the system can use. Any user column defined here can be used in any user table in any user database. Columns for system tables are reserved for system tables, but may be used in any system table. FIG. 29 lists each column of the column table, the type of data in each column and a description of the data that each column contains in accordance with the invention. As shown, the table 290 includes an ObjectOwner column 292 that contains an indication of the intended consumer of the particular column where “P” designates that the particular column may be used by programmers to build system tables and “C” designates that the particular column may be used by consultants to build user tables.

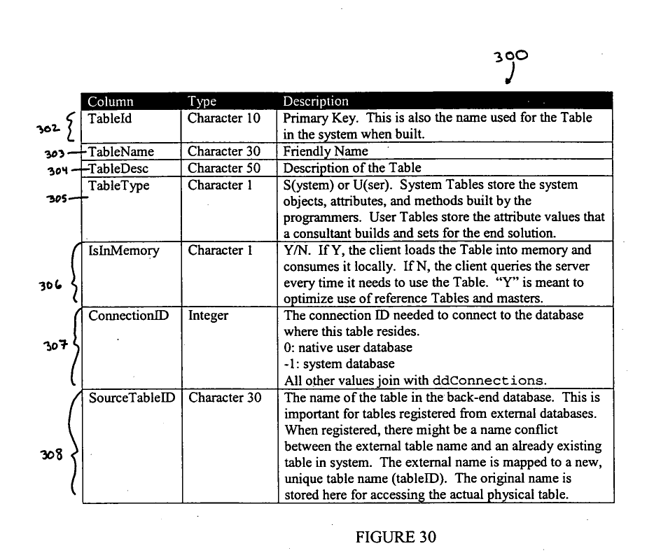

FIG. 30 is a diagram illustrating an example of a definition of a table 300 containing information about the tables for system tables of the system in accordance with the invention. The tables defined by this table include system tables, native user tables, and external user tables. In accordance with the invention, ddTables (the name of this table in the preferred embodiment of the system) has a many-to-many relationship with the ddColumns table, through the ddTabCols table. Thus, there may be many different tables that have the same or different column definitions contained in the ddColumns table. This table may include a TableID column 302, a TableName column 303, a TableDesc column 304, a TableType column 305, an IsInMemory column 306, a ConnectionID column 307 and a SourceTableID column 308. The ConnectionID column contains information about the location in which the database (and the associated table) is located wherein a “0” indicates the native user database and “−1” indicates a system database. The SourceTableID column 308 contains the name of the table in the back-end database which is important for tables registered from external databases.

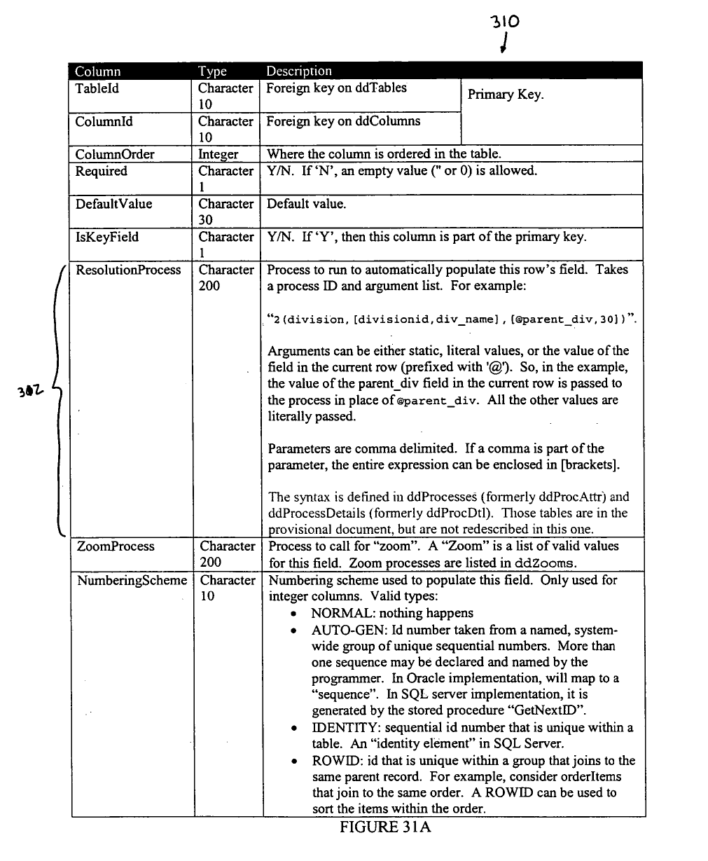

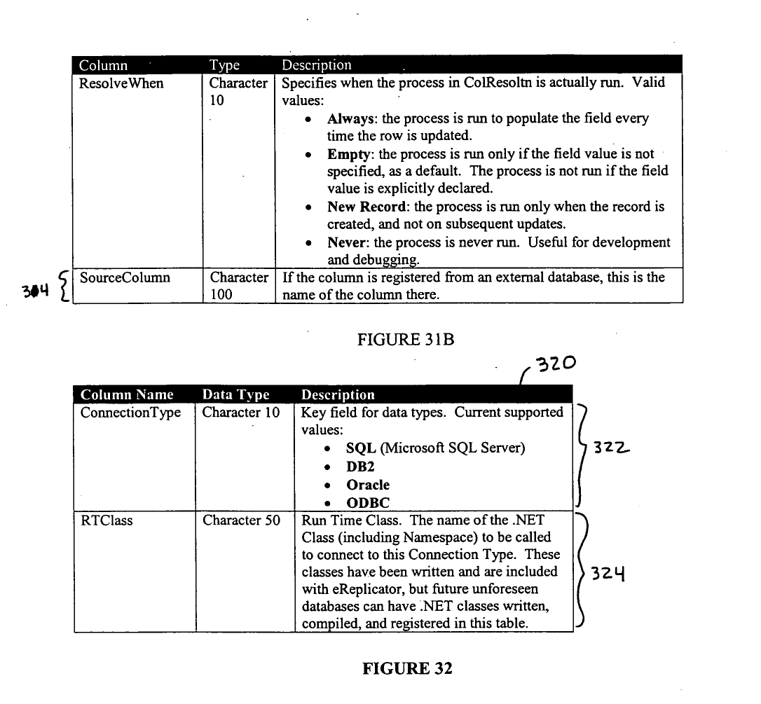

FIGS. 31A and 31B illustrating an example of a definition of a table columns table 310 containing information about the columns of the tables for system tables of the system in accordance with the invention. In the preferred embodiment of the invention, this table is known as the ddTableColumns table and joins ddTables to ddColumns in a many-to-many relationship. However, the ddTableColumns table also contains data that describes how a column behaves within a specific table so that is the table for table-specific column data. For example, this table may contain information about whether a particular column is required of whether a particular column is a primary key for the particular business software application. This table 310 includes the various columns shown in FIGS. 31A and 31B. To highlight a few specific columns, the table 310 includes a ResolutionProcess column 312 and a SourceColumn column 314. The ResolutionProcess column 312 that contains information about a process to be run in order to automatically populate the row's field. An example of the process definition is shown in FIG. 31A and the syntax for the process is defined in a ddProcesses table. The SourceColumn column 314 contains the name of the external database in which the column may be found if the column is stored in an external database. This column permits universal external database connectivity of the system as described above.

FIG. 32 illustrating an example of a definition of a connection type table 320 containing information about the type of non-native database connected to the system in accordance with the invention. This table may be known as the ddConnectionType table is a preferred embodiment and lists the code to call based on the type of the destination database. This allows the engine 74 (See FIG. 2) to connect to multiple database back-ends seamlessly. These are usually registered by the programmer. The table 320 includes a ConnectionType column 322 and a RTCLass column 324. The ConnectionType column contains data about the particular external database that is being accessed and the RTClass column contains a run time class (the name of the NET class) to be called to connect to the external database defined for the connection type in the ConnectionType column.

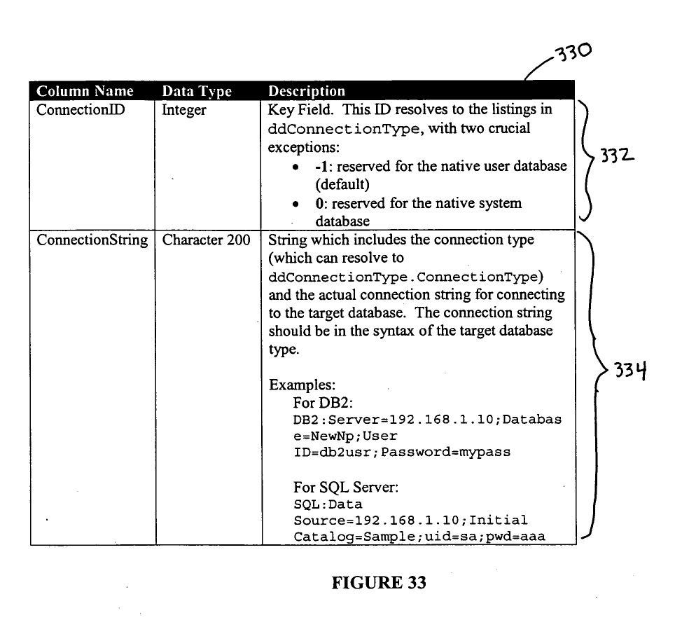

FIG. 33 illustrating an example of a definition of a connection table 330 containing information about the external database connections of the system in accordance with the invention. In a preferred embodiment, the table has the name ddConnections and lists the destination location and type of databases to which the system can connect. Typically, the external databases are registered by the consultant. The table 330 contains a ConnectionID column 332 and a ConnectionString column 334.

FIG. 34 illustrates a method 340 for representation a table in accordance with the invention. In particular, when the system initializes, an instance of every table in ddTable table in the system database 72₁ is loaded into memory as an npDDTable object pool 342 containing one or more npDDTable object(s) 344 for each table. In accordance with the invention, each instance of the npDDTable object contains a schema 344a for the table (columns, properties, etc), an connection ID 344b of the source database, the table name 344c in the destination back end database and an array 344d of columns and their properties, including the column names in the back end database. Since these npDDTable objects are stored in memory, the engine 74 does not need to return to the system database 72₁ every time it needs to access a table or its information. The only times the system database needs to be queried directly are when the npDDTable pool is initialized or when the schema of any table or column is actually changed since the pool 342 of objects must be re-generated when the schema of the database changes. In accordance with the invention, storage of these objects in memory greatly speeds up the system.

FIG. 35 illustrates an example of a method 350 for opening a table in accordance with the invention. In particular, all tables in all databases are accessed by the engine 74 through instances of an npTable object 352 regardless of the location or type of database. This class is the main workhorse of the engine used by the consultant tools, the web client, and the windows client. In the example shown in FIG. 35, access to a user database table is described although the method is also used to open a system database table. In a first step (step (1) as shown in FIG. 35), a Windows application 354a (or web application 354b) requests the opening of a table for use by instantiating an npTable 352 and calls an OpenTable( ) method in step (2). The OpenTable( ) method then looks for the requested table's instance of npDDTable 344 in the npDDTable memory pool 342 (described above in FIG. 34), and retrieves the table's schema, connection ID, and destination table and columns names (if any) from the npDDTable 344 associated with the particular table in step (3).

Based on the retrieved schema in step (4), a local dataset 356 is created in the npTable object 352 with the corresponding schema. Once the dataset has been created, it needs to be populated. To populate the dataset, npTable 352 sends the connectionID and schema to a global DBConn(ection) object 358 in step (5). Based on these pieces of data (as described below with reference to FIG. 36 in greater detail) the DBConn object 358 creates an correct SQL query in step (6) and sends it to the correct database in step (7) based on the connectionID data. The data for the table is then retrieved from the database, such as the user database 72₂ shown in the example in FIG. 35, and the data is returned by DBConn 358 to npTable in step (8). At this point, the application can consume the table at will via npTable's access methods (9), which consume its local dataset.

Note that after OpenTable( ) is finished, npTable 352 does not retain the schema and connection ID from npDDTable. npTable 352 must check its corresponding npDDTable instance for the correct schema and connection before every database connection which ensures that npTable 352 is blind to the schema and location of the destination database, even if they change in the background.

FIG. 36 is a diagram illustrating more details of the DBConn object 358 shown in FIG. 35 and a database connection method 360. The DBConn object includes essential database interactivity methods, which are generic enough to be called by npTable (or any other data access object). These methods include (but are not limited to):
GetConnection( ); Connect( );
OpenDataTable( ); SaveDataTable( ); CloseDataTable( );
ExecuteSql( ); ExecuteStoredProcedure( );
BeginTransaction( ); RollbackTransaction( ); CommitTransaction( ).

When DBConn's connection methods are called (usually by npTable), parameters are passed in step (1) which include the connection ID, the name of the table in the destination database (in this example, a user SQL server database) and the name of the columns to be returned in the destination database. Based on the connection ID, the connection is found in the ddConnections table stored in the system database 72₁. As shown in the ddConnections table description above (See FIG. 33), this returns the connection type and connection string. Based on the connection type returned (SQL, Oracle, etc.), DBConn queries ddConnectionTypes table stored in the system database 72₁ in step (3), to find the namespace and name of the connection object class to instantiate for database connection in step (4). Note that there is one connection object (npDBConnSQL, npDBConnOracle and npDBConnDB2 in this example) for each database type supported. Also note that two connection IDs are hard-coded: 0 for the native user database (npUserDb, in SQL Server), and −1 for the native system database (npSysDb, also in SQL Server). In these instances, there is no need for a lookup in ddConnect ions.

In step (6), the DBConn 358 then generates it's appropriate ANSI SQL and passes it, along with the proper connection string, to the database-dedicated connection object (npDBConnSQL in this example.) The dedicated connection object connects to the database and passes it the SQL to execute. Not shown: any data returned from the database is sent back along the path through npConn<connectionType> back to DBConn, back to the calling object (e.g. npTable).

FIG. 37 illustrates a method 370 for saving table data/modifying table data in accordance with the invention. In accordance with the invention, when the consultant or user is ready to save the data, the application calls npTable.SaveTable( ). As shown, all initial reads and writes to the data occur to npTable's local dataset 356 in memory in step (1). When a consultant or user clicks “Save” in the UI, npTable. SaveTable( ) method in the npTable object 352 is called. The object queries its corresponding npDDTable instance 344 for the table's schema, connectionID, and destination table and column names in steps (3) and (4). If there is a discrepancy between the npDDTable schema and the npTable schema in step (4), an error message is generated (not shown). This optimistic scheme allows table schema to be modified on live systems, without causing data discrepancies on changing tables.

If there is no error, a SaveDataTable( ) method of the DBConn object 358 is called, along with the connection ID, a parameterized version of the changes to the local dataset, and the destination data object names in step (5). There, DBConn 358 creates the appropriate SQL and connects to the appropriate database in step (6) as described above in greater detail. The SQL writes to the actual user database 72₂ in step (7), and any return values are passed back along the path (not shown).

FIG. 38 illustrates a method 380 for modifying table schema data in accordance with the invention. Recall that in the invention's model, modifying the end-user system is merely a matter of modifying the contents of system tables. In the invention's model this is in effect using the system database as a “user” database for the consultant. However, as previously stated, additional actions are required to maintain database objects. Business logic object modifications (update methods, server functions, validations) are described in the biz-logic.doc document. Data object modification (i.e. table schema modification) will now be described. For simplicity, this example assumes that a column's attributes (data type, length, validation) are being modified (in ddColumns). However, this model applies even if a table is added/modified/deleted (ddTables) or if columns are added to/deleted from a table (ddTableColumns).

Any modifications to a column's attributes are performed by the consultant through a Column Designer tool 382. For example, let's say that the LastName column is expanded from a Width of 20 to 100 characters. This means that the record in ddColumns with columnID=LastName is modified: the Width field is changed from 20 to 100. To do this, the column designer opens an instance of the npTable 352 with a local dataset 356 copy of ddColumns, and makes all changes through the object in step (1). Then, as with any table, SaveTable( ) is called in step (2). The table's connectionID and schema are retrieved from the ddColumns instance of npDDTable 344 in steps (3) and (4), and passed to DBConn. SaveDataTable( ) in step (5), where SQL is created (6) and passed to the system database 72₁, where the record is modified in ddTables in step (7). To this point, there is no real difference from user database access and modification.

At this point, the Column Designer must take responsibility for modifying the physical data structures and their representations to the system. So in our example, the Column Designer reinitializes the pool 342 in step (8). Then the column designer compares the npDDTable instances that contain the “LastName” column (for example, “Customer”) with their representations in the user database 72₂ in step (9). Any user tables with schema that don't match their npDDTable instances are identified, and their schema are updated in step (10). Any time ddColumns, ddTables, or ddTableColumns are modified, the npDDTable pool 342 in memory must be reinitialized. As shown above, the Column Designer handles this explicitly. Not shown, the Database Designer also handles these updates in the same manner.

Any table in any database can easily be accessed through a large set of forms, many with a rich user interface (UI). The exact nature of the forms and their configuration are not in the scope of this document. What is important is that the simple reference form, which directly corresponds to a table's fields, can be used both for data entry by the end-user, and for data-entry by the consultant (for building an end-user system). Richer forms and consultant tools often use these forms as sub-components. An example of the forms and reference forms in accordance with the invention will now be described.

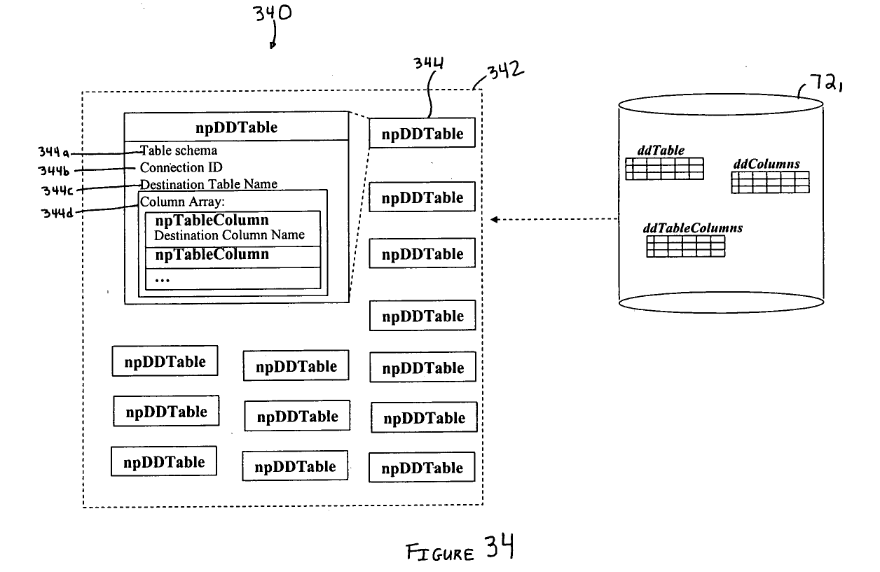

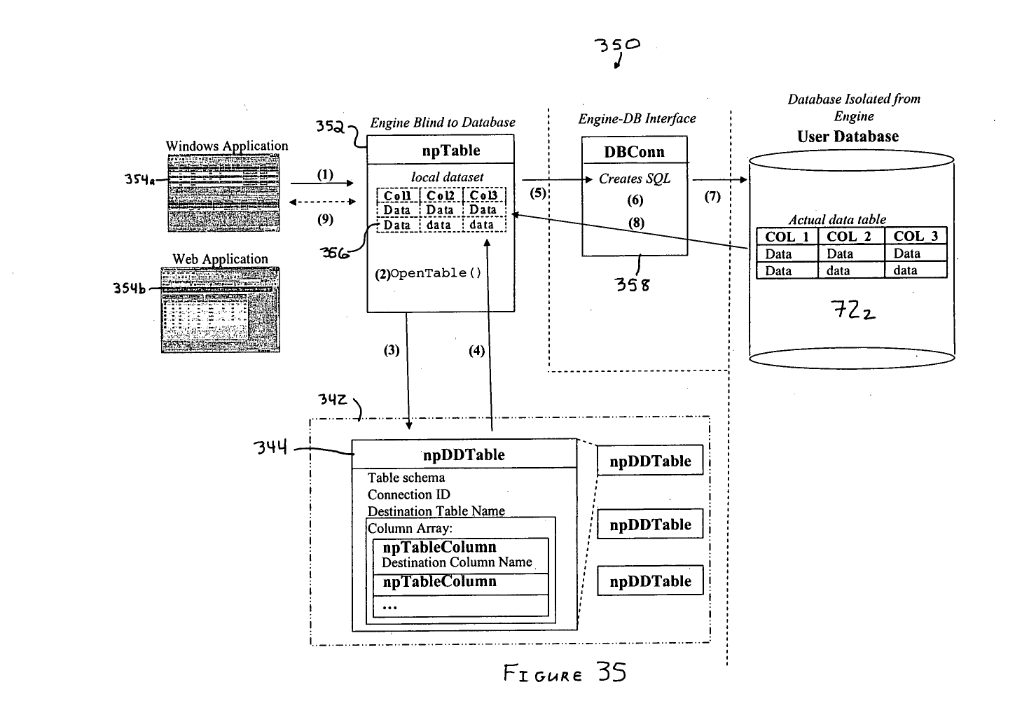

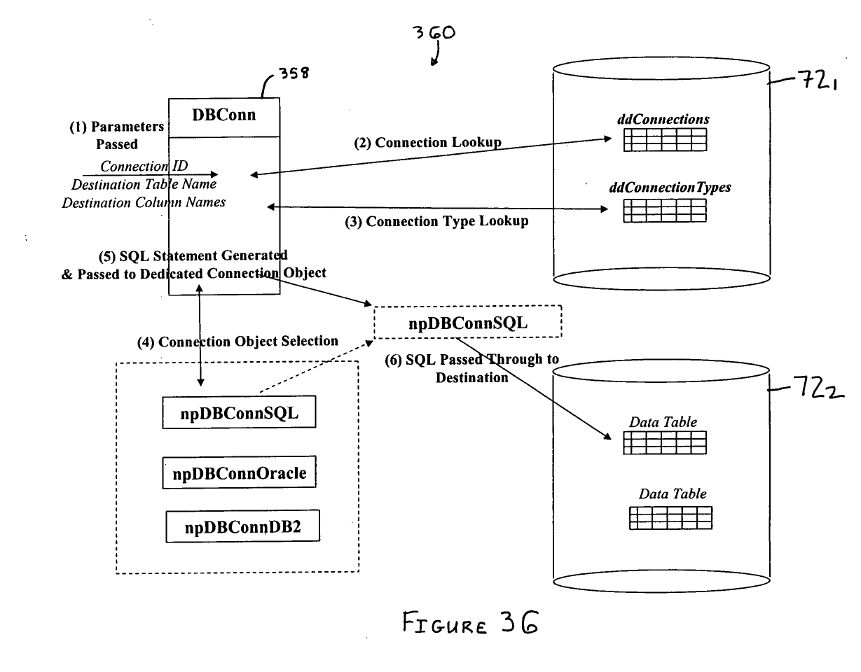

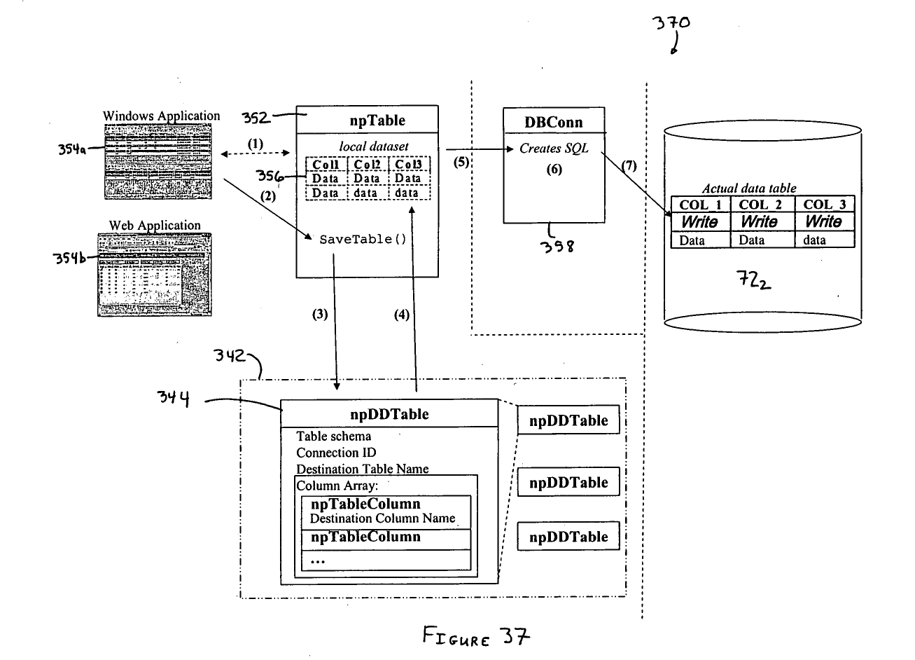

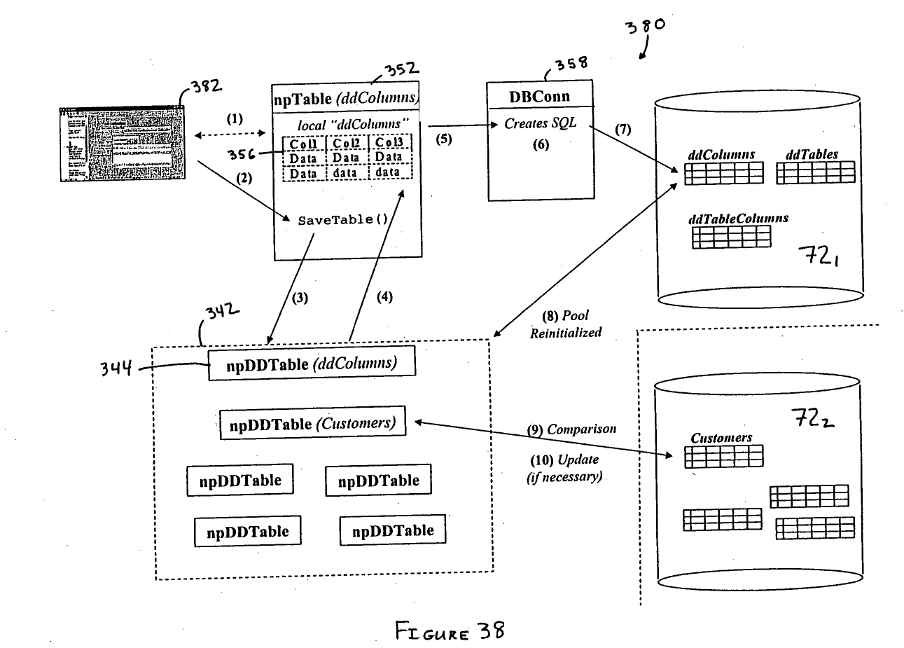

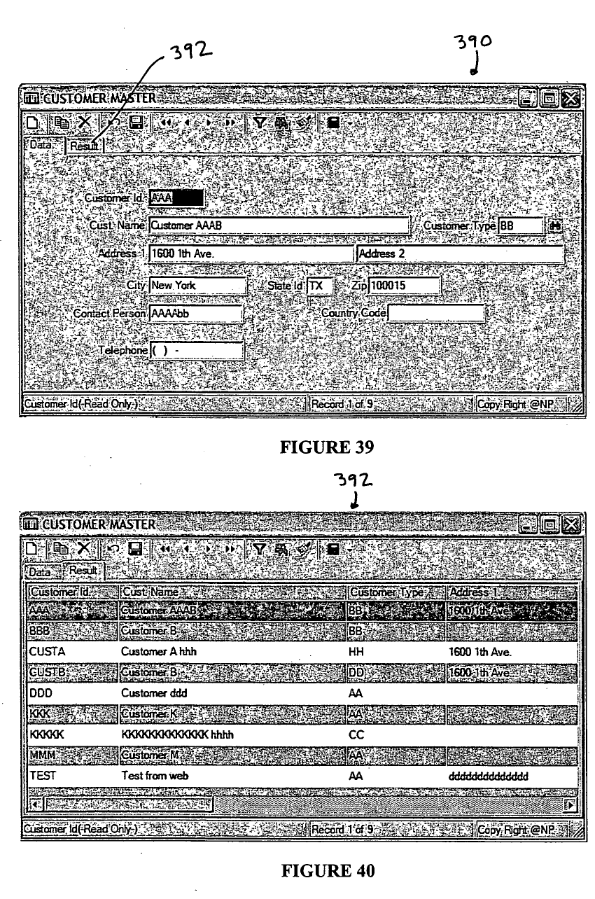

FIG. 39 illustrates an example of a user reference form 390 in accordance with the invention and FIG. 40 illustrates an example of a user reference form results tab 392 in accordance with the invention. As shown, the form permits the user to enter information into the system (in this example customer information into a customer master UI). The form 390 has a results tab 392 which is shown in more detail in FIG. 40. The results tab permits searches that returns records shown in FIG. 40. In accordance with the invention, the form consumes user tables through npTable, as described above, and saves by calling npTable. SaveTable( ), as described above.

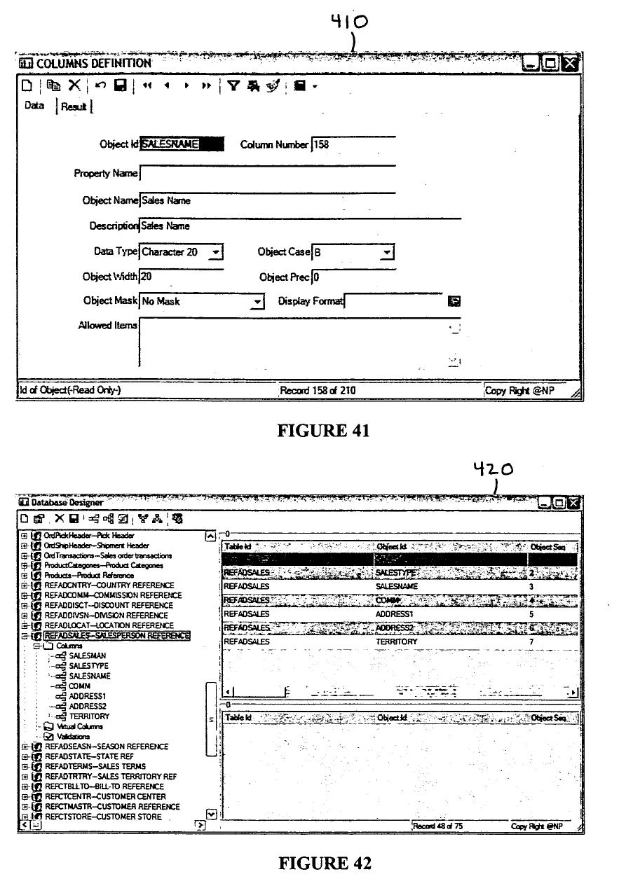

FIG. 41 illustrates an example of a column designer user interface 410 in accordance with the invention. The consultant tools utilize much of the same functionality. For example, the column designer 410 looks identical, except that it interfaces to the ddColumns table and thus has different data entry fields as shown. As above, clicking “Save” modifies the record in ddColumns. However, as described above, saving the record also initiates a refresh of the npDDTable pool, and a change to the physical table(s) in the user database.

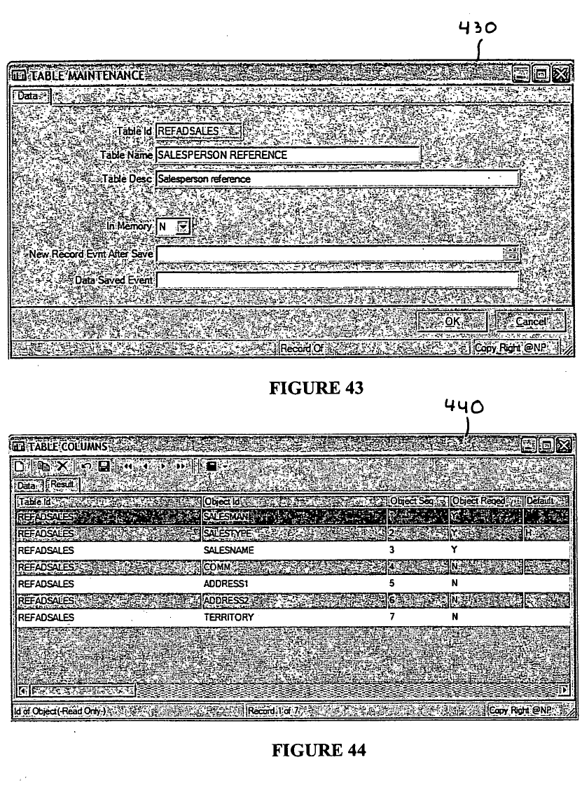

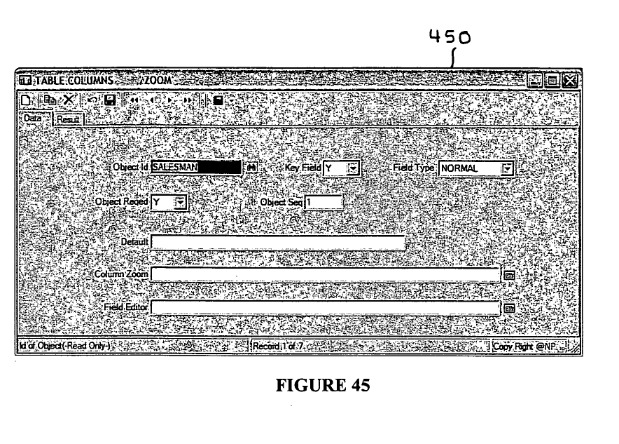

FIG. 42 illustrates an example of a database designer user interface 420 in accordance with the invention, FIG. 43 illustrates an example of a table designer user interface 430 in accordance with the invention, FIG. 44 illustrates an example of a table column designer user interface 440 in accordance with the invention and FIG. 45 illustrates an example of a table column designer zoom user interface 450 in accordance with the invention. The database designer 420 has a slightly more complex user interface. However, when a new table is added, or a table's specific properties are edited, a reference form corresponding to ddTables appears as shown in FIG. 43. Similarly, when columns are added to or removed from a table, a reference form shown in FIGS. 44 and 45 are made available that corresponds to ddTableColumns. Also note that the changes to the npDDTable pool and the backend database structures are handled automatically by the tools. The consultant does need to know or worry about them.

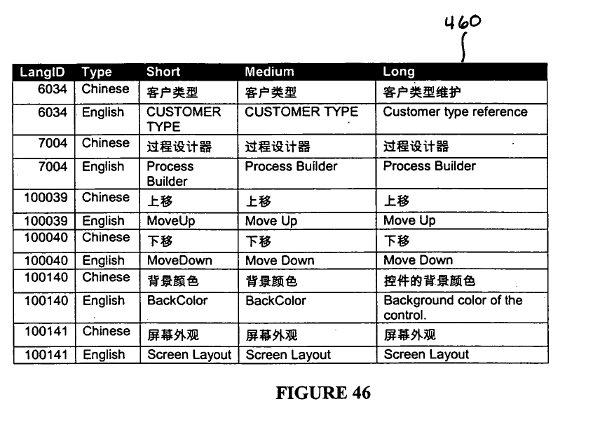

FIG. 46 illustrates an example of the ddLanguage table 460 in accordance with the invention that provides the system with a language independence feature. An example of this feature is shown above with reference to FIG. 26A-C (showing the generation and use of a validation.) In accordance with the invention, all text in the invention uses Unicode, for maximum international capability. All labels and texts string displayed in the invention are stored in the ddLanguage system table so that none of the labels and text strings are hard-coded. Each text or label has a unique languageID shown in FIG. 46, referring to the string. However, there may be multiple listings for that languageID with one listing for each language supported for this label or text string. That is, for entry 6034 shown in FIG. 46, there may be one (only one) listing for English, one (and only one) for Spanish, and one (and only one) for Chinese (or one listing for English and one for Chinese when only these two languages are supported as shown in FIG. 46). Thus, FIG. 46 shows an example of the ddLanguages table for a system that supports English and Chinese. In accordance with the invention, the current language is a user setting, stored uniquely for the current user that is logged into the system. When any user interface component is initialized, it retrieves its text based on the langID for the text and the current user language. Thus, the same business software application in the example shown in FIG. 46 may be generated in English for one user and also in Chinese for another user.

FIG. 47A illustrates an example of a user interface 470 in the system to change the language of the business software application interface in accordance with the invention. The user interface permits the user's language to be changed by any user from the “My Settings” dialog using the language preference dialog 472. In the example shown in FIG. 47A, the system is able to generate the business software application for a particular user in Chinese, English and Spanish. FIG. 47B illustrates a user interface 473 of the business software application once the Chinese language has been selected. When the user saves the settings, the invention instantly refreshes all UI elements, resulting in an instant language conversion to the target language. Note that, like everything else in the system, the supported user settings are defined in the system tables (ddUserSettings), and each user's settings are stored in the system tables (ddUserSettingValues). Another great benefit of this architecture is that typos in the interface can be fixed instantly without a recompile.

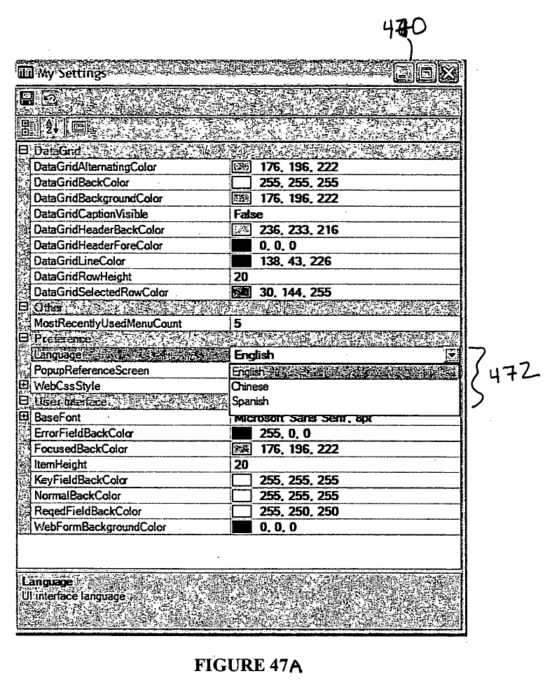

FIGS. 48A and 48B illustrates an example of the business software application feature (a customer master) user interface for a web-based system 480 and a Windows-based system 481, respectively. As shown, based on the data contained in the tables of the database, the user interface and functionality of a business software application may be generated for both the web-based system and Windows-based system. In accordance with the invention, the system may employ a web engine 74 and a separate Windows engine 74 to generate the business software application for each different system.

Now, more details of the application levels (See FIG. 7 above) will be described. The schema of the system tables to store application definitions, the required schema of the user tables required to be compliant with the model and the UI for creating Applications and their levels according to our practices will be further described. First, the user interface for the creation and modification of an application stage will be described with reference to FIG. 49.

When creating a new application, the first thing the consultant must do is to declare it in the Application, its code, and its transaction and detail tables (See FIGS. 15 and 18 above). This is a simple reference form tool as shown in FIG. 49 that directly inputs data into ddApplications. These fields will be described in greater detail in the ddApplication definition. The ddApplication contains an application code field that contains a unique identifying key for the application, an AppSeq field containing the ordinal location of this application in the “Levels and Attributes” and “Application Levels” screens, an App Detail Table pointing to the application detail table, as described in FIGS. 15, 18, 16B and 16C above. The form also contains a Trx Table Name that lists the transaction table for this application, as described in FIGS. 15, 18 and 16A above. Note that the application detail and transaction tables must conform to a required schema, or the interface will not allow them to be added here. The required schema for these tables is described in greater detail ahead in the “Required User Tables” section. Now, the levels and attributes are described in more detail.

FIG. 50 illustrates a levels and attributes form 500 that defines the levels for each application, as described above in FIGS. 7 (conceptually), 8 (real world example), and 9 (declaration example). This is a simple tree/form interface. The consultant clicks on the desired application in the tree on the left. The toolbar buttons allow levels to be added, deleted, and moved up and down within their application. While the most common level names are “Type”, “Stage”, and “Sub-Stage”, note that other names may be used if they are deemed more intuitive (e.g. in the BOM Management application: “Path” in lieu of “Type”). The data is saved to ddAppSupportLevels table. Now, the application levels will now be described in more detail.

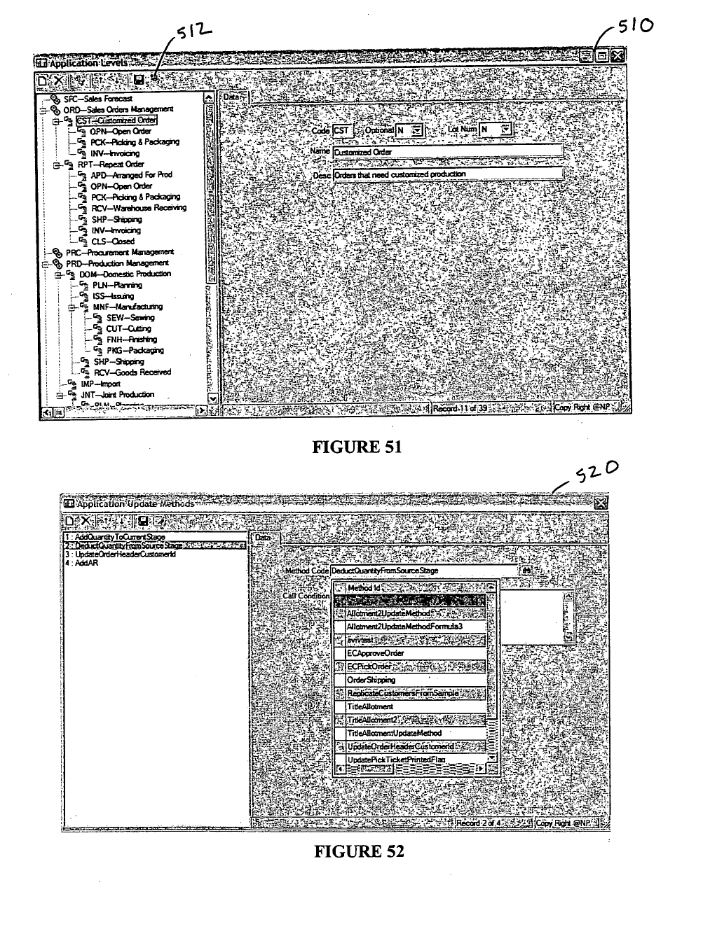

The specific levels are configured in an application levels form 510 as shown in FIG. 51. Taking the “ORD-Sales Orders Management” application as an example: level 1 represents the Order Type, and level 2 represents an Order Stage. On this form, the consultant has just declared the “Customized Order” and “Repeat Order” order types. The consultant has added 3 stages to the Customized Order order type: Open Order, Picking & Packaging, and Invoicing. Nodes are added similarly to those in the Levels and Attributes form. To place a new node within the correct level, the consultant must first select the desired parent. When the consultant clicks “Save”, this data is saved in ddApplicationLevels.

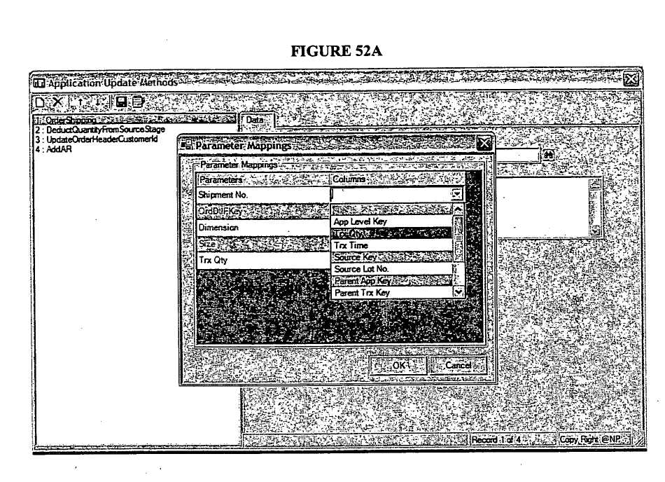

Finally: application logic must be assigned to the application, so that it will be called when items are moved from stage to stage. To do this, the consultant clicks on the “Update Methods” button 512 grayed out in the diagram because the application's root node must be selected). FIG. 52 illustrates a form 520 generated when the update methods button is pressed in accordance with the invention. Update methods may be found and added to the list from the “Method Code” textbox, which includes a zoom listing all update methods valid for applications. The list on the left lists the update methods to be called, and the order in which they will be called. When the consultant saves this list and exits, this data is saved to ddAppUpdateMethods. The tool automatically generates the triggers to call the update methods and writes them to the target user database. Recall that these update methods can update any table available to this user in the system. It allows complex logic and interdependent updates across the system, code reuse, maximum flexibility. If any Update Method requires input parameters, they are mapped by clicking on the parameters mapping button ( [symbol] ) shown in FIG. 52A. Literals, expressions, and transaction table columns can be mapped to the update method parameters. Now, the user tables for the application levels will now be described.

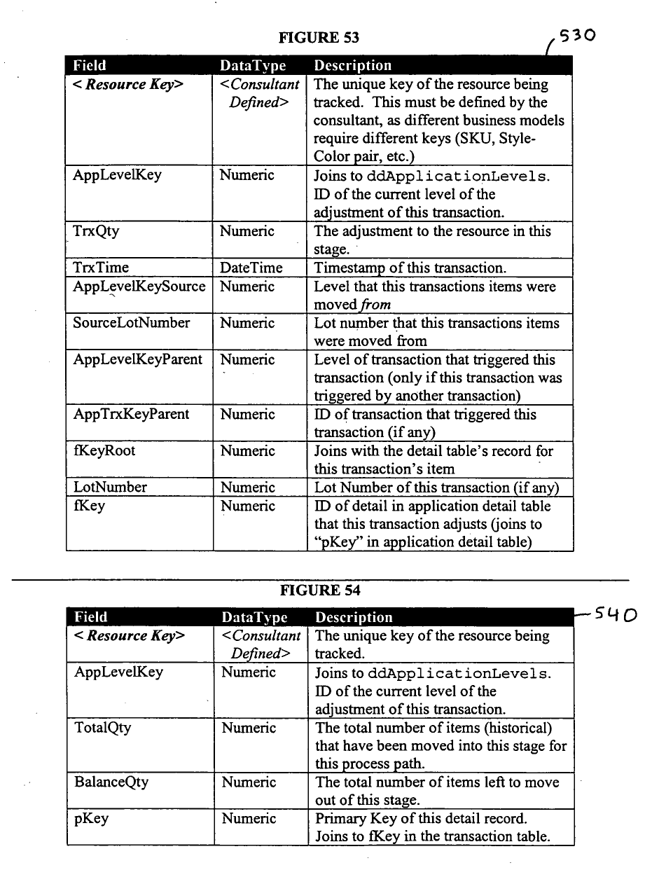

As stated, the application transaction table and the application detail table must be built manually by the consultant. The consultant also specifies here if the level is optional (as described above) or must keep its lot number (as described above). They must contain the fields listed below in order to interoperate with this system. FIGS. 53 and 54 illustrate a transaction table 530 and an application detail table 540, respectively that store the data associated with each created application level. However, the invention is not limited to the fields shown in these tables (or in any table in this patent application) as the fields may be increased and decreased without departing from the scope of the invention.

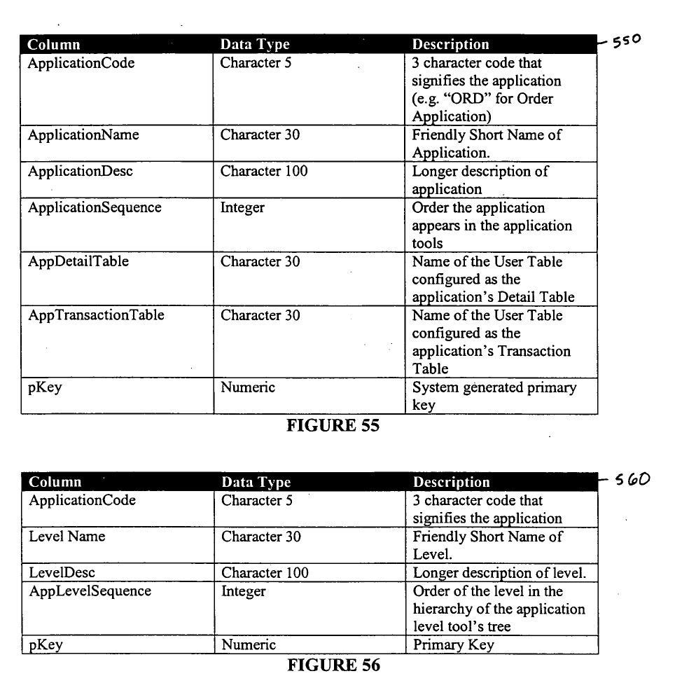

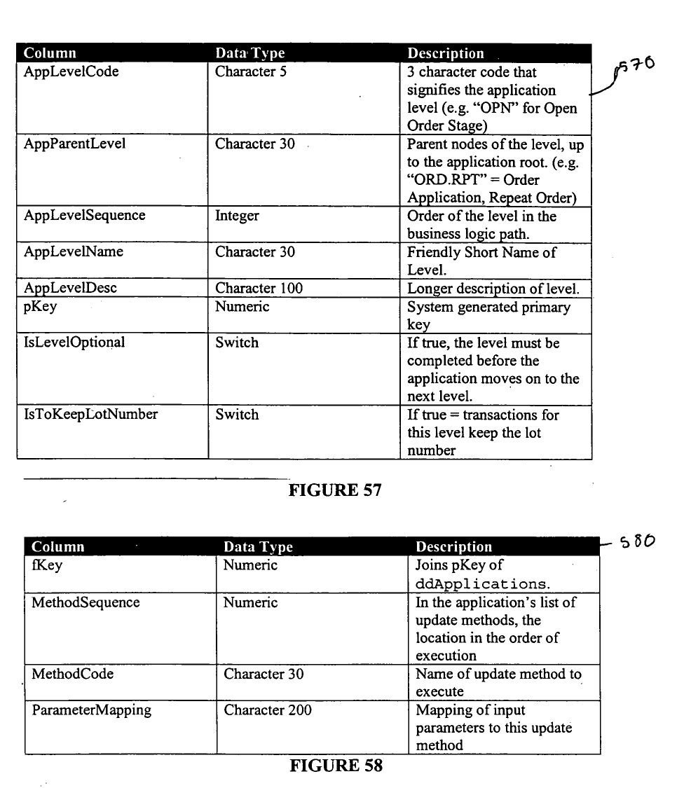

The schema of the relevant system tables for applications is now described. FIGS. 55-58 illustrates the system tables. In particular, FIG. 55 illustrates a ddApplications table 550 that maintains the high level definition of each application. FIG. 56 illustrates a ddAppSupportLevels table 560 that declares the levels supported by each application in ddApplications. ddApplications joins ddAppSupportLevels one-to-many. FIG. 57 illustrates a ddApplicationLevels table 570 that configures the level and sublevel in each application. FIG. 58 illustrates a ddAppUpdateMethods table 580 that lists the Update Methods to be called by the applications when stages and resources are updated within the application. Now, the system tables in accordance with a preferred embodiment of the invention will be described in more detail.

FIG. 59 illustrates the ddColumns table 280 of the database structure of FIG. 27 wherein the primary key of the ddColumns table is an ObjId attribute 282. The ddColumns table stores the data that defines every column in every table in the system, including the columns of ddColumns itself. The ddColumns table has a many-to-many relationship with the ddTables table, through the ddTabCols table. Thus, after a column is defined, it can be reused for multiple tables. All attributes in the system are represented as system table columns. Since an object instance is represented by a table row, the attribute values are represented in a row's field values. In addition to the ObjId attribute, the ddColumns table may further include an ObjName attribute 284, an ObjDesc attribute 286, an ObjType attribute 288, an ObjWidth attribute 290, an ObjPrec attribute 292, an ObjItems attribute 294, an ObjMask attribute 296, and an ObjLevel attribute 298 that have the data types and the characteristic shown in FIG. 59.

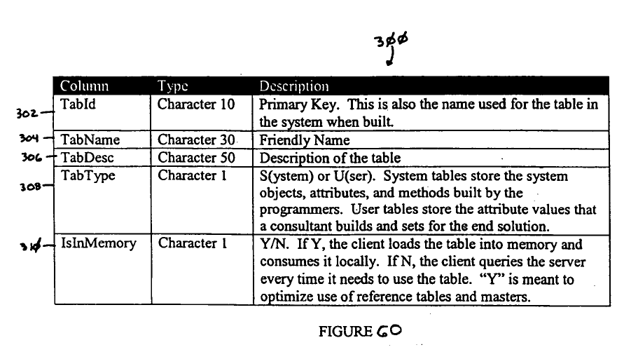

FIG. 60 illustrates the ddTables table 300 of the database structure of FIG. 27. This table stores the data that defines every table in the system, including ddTables itself. The DdTables table has a many-to-many relationship with the ddColumns table, through the ddTabCols table which means that columns can be reused in different tables. In accordance with the invention, classes in the system are represented as tables and an instance of any object of that class is represented as a table row. As shown in FIG. 60, the primary key of this table is a TabId attribute 302 and the table may further comprise a TabName attribute 304, a TabDesc attribute 306, a TabType attribute 308 and an IsInMemory attribute 310 wherein each attribute has the type and characteristics shown in FIG. 60.

FIGS. 61-1 and 61-2 illustrate the ddTabCols table 312 of the database structure of FIG. 27. This table stores the data that defines the column in the tables in the system. This table joins the ddTables table to the ddColumns table in a many-to-many relationship as shown in FIG. 27. The ddTabCols table also contains data that describes how a column behaves within a specific table so that is the table to go to for table-specific column data. For example, this table contains data to answer the questions: Is the column required? Is the column is a primary key. Each of the attributes of the table 312 have a name, type of description as shown in FIGS. 61-1 and 61-2. The table may include a TabId and ColId attribute 314, 316 that are the primary key for the table and are foreign keys for the ddTables table and the ddColumns table as shown. The table may further include a ObjSeq attribute 318, an ObjReqed attribute 320, a DefValue attribute 322, a VisLevel attribute 324, an IsKeyField attribute 326, a ZoomString attribute 328, an FldType attribute 330, a ColResoltn attribute 332, a ColResWhen attribute 334, a ColValidtn attribute 336 and a ColZoom attribute 338 that has the types and description/contents/functions shown in the figures.

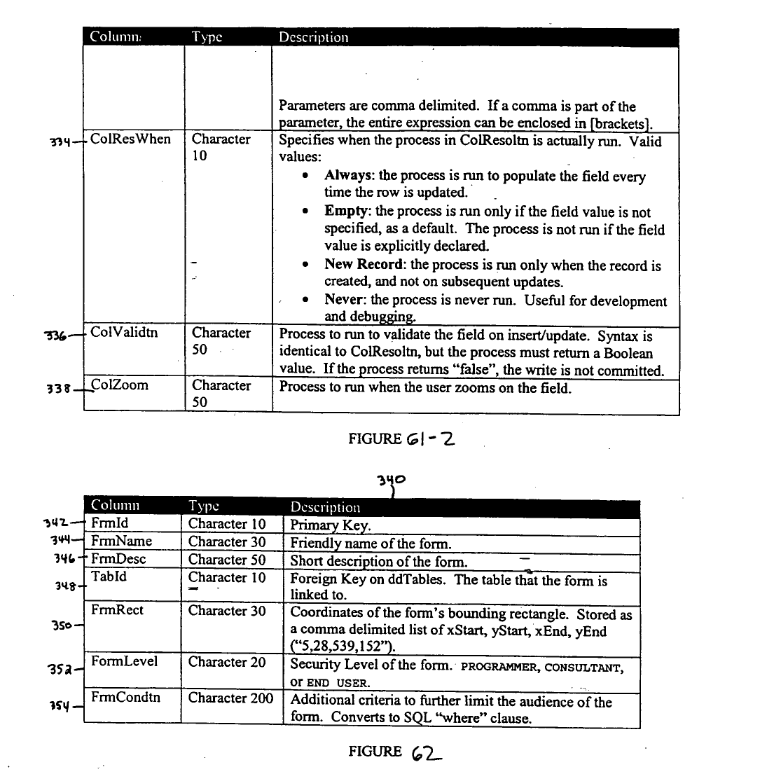

FIG. 62 illustrates the ddForms table 340 of the database structure of FIG. 27. This table is part of the user interface (UI) tables in accordance with the invention. In accordance with the invention, these tables define the forms in the system and may include forms for the consultant and forms for the end user. In accordance with the invention, a form is one group of controls that the user (or consultant) uses to input data. Valid controls include textboxes, checkboxes for Boolean values, radio buttons, dropdowns, and labels. In accordance with the invention, a form is linked to the table to which it writes data. Sometimes, complex forms are required to represent joins to multiple tables. When an input page requires “subforms”, a multiform is built from more than one form. A form is listed in the menus when it has an entry in ddMenu. However, when a multiform is used, the multiform must be listed in ddMenu for a menu item to appear. The ddForms table 340 represents the forms in the system and includes forms whether used by programmers, consultants, or end users. For a multiform, each entry in ddForms represents a subform. Furthermore, multiple forms can be linked to a database table, so ddForms joins many-to-one with ddTables.

The DdForms table joins one-to-many with ddFormItems, which represents the controls within the forms. In a simple form, ddForms joins ddMenu in a one-to-many relationship (each entry in ddMenu really representing a menu item). If a form is part of a multiform, then ddForms joins one-to-one with ddMlFmltm, which contains extra fields not required for a simple form. DdMlFmItm joins many-to-one with ddMultiForm, so ddForms also has a many-to-one relationship with ddMultiform. The table 340 may include a FrmId attribute 342 that is the primary key for this table. The table 340 may further comprise a FormName attribute 344, a FrmDesc attribute 346, a TabId attribute 348, a FrmRect attribute 350, a FrmLevel attribute 352 and a FrmCondtn attribute 354 that have the types and functions and contain the data shown in FIG. 62.

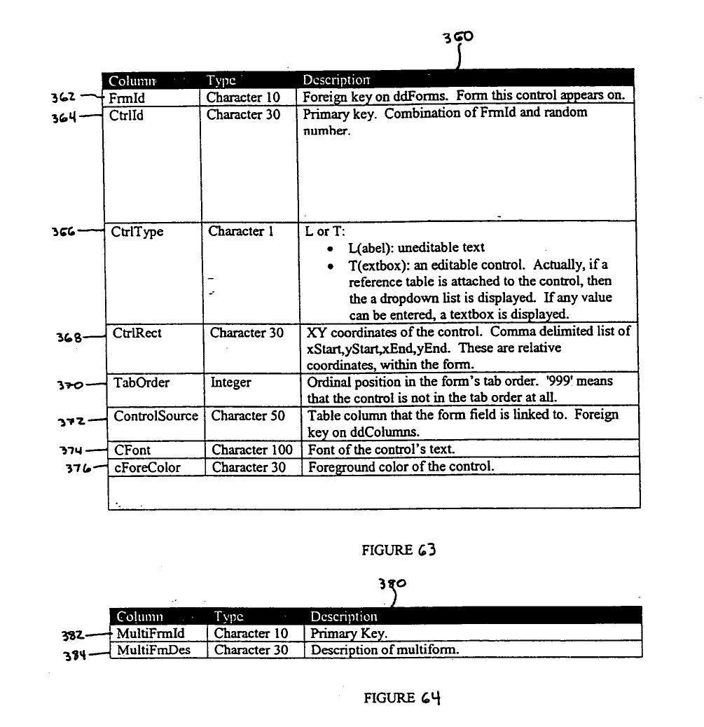

FIG. 63 illustrates the ddFormItems table 360 of the database structure of FIG. 27. This table specifies the specific user interface (UI) controls on a given form. This table joins many to one with ddForms. The ddFormItems table 360 comprises a FrmId attribute 362 that is a foreign key for the ddForms table for the form that this control appears on and a CtrlId attribute 364 that is a primary key of the table. The ddFormItems table 360 may further comprise a CtrlType attribute 366, a CtrlRect attribute 368, a TabOrder attribute 370, a ControlSource attribute 372, CFont attribute 374 and a cForeColor attribute 376 that have the attributes listed in FIG. 63.

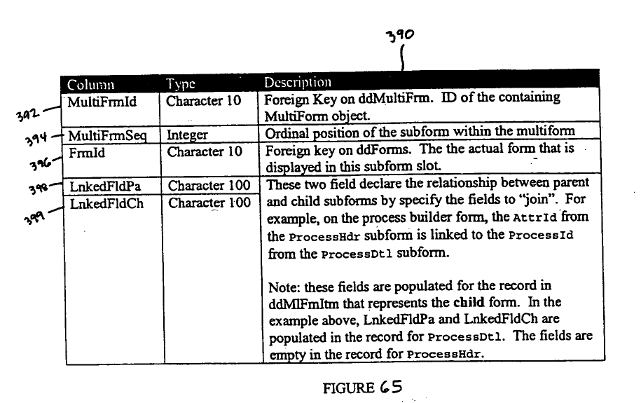

FIG. 64 illustrates the ddMultiForm table 380 of the database structure of FIG. 27 wherein the table contains data that represents a multiform. The table joins one to many with the ddMlFmItm table (which actually links to the forms contained). The table also joins one to many with the ddMenu table. The table 380 may include a MultiFrmId attribute 382 that is the primary key and a MultiFmDes attribute 384 that contains a description of the multiform.

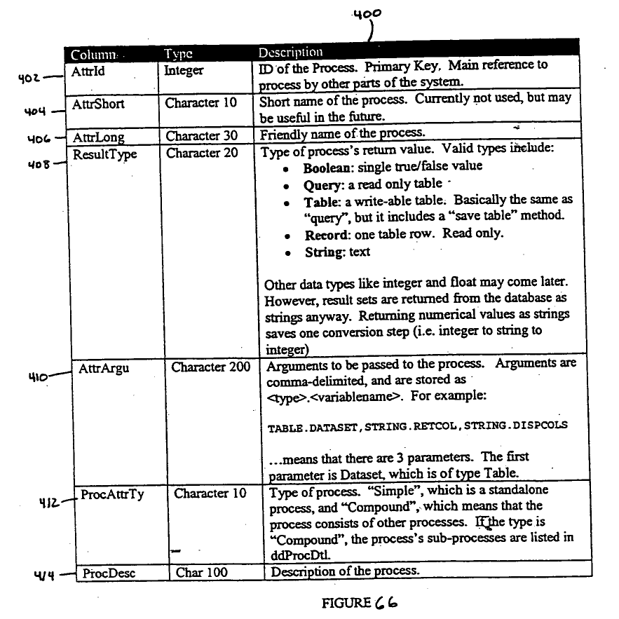

FIG. 65 illustrates the ddMlFmltm table 390 of the database structure of FIG. 27 and the table contains data about and represents a sub-form within a multiform, so joins many to one with the ddMultiForm table. The table also joins one-to-one with the ddForms table (so logically, if not explicitly, ddMultiForm has a one-to-many relationship with ddForms). The ddForms table includes extra fields not required for simple forms, to support parent-child multiform configurations on the same page (e.g.: order parent subform on top with order items child subform on the bottom). The table 390 may include a MultiFrmId attribute 392, a MultiFrmSeq attribute 394, a FrmId attribute 396, a LnkedFldPa attribute 398 and a LnkedFldCh attribute 399 that have the characteristics set forth in FIG. 65.

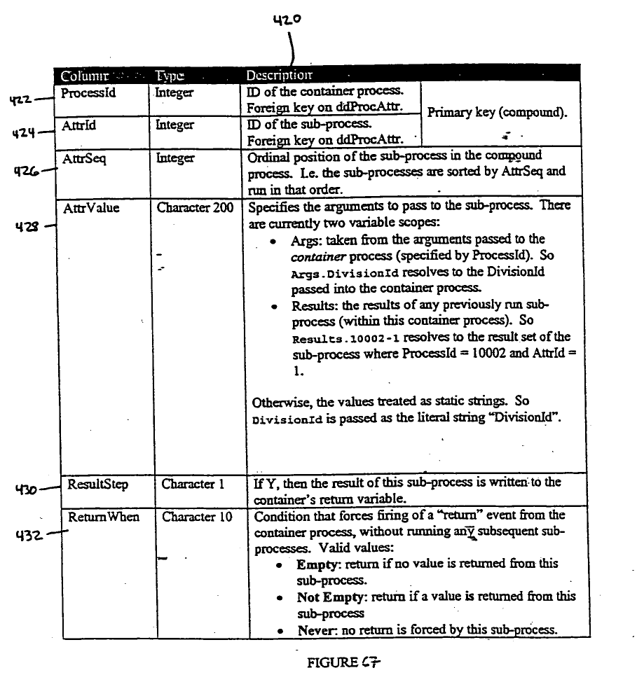

FIG. 66 illustrates the ddProcessDetails table 400 of the database structure of FIG. 27. This table is part of the process tables in the system. The process tables contain the data about the processes in the system, including methods and processes. The method are written by programmers and compiled as code. The interface of our methods is also exposed so that third parties may write methods and compile them as dlls (dynamic linked libraries). The processes are written by consultants and may include scripts consisting of methods and processes which are linked together graphically. The ddProcAttr table thus lists basic information for all methods and processes. The Methods and Processes are called using the exact same syntax, and share the same ID space (i.e., no method's ID will ever equal a process's ID). To reiterate from the discussion in ddTabCols table above, the syntax for a process is as follows:
<process ID>(arg1, arg2, . . . , argN)

For example:
2(division,[divisionid,div_name],[@parent_div,30]).

The arguments can be either static, literal values, or the value of the field in the current row (prefixed with ‘@’). So, in the example, the value of the parent_div field in the current row is passed to the process in place of @parent_div. All the other values are literally passed. Parameters are comma delimited. If a comma is part of the parameter, the entire expression can be enclosed in [brackets]. A process can be called in the following ways:
By linking to an attribute or column. All attributes and columns have attributes to define the zoom, validation, and resolution of the field. See ddTabCols table for more details; and
By linking to a form control, like a button; and
By including within a process. Consultants build their own processes by adding currently existing processes.

Returning to FIG. 66, the table 400 may comprise an AttrId attribute 402, an AttrShort attribute 404, an AttrLong attribute 406, a ResultType attribute 408, a AttrArgu attribute 410, a ProcAttrTy attribute 412 and a ProcDesc attribute 414 that have the characteristics shown.

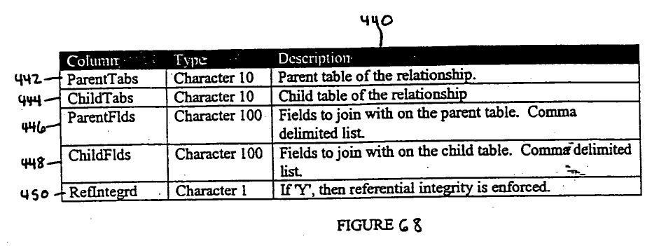

FIG. 67 illustrates the ddProcDtl table 420 of the database structure of FIG. 27 that lists the sub-processes of compound processes. This table sort of joins the ddProcAttr table to itself in a many to many relationship. When a compound process is run by the system, an empty return value is instantiated for the container process (a process that contains all the sub-processes of a compound process.) Sub-processes can write to this return value, but then need to explicitly declare a return event. If no sub-process successfully computes a return value before a return event is fired, then an empty variable is returned. Also, subsequent sub-processes can overwrite return values written by previous processes many times before a return event is fired. When the return event is fired, the most recent value of the return variable is returned. The table 420 may comprise a ProcessId attribute 422, an AttrId attribute 424, an AttrSeq attribute 426, an AttrValue attribute 428, a ResultStep attribute 430 and a ReturnWhen attribute 432 that have the characteristics shown.

FIG. 68 illustrates the ddTabRels table 440 of the database structure of FIG. 27. This table is part of the overhead tables. This table stores data that defines relationships between tables in the system. When the system constructs user tables, foreign key constraints are defined based on these relationships. The table 440 may include a ParentTabs attribute 442, a ChildTabs attribute 444, a ParentFlds attribute 446, a ChildFlds attribute 448 and a RefIntegrd attribute 450 that have the characteristics shown.

In addition to the various aspects of the invention described above, the system in accordance with the invention may include a security module/model and a query designer module. The security model is data driven (e.g., stored in one or more tables) and had one or more layers of security (four in the preferred embodiment) in which the data of the business software application being generated may be secured on a functionality basis, on a view basis, on a column basis and on a record basis to provide different levels of security. On a functionality basis, a particular user may or may not have the rights to modify data in the business software application. On the view basis, each different user may be permitted to see a different view of the data. On a column basis, a particular user may be able to only see particular columns in the data. For example, a warehouse worker may be permitted to see the data about the warehouse, but not permitted to see the column of data about the commissions paid to particular vendors. On a record basis, a user may be restricted to viewing only his own records in the business software application. In this manner, the security of the data may be adjusted and modified at different levels.

The query designer operates in a similar matter to the update method designer described above in that it permits the user to generate functionality of the business software application system. In this case, the designer permits a user to generate a query that returns data sets to the user. However, similar to the update method designer, the query designer uses statements and controls as described above.

While the foregoing has been with reference to a particular embodiment of the invention, it will be appreciated by those skilled in the art that changes in this embodiment may be made without departing from the principles and spirit of the invention, the scope of which is defined by the appended claims.

1. A computer implemented business software application generation system comprising:
a system database comprising a plurality of tables linked together wherein the plurality of tables stores data about the tools to generate an instantiation of a business software application;
a user database comprising a plurality of tables linked together wherein the plurality of tables stores data about a user interface, functionality and business logic of a particular business software application is instantiated using the tables on the system database, the particular business software application having an application, application level and resource modeling; and
an engine connected to the user database, the engine further comprising instructions that generate an instantiation of the particular business software application based on the data and tables in the user database.

2. The system of claim 1 further comprising one or more external databases and wherein the system database further comprises one or more tables that map a data format of the external database into a system format to create a virtual database so that the instantiation of the business software application consumes the data in the virtual database.

3. The system of claim 2, wherein the external databases have different data formats.

4. The system of claim 1, wherein the system database further comprises a language table in which one or more languages of the user interface of the particular business software application are specified and a user settings table containing a language setting for a particular user so that the language setting changes the language of the user interface of the instantiation of the business software application.

5. The system of claim 4, wherein the engine further comprises instructions that automatically regenerate the instantiation of the business software application with a new language when the language setting in the user settings table is modified.

6. The system of claim 1, wherein the system database further comprises an update method table that stores one or more update methods associated with the instantiation of the business software application, the update method generated using a update method designer that is instantiated by the system database.

7. The system of claim 1 further comprising one or more clients connected to the system database and user database by a communications link wherein an instantiation of the business software application is executed on each client based on the tables in the user database.

8. The system of claim 7, wherein each client further comprising a computing device that executes an engine that further comprises instructions that generate the instantiation of the particular business software application based on the data and tables in the user database.

9. The system of claim 7, wherein each client further comprises a web application server that has an engine that further comprises instructions that generate the instantiation of the particular business software application based on the data and tables in the user database, each client further comprising a web client that connects to the web application server to receive the instantiation of the business software application generated by the web application server.

10. A computer-implemented method for generating a business software application, comprising:
storing a plurality of tables in a system database wherein the plurality of tables stores data about the tools to generate an instantiation of a business software application;
storing a plurality of tables in user database wherein the plurality of tables stores data about a user interface, functionality and business logic of a particular business software application is instantiated using the tables on the system database, the particular business software application having an application, application level and resource modeling; and
generating an instantiation of the particular business software application based on the data and tables in the user database.

11. The method of claim 10 further comprising connecting one or more external databases to the system database by mapping a data format of the external database into a system format to create a virtual database so that the instantiation of the business software application consumes the data in the virtual database.

12. The method of claim 11, wherein the external databases have different data formats.

13. The method of claim 10 specifying, in a language table in the system database, one or more languages of the user interface of the particular business software application and changing the language setting for a particular user using a user settings table, the language setting automatically changing the language of the user interface of the instantiation of the business software application.

14. The method of claim 13 further comprising automatically regenerating the instantiation of the business software application with a new language when the language setting in the user settings table is modified.

15. A business software application generation system comprising:
a system database comprising a plurality of tables linked together wherein the plurality of tables stores data about the tools to generate an instantiation of a business software application;
a user database comprising a plurality of tables linked together wherein the plurality of tables stores data about a user interface, functionality and business logic of a particular business software application is instantiated using the tables on the system database, the particular business software application having an application, application level and resource modeling; and
one or more clients connected to the system database and user database by a communications link wherein an instantiation of the business software application is executed on each client based on the tables in the user database.

16. The system of claim 15, wherein each client further comprising a computing device that executes an engine that further comprises instructions that generate the instantiation of the particular business software application based on the data and tables in the user database.

17. The system of claim 15, wherein each client further comprises a web application server that has an engine that further comprises instructions that generate the instantiation of the particular business software application based on the data and tables in the user database, each client further comprising a web client that connects to the web application server to receive the instantiation of the business software application generated by the web application server.

18. The system of claim 15 further comprising one or more external databases and wherein the system database further comprises one or more tables that map a data format of the external database into a system format to create a virtual database so that the instantiation of the business software application consumes the data in the virtual database.
